(19) United States
(12) Patent Application Publication
(10) Pub. No.: US 2006/0004192 A1
(43) Pub. Date: Jan. 5, 2006

(54) Method of preparing a cellulose acylate, cellulose acylate film, polarizing plate, and liquid crystal display device

(75) Inventors: Toyohisa Oya, Minami-ashigara-shi (JP); Saisuke Watanabe, Minami-ashigara-shi (JP); Kiyokazu Hashimoto, Minami-ashigara-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/169,795

(22) Filed: Jun. 30, 2005

(30) Foreign Application Priority Data
Jul. 2, 2004 (JP) 2004-197378
Jul. 2, 2004 (JP) 2004-197380
Jul. 2, 2004 (JP) 2004-197376

(51) Int. Cl. C08B 3/16

(52) U.S. Cl. 536/58

(57) ABSTRACT

A method of preparing a cellulose acylate of a specific substitution degree, which includes: adding at least one selected from the group consisting of water and a carboxylic acid having 2 to 7 carbon atoms, as an activating agent, to a cellulose; and applying at least one treatment selected from (a) maintaining the cellulose at a temperature of 40° C. or more, for one hour or more, (b) irradiating microwaves to the cellulose, and (c) placing the cellulose under a pressure in the range of from 1.5 atm (0.15 MPa) to 100 atm (10.13 MPa); a cellulose acylate film prepared by means of a solution-casting film formation method or melt-casting film formation method, using the cellulose acylate which is prepared by the preparation method; and a polarizing plate and a liquid crystal display device, each of which contains the cellulose acylate film.

### FIELD OF THE INVENTION

The present invention relates to a method of preparing a cellulose acylate, and to a cellulose acylate film, which is preferable as an optical film, using the same. Further, the present invention relates to a method of preparing a cellulose acylate, preferable for use in an optical film, containing little quantity of minute contaminants (foreign matters), and relates to an efficient synthesizing method saving the reaction time. Still further, the present invention relates to an optical film of cellulose acylate containing little quantity of minute contaminants. Moreover, the present invention relates to a cellulose acylate film not containing minute contaminant and having good peelability, and relates to a polarizing plate and a liquid crystal display device that are free of display troubles.

### BACKGROUND OF THE INVENTION

Since a cellulose acetate has good transparency, toughness, and optical isotropy, it has been used as a base of a photographic sensitive material. In recent years, its application for an optical film for a liquid crystal display device has been expanded. As an optical film for a liquid crystal display device, use has been made of a protective film of a polarizing plate, or use has been made of a phase contrast film for a liquid crystal display device in an STN (super twisted nematic) system and the like. The phase contrast film is stretching, in preparation, to develop retardation in the direction of its plane (Re) and retardation in the direction of its thickness (Rth).

In recent years, a new display device, such as a VA (vertical alignment) system and an OCB (optically compensated bend) system, requiring a larger phase difference of Re or Rth compared with the STN type, has been developed. Thus, a material advantageous in giving retardation in optical films has been required. To satisfy such requirement, a material for a novel optical film, a solution-casting film using a mixed ester of an acetyl group and a propionyl group of cellulose (cellulose acetate propionate), is disclosed in JP-A-2001-188128 (“JP-A” means unexamined published Japanese patent application). Further, a method is disclosed in use of a melt-casting film of cellulose acylate, such as cellulose acetate butyrate and cellulose acetate propionate, as an optical film, because their melting points are lower than that of cellulose acetate (see, JP-A-2000-352620).

A wide variety of cellulose acetate butyrate or cellulose acetate propionate, for a molding or coating material, is disclosed as commercially available cellulose acylate other than cellulose acetate (see, catalogue of Eastman Kodak Co., 1994).

However, such cellulose acetate butyrate or cellulose acetate propionate as described in the above-described patent publications or technical literature is apt to contain minute contaminants, compared with cellulose acetate. Further, such cellulose acetate butyrate or cellulose acetate propionate has acylation reactivity lower, and thereby requires a reaction time longer, than those of cellulose acetate. Increase in reaction temperature or the amount of a catalyst for the solution of the problems above may causes lowering of the polymerization degree, which is not desirable for the use of film.

While the substance of minute contaminants has not been clarified, it is presumed that they are unreacted or low-acylated cellulose. Accordingly, when a polarizing plate is formed by the film prepared from such cellulose acylate, and built in a liquid crystal display device, an extraordinary effect in the state of polarizing is generated, because the refractive index of the insoluble minute contaminants is different from that of cellulose ester. As a result, defects, such as light leakage, occur according to the operating conditions, thereby decreasing the quality of a liquid crystal display device. As the liquid crystal display device has been growing more precise and sophisticated in recent years, lowering of the minute contaminants content is recognized to be an important characteristic required for a material for an optical film.

As a means of decreasing the contents of minute contaminants in cellulose acetate butyrate or cellulose acetate propionate, JP-A-2001-188128 describes a method for filtering a dissolved dope, using a filter. Such a method is effective for decreasing the minute contaminants if the filtering conditions are properly selected. However, when a large amount of the minute contaminants is contained, it is absolutely necessary to radically decrease, per se, the amount of the minute contaminants contained in cellulose acylate, because the increase in filtering pressure or consumption of filtering medium becomes an issue to be resolved.

As to a method of synthesizing cellulose acetate propionate, JP-A-6-501040 describes a method of acylation of cellulose by adding carboxylic acid to the cellulose, maintained at 54.4° C. for 30 minutes, and then carrying out acylation, using sulfuric acid as a catalyst. JP-A-6-32801 describes a method of preparing cellulose acylate by using trifluoroacetic acid anhydride as an accelerating agent for acylation. While these methods are useful for preparing mold-grade or coating-grade cellulose acylate, the large amount of minute contaminants is mostly not proper for an optical film. Besides, the latter method raises the industrial manufacturing cost.

As a means for activating cellulose to improve its reactivity, e.g., U.S. Pat. No. 3,767,642 describes a method of preparing acetyl cellulose by slurring wood pulp in a dilute aqueous solution of acetic acid, repeating filtration and acetic acid substitution, and thereafter performing acetylation. For this method, however, it is necessary to recover a great amount of acetic acid, and accordingly the method is not proper for industrial production. Further, German Patent No. 19,624,866 describes a method of allowing cellulose to react with cellulase. U.S. Pat. No. 5,371,207 describes a method of preparing cellulose diacetate by acylation, after adding acetic acid and acetic acid anhydride into cellulose under high pressure. However, these two conventional techniques are not suitable for industrial mass production. These two prior arts are effective to improve the reactivity of acylation when they are applied to cellulose acetate butyrate or cellulose acetate propionate; however, they do not have insufficient effect to reduce the contents of minute contaminants to the degree that is proper for an optical film.

In recent years, a method of activating an organic reaction using microwaves has been studied (Rajender S. Varma, etc.; Advances in Green Chemistry, Chemical Syntheses Using Microwaves (irradiation), AstraZeneca Research Foundation, India, Bangalore). However, the use of microwaves as a pretreatment for synthesis of cellulose acylate has never been known to reduce the amount of minute contaminants formed during synthesis of cellulose acylate.

As described above, no industrially useful method of preparing cellulose acetate butyrate or cellulose acetate propionate has been known that makes it possible to reduce the amount of minute contaminants contained therein to an acceptable level for an optical film. Practical realization of such a method has been earnestly expected.

### SUMMARY OF THE INVENTION

The present invention resides in a method of preparing a cellulose acylate having a substitution degree represented by formulas (1) to (3), which comprises the steps of:
adding at least one selected from the group consisting of water and a carboxylic acid having 2 to 7 carbon atoms, as an activating agent, to a cellulose; and
applying at least one treatment selected from (a) maintaining the cellulose at a temperature of 40° C. or more, for one hour or more, (b) irradiating microwaves to the cellulose, and (c) placing the cellulose under a pressure in the range of from 1.5 atm (0.15 MPa) to 100 atm (10.13 MPa):
   2.5≦A+B≦3 formula (1)
   0≦A≦2.5 formula (2)
   0.3≦B≦3 formula (3)
wherein “A” represents a substitution degree of an acetyl group, and “B” represents the sum total of substitution degrees of acyl groups having 3 to 7 carbon atoms.

Further, the present invention resides in a cellulose acylate film, which is prepared by means of a solution-casting film formation method or melt-casting film formation method, using the cellulose acylate which is prepared by the above preparation method.

Further, the present invention resides in a polarizing plate, which comprises at least one sheet of the above cellulose acylate film, as a protection film on a polarizing film.

Further, the present invention resides in a liquid crystal display device, which comprises the above cellulose acylate film.

Other and further features and advantages of the invention will appear more fully from the following description.

### DETAILED DESCRIPTION OF THE INVENTION

According to the present invention, there are provided the following means:

<1> A method of preparing a cellulose acylate having a substitution degree represented by formulas (1) to (3), which comprises the steps of:
adding at least one selected from the group consisting of water and a carboxylic acid having 2 to 7 carbon atoms, as an activating agent, to a cellulose; and
applying at least one treatment selected from (a) maintaining the cellulose at a temperature of 40° C. or more, for one hour or more, (b) irradiating microwaves to the cellulose, and (c) placing the cellulose under a pressure in the range offrom 1.5 atm (0.15 MPa) to 100 atm (10.13 MPa):
   2.5≦A+B≦3 formula (1)
   0≦A≦2.5 formula (2)
   0.3≦B≦3 formula (3)
wherein “A” represents a substitution degree of an acetyl group, and “B” represents the sum total of substitution degrees of acyl groups having 3 to 7 carbon atoms.

<2> The method of preparing the cellulose acylate according to <1>, which further comprises the step of:
adding a carboxylic acid anhydride having 2 to 7 carbon atoms to the cellulose to be acylated, and acylating a hydroxyl group of the cellulose in the presence of a Brφnested acid.

<3> The method of preparing the cellulose acylate according to <1>, which further comprises the steps of:
cooling the cellulose to a temperature of from −30° C. to less than 30° C., before acylation; and
adding a carboxylic acid anhydride having 2 to 7 carbon atoms to the cellulose to be acylated, to which said treatment is applied, and acylating a hydroxyl group of the cellulose in the presence of a Brφnested acid.

<4> The method of preparing the cellulose acylate according to <1>, wherein said activating agent is water, at least one kind of carboxylic acid having 2 to 6 carbon atoms, or a mixture of water with at least one kind of carboxylic acid having 2 to 6 carbon atoms.

<5> The method of preparing the cellulose acylate according to <1>, wherein “B” in formula (1) or (3) represents the sum total of substitution degrees of a propionyl group, a butyryl group, a pentanoyl group, and a hexanoyl group.

<6> The method of preparing the cellulose acylate according to <1>, wherein a frequency of the microwaves irradiated in the (b) is 433.920±0.87 MHz, 915±50 MHz, 2450±50 MHz, 5800±75 MHz, or 24.125±0.125 GHz.

<7> The method of preparing the cellulose acylate according to <1>, wherein the activating agent to be added to the cellulose is a carboxylic acid having 2 to 7 carbon atoms.

<8> The method of preparing the cellulose acylate according to <1>, wherein the activating agent to be added to the cellulose is selected from the group consisting of acetic acid, propionic acid, and butyric acid.

<9> The method of preparing the cellulose acylate according to <1>, wherein the activating agent to be added to the cellulose is acetic acid.

<10> The method of preparing the cellulose acylate according to <1>, wherein a period of time for maintaining the cellulose with the activating agent at a temperatures of 40° C. or above is in the range of from one hour to 100 hours.

<11> The method of preparing the cellulose acylate according to <1>, wherein the cellulose is maintained at a temperature in the range of from 60° C. to 90° C. in the presence of the activating agent.

<12> The method of preparing the cellulose acylate according to <2>, wherein said Brφnested acid is sulfuric acid or perchloric acid.

<13> The method of preparing the cellulose acylate according to <2>, wherein the maximum temperature in the step of acylation is 50° C. or below.

<14> The method of preparing the cellulose acylate according to <2>, wherein a reaction terminator is added over a period of time from three minutes to three hours, after the step of acylation.

<15> The method of preparing the cellulose acylate according to <14>, wherein the reaction terminator is acetic acid containing 5 wt % to 80 wt % of water.

<16> A cellulose acylate film prepared by means of a solution-casting film formation method or melt-casting film formation method, using the cellulose acylate which is prepared by the preparation method according to <1>.

<17> The cellulose acylate film according to <16>, wherein a retardation in a plane (Re) and a retardation in a thickness direction (Rth) satisfy the following formulas.
Rth[nm]≧Re[nm]
300≧Re[nm]≧0
500≧Rth[nm]≧0

<18> A polarizing plate, which comprises at least one sheet of the cellulose acylate film according to <16>, as a protection film on a polarizing film (layer).

<19> A liquid crystal display device, which comprises the cellulose acylate film according to <16>.

The cellulose acylate according to the present invention is described in detail. The cellulose acylate according to the present invention satisfies the following substitution degree:
2.5≦A+B≦3 formula (1)
0≦A≦2.5 formula (2)
0.3≦B≦3 formula (3)
wherein A is the substitution degree of acetyl group, B is the sum total of the substitution degree(s) of an acyl group(s) having 3 to 7 carbon atoms.

Each of the glucose units, which constitute cellulose by bonding through β-1,4-glycoside bond, has free hydroxyl groups at the 2-, 3-, and 6-positions thereof. Cellulose acylate that can be obtained by the producing method of the present invention is a polymer obtained by esterifying a part or the whole of these hydroxyl groups with acyl groups. In the present invention, a substitution degree means the rate of esterification at the 2-, 3-, or 6-positions in the cellulose repeating unit, and the total substitution degree means the sum thereof. Specifically, the 100% esterification of the hydroxyl grout at any one of the 2-, 3-, and 6-positions of cellulose is a substitution degree of 1. Accordingly, the 100% esterification of all of the 2-, 3-, and 6-positions of cellulose gives a total substitution degree of 3, which is the maximum.

An acyl group for B is preferably propionyl, butyryl, 2-methylpropionyl, pentanoyl, 3-methylbutyryl, 2-methylbutyryl, 2,2-dimethylpropionyl (pivaloyl), hexanoyl, 2-methylpentanoyl, 3-methylpentanoyl, 4-methylpentanoyl, 2,2-dimethylbutyryl, 2,3-dimethylbutyryl, 3,3-dimethylbutyryl, cyclopentancarbonyl, heptanoyl, cyclohexanecarbonyl, benzoyl, etc. An acyl group for B is more preferably propionyl, butyryl, pentanoyl, hexanoyl or benzoyl, and particularly preferably propionyl or butyryl.

In the present invention, A+B satisfies the range from 2.0 to 3. Preferably, A+B is from 2.5 to 3, more preferably from 2.6 to 2.97, particularly preferably from 2.7 to 2.95.

Further, in the present invention, A satisfies the range from 0 to 2.5. Preferably, A is from 0.1 to 2.1, more preferably from 0.2 to 2.0, particularly preferably from 0.25 to 1.8.

Further, in the present invention, B satisfies the range from 0.3 to 3. Preferably, B is from 0.7 to 2.9, more preferably from 0.85 to 2.85, particularly preferably from 1.0 to 2.8.

Cellulose acylate, in the present invention, is particularly preferably cellulose acetate propionate or cellulose acetate butyrate.

A method of preparing cellulose acylate of the present invention comprises the steps of:
(1) adding an activating agent (water, carboxylic acid having 2 to 7 carbon atoms, and their combination) to cellulose; and
(2) applying at least one treatment of: (a) maintaining the cellulose at a temperatures of 40° C. or above for one hour or more, (b) irradiating microwaves onto the cellulose, and (c) pressing the cellulose at a pressure in the range of from 1.5 atm (0.15 MPa) to 100 atm (10.13 MPa).

Preferably, the method of preparing cellulose acylate of the present invention further comprises the step(s) of:
(3) cooling the cellulose at temperatures ranging from −30° C. to 30° C. or below before acylation; and/or
(4) adding carboxylic acid anhydride to the cellulose treated as described above, to perform acylation of hydroxyl group of the cellulose in the presence of Brφnested acid.

A method of preparing cellulose acylate of the present invention is described in detail as below.

Inventors of the present invention have found that by sufficiently activating cellulose (in this specification and the claims, unless otherwise particularly stated, “activating” means, pretreatment of cellulose acylate for improving a reaction rate of acylation.) as a raw material of cellulose acylate in advance of acylation, not only acylation proceeds rapidly and uniformly, but also quantity of a minute contaminant is decreased drastically. This mechanism is not yet made clear, but it is considered that reactive activity of a hydroxyl group of cellulose can be increased, by cutting an intermolecular or intramolecular strong hydrogen-bond of cellulose polymer. Cellulose of high concentration containing 92-99.9% of c-cellulose may be preferably used as a raw material for cellulose.

The above-described activation step comprises (I) a step of adding at least one of water and carboxylic acid having 2 to 7 carbon atoms as an activating agent, and (2) a step of applying a treatment selected from (a) maintaining the cellulose at temperatures of 40° C. or above for one hour or above, (b) irradiating microwaves onto the cellulose, and (c) placing the cellulose under the pressure. At this time, when a cellulose material is a state of sheet or block, it is preferable to grind previously such a cellulose material. It is preferably carried out that the cellulose material is ground or agitated in the step (1) or (2), or at a step before or after the steps (1) and (2), in order to disentangle cellulose fibers. It is preferable that grinding or disentangling of cellulose fibers progress so that the shape of cellulose after activation becomes fluff. When an activating agent is added, its temperature may be adjusted at any temperature. A method of addition of an activating agent may be selected from spraying, dropping or dipping.

While water or carboxylic acid having 2 to 7 carbon atoms can be used as an activating agent, it is preferable to add after the activation “a step of adding acid anhydride in excess to dehydrate” or “a step of washing by carboxylic acid to substitute water” or “a step of adjusting the conditions for acylation”, when water is used.

Carboxylic acid for an activating agent is preferably carboxylic acid having 2 to 7 carbon atoms, e.g. acetic acid, propionic acid, butyric acid, 2-methylpropionoc acid, valeric acid, 3-methylbutyric acid, 2-methylbutyric acid, 2,2-dimethylpropionic acid (pivalic acid), hexanoic acid, 2-methylvaleric acid, 3-mthylvaleric acid, 4-methylvaleric acid, 2,2-dimethylbutyric acid, 2,3-dimethylbutyric acid, 3,3-dimethylbutyric acid, cyclopentane carboxylic acid, heptanoic acid, cyclohexanecarboxylic acid, benzoic acid, etc. More preferable is acetic acid, propionic acid or butyric acid, and particularly preferable is acetic acid.

Carrying out the activation, Brφnested acid, such as sulfuric acid, can be added, if necessary. However, when strong acid such as sulfuric acid is added, depolymerization may be accelerated. It is, therefore, preferable to limit the amount of addition of Brφnested acid in from 1 to 10 wt % to cellulose. Two or more different types of activating agents may be used simultaneously, or anhydride of carboxylic acid having 2 to 7 carbon atoms may be added.

The amount of addition of activating agent is preferably 5 wt % or above to cellulose, more preferably 10 wt % or above, particularly preferably 30 wt % or above. When the amount of activating agent is too small, the degree of activation of cellulose lowers. While the upper limit of the amount of activating agent is not specifically limited unless productivity is decreased, it is preferably 100 times or below the weight of cellulose, more preferably 20 times or below, particularly preferably 10 times or below the weight of cellulose. An activating agent may be added in great excess to cellulose, and thereafter the amount of activating agent may be decreased by operations such as filtration, blast drying, heating drying, reduced pressure distillation, solvent displacement, etc.

A step of maintaining cellulose together with an activating agent at temperatures of 40° C. or above for one hour or above is described below. When the temperature for maintaining cellulose together with an activating agent is lower than 40° C., effect on activation is not sufficient and the occurrence of minute contaminants cannot be sufficiently suppressed. When such temperature is higher than 100° C., cellulose is apt to be deteriorated, and is not preferable for industrial production, because high energy is required for heating. The temperature for maintaining cellulose together with an activating agent is preferably from 40° C. to 90° C., more preferably from 50° C. to 90° C., particularly preferably from 60° C. to 90° C. The temperature at the time of activation may be constant or changed.

When the period of time to maintain cellulose together with an activating agent is shorter than one hour, effect on activation may not be sufficient and the occurrence of minute contaminants cannot be sufficiently suppressed. Its upper limit is not specifically limited. However, 720 hours or above is not preferable from the standpoint of industrial production. The time to maintain cellulose together with an activating agent is preferably from one hour to 100 hours, more preferably from two hours to 72 hours, particularly preferably from three hours to 48 hours.

A step of activation of cellulose can be carried out under pressure. As a means for heating may be used electromagnetic wave such as microwave, infrared rays, etc.

Next, a step of irradiating microwaves is described.

Microwaves are usually defined as an electromagnetic wave of from 300 to 300,000 MHz. Energy is transferred from microwaves to a substance by a fundamental mechanism of bipolar revolution and ionic conduction and, as a result, heat is generally generated. Inventors of the present invention have found that irradiation with microwaves is effective for activation of cellulose. In this embodiment of the present invention, preferably cellulose to which is added an activating agent is irradiated with microwaves having a frequency of 433.920±0.87 MHz, 915±50 MHz, 2450±50 MHz, 5800±75 MHz, or 24.125±0.125 GHz. These frequencies are industrially particularly preferably used from the standpoint of the prevention of breakdown in telecommunication or another electronic device.

Frequencies of microwaves applied may be preferably 915±50 MHz, 2450±50 MHz, or 5800±75 MHz, more preferably 915±50 MHz or 2450±50 MHz, and particularly preferably 2450±50 MHz.

In the present invention, it is preferable to irradiate cellulose with microwaves over the period of time to give sufficient quantity of energy for heating cellulose or the activating agent sufficiently. Since a heating time is drastically different depending on the amount of an activating agent or cellulose or the material and shape of a container used for activation, it is hard to define uniquely. However, the heating time may be preferably from one second to several hours and more preferably from three seconds to 30 minutes. It is also preferable to irradiate cellulose with microwaves intermittently or under control of power in order to prevention of overheating at the time of irradiation.

Energy of microwaves applied and irradiation time are dependent on the amount of cellulose to be activated and the amount of activating agent. However, when the temperature of cellulose exceeds 150° C., there occurs a case where cellulose is denatured. It is, accordingly, preferable to maintain cellulose below such temperature. When the temperature of activating agent reaches its boiling pint, it is preferable to prevent cellulose from being dried by providing a reflux condenser.

A microwave-irradiation apparatus may be the so-called microwave oven type (multimode) or wave guide type (single mode). The former has an advantage of being easy to operate. The latter has advantages that it can apply an accurate microwave field and control of temperature is easy. At the time of irradiation with microwaves, an apparatus capable of measuring of internal temperature and controlling the power of microwave may be preferably used in order to avoid a sharp increase in temperature or generation of carbon-like substances.

Preferred examples of a commercially available microwave synthesis apparatus are “Discover” (trade name) (manufacture by CEM CO.), “MicroSynthStart” (trade name) (manufactured by Milestone-General Co.), “Emrys Creator” (trade name) (manufactured by Personal Chemistry Co.) or “GreenMotifl” (trade name) (manufactured by TOKYO DENSHI CO.). In the case of synthesis in small scale, a commercially available microwave oven for home use or its modification may be used.

The mechanism that generation of a minute contaminant can be suppressed by irradiating cellulose in which is added an activating agent with microwaves is not made clear. It is, however, considered as described that the electromagnetic energy of microwave is taken up by an activating agent which is a dielectric, thereby generating heat by dielectric loss. As a result, an effect is increased that an intramolecular or intermolecular hydrogen bond of cellulose fibers is cut by the activating agent.

A step of activation of cellulose can be carried out under pressure. As a means for heating, the method other than microwaves may be used.

A method of preparing cellulose acylate of the present invention preferably includes a step of cooling cellulose at temperatures from −30° C. to less than 30° C. before acylation. When acylation is made to proceed in a state that cellulose is maintained at high temperature, temperature control at the time of acylation is hard. When the temperature for acylation is too high, depolymerization proceeds, thereby lowering the polymerization degree of cellulose acylate. Temperature for cooling cellulose is preferably from −20° C. to less than 30° C., more preferably from −10° C. to less than 25° C., particularly preferably from −5° C. to less than 25° C. Any method may be adopted as a method of cooling cellulose, such as a method of adjusting the temperature of a reactor, a method of introducing cellulose into another reactor for acylation after an activation treatment, a method of taking temporarily cellulose out of a reactor after an activation treatment and allowing to stand for spontaneous cooling or cooling it to a given temperature, a method of adding pre-cooled solvent or acylating agent to cellulose which has been activated, or a method of cooling cellulose by the use of gasification heat of an activating agent, solvent or acylating agent generated under a reduced pressure.

According to a method of preparing cellulose acylate of the present invention, an anhydride of carboxylic acid can be added to cellulose to perform acylation of hydroxyl group of cellulose in the presence of Brφnested acid.

Anhydride of carboxylic acid preferably includes an anhydride of carboxylic acid having 2 to 7 carbon atoms, such as acetic acid anhydride, propionic acid anhydride, butyric acid anhydride, 2-methylpropionic acid anhydride, valeric acid anhydride, 3-methylbutyric acid anhydride, 2-methylbutyric acid anhydride, 2,2-dimethylpropionic acid anhydride (pivalic acid anhydride), hexanoic acid anhydride, 2-methylvaleric acid anhydride, 3-methyl valeric acid anhydride, 4-methyl valeric acid anhydride, 2,2-dimethylbutyric acid anhydride, 2,3-dimethylbutyric acid anhydride, 3,3-dimethybutyric acid anhydride, cyclopentanecarboxylic acid anhydride, heptanoic acid anhydride, cyclohexanecarboxylic acid anhydride, benzoic acid anhydride, etc.

More preferably, it is acetic acid anhydride, propionic acid anhydride, butyric acid anhydride, valeric acid anhydride, hexanoic acid anhydride, heptanoic acid anhydride, or the like, particularly preferably, acetic acid anhydride, propionic acid anhydride, or butyric acid anhydride.

In order to prepare a mixed ester, two or more kinds of such an acid anhydride as described above may be preferably used simultaneously. An acid anhydride is generally added in excess to cellulose. An acid anhydride is added preferably in 1.2 to 50 equivalent weight, more preferably in 1.5 to 30 equivalent weight, and particularly preferably in 2 to 10 equivalent weight to a hydroxyl group of cellulose.

According to a method of preparing cellulose acylate of the present invention, Brφnested acid can be used as a catalyst for acylation. Brφnested acid is defined in, for example “RIKAGAKUJITEN”(SCIENCE AND CHEMICAL DICTIONARY), 5th ed., IWANAMI PUBLISHING CO. 2000. Preferable examples of Brφnested acid include sulfuric acid, perchloric acid, phosphoric acid, methanesulfonic acid, benzenesulfonic acid, p-toluenesulfonic acid, etc. It is more preferably sulfuric acid or perchloric acid, particularly preferably sulfuric acid. Amount of addition of Brφnested acid to cellulose is preferably from 0.1 to 30 wt %, more preferably from 1 to 15 wt %, particularly preferably from 3 to 12 wt %.

When acylation is carried out, a solvent may be added in order to adjust the viscosity, reaction rate, agitatability, rate of substitution of acyl group, etc. As a solvent may be used dichloromethane, chloroform, a carboxylic acid, acetone, ethyl methyl ketone, toluene, dimethyl sulfoxide, sulfolane, etc; a carboxylic acid is preferably used, and a carboxylic acid having 2 to 7 carbon atoms, e.g., acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethybutyric acid, cyclopentanecarboxylic acid, etc., is more preferably used.

When acylation is carried out, a mixture of an acid anhydride and a Brφnested acid which are pre-mixed, or to which a solvent may be added if necessary, may be mixed with cellulose; or an acid anhydride, a Brφnested acid, and a solvent if necessary, may be mixed sequentially with cellulose. It is generally preferable that a mixture of an acid anhydride and Brφnested acid or a mixture of an acid anhydride, a Brφnested acid and a solvent is provided as an acylating agent and is reacted with cellulose. In order to suppress the increase in temperatures in a reactor by reaction heats generated at the time of acylation, it is preferable to cool an acylating agent before use. Temperature for cooling an acylating agent is preferably from −50° C. to 20° C., more preferably from −35° C. to 10° C., particularly preferably from −25° C. to 5° C. An acylating agent may be added in a state of liquid or frozen solid such as crystal, flake or block. An acylating agent may be added to cellulose at one time or at several times in parts. Alternatively, cellulose may be added to an acylating agent at one time or at several times in parts.

While the acylation of cellulose is an exothermic reaction, in the method of preparing cellulose acylate of the present invention, the maximum temperature attained at the time of acylation is preferably of 50° C. or below. When the reaction temperature for acylation is higher, depolymerization proceeds, and therefore cellulose acylate having high polymerization degree cannot be obtained. The maximum temperature attained at the time of acylation is preferably 45° C. or below, more preferably 40° C. or below, and particularly preferably 35° C. or below. Reaction temperature may be controlled by a temperature adjusting apparatus or via a temperature of an acylating agent. Since the generation of heat at the time of acylation is large at the early stage of reaction, the reaction temperature can be controlled by cooling at the early stage of reaction and thereafter heating. A terminal point of acylation can be determined by measuring the light transmittancy, viscosity of solution, change in temperature of reaction system, solubility of reactant or product to an organic solvent, etc.

The minimum temperature of reaction is preferably −50 or above, more preferably −30° C. or above, and particularly preferably −20° C. or above.

Reaction time for acylation is preferably from 0.5 to 24 hours, more preferably from one to 15 hours, and particularly preferably from 1.5 to 12 hours. When the reaction time for acylation is 0.5 hours or below, it is not preferable because the reaction cannot sufficiently progress under usual reaction conditions. When the reaction time for acylation exceeds 24 hours, it is not preferable from the standpoint of industrial production.

In the method of preparing cellulose acylate of the present invention, it is preferable to add a reaction terminating agent after acylation reaction. The reaction terminating agent may be added into a reactor for acylation reaction, or a reactant or product may be added into a reactor for acylation reaction. The reaction terminating agent is preferably added over a period from three minutes to tree hours. As the reaction terminating agent may be used any substance capable of decomposing an acid anhydride. A reaction terminating agent are preferably water, alcohol such as ethanol, methanol, propanol, isopropyl alcohol, etc., or a composition containing thereof. When water or alcohol is directly added, large heat beyond the cooling ability of a reactor generates, thereby lowering the polymerization degree of cellulose acylate or precipitating cellulose acylate undesirably. Therefore, in the method of preparing cellulose acylate of the present invention, a mixture of water and acetic acid is particularly preferably used. The ratio of acetic acid to water may be optionally selected; acetic acid containing 5 wt % to 80 wt % of water is preferable, acetic acid containing 10 wt % to 60 wt % of water is more preferable, and acetic acid containing 20 wt % to 50 wt % of water is most preferable.

Time for addition of a reaction terminating agent shorter than three minutes is not preferable. This is because that heat generated is large, decrease in polymerization degree results, hydrolysis of an acid anhydride is insufficient, and lowering of stability of cellulose acylate may results. Time for addition of a reaction terminating agent longer than three hours is not preferable, because it lowers industrial productivity. Time for addition of a reaction terminating agent is preferably from four minutes to two hours, more preferably from five minutes to one hour, and particularly preferably from 10 minutes to 30 minutes. When a reaction terminating agent is added, a reactor is cooled or not necessarily cooled. In order to suppress depolymerization, it is preferable to cool a reactor to suppress rise in temperature. It is also preferable to cool a reaction terminating agent.

After the end of acylation reaction, an aqueous solution of a neutralizing agent (such as a carbonate, acetate, hydroxide or oxide of calcium, magnesium, iron, aluminum or zinc) may be added to the system in order to hydrolyze excessive carboxylic acid anhydride which remains in the system and neutralize a part of the esterifying catalyst which remains in the system.

The total substitution degree of cellulose acylate thus obtained is approximately 3. However, in order to obtain cellulose acylate having desired substitution degree, it is preferably carried out that the cellulose acylate thus formed is maintained at temperatures from 20 to 90° C. for several minutes to several days in the presence of small amounts of catalyst (usually, residual sulfuric acid) and water and an ester linkage is partially hydrolyzed, thereby changing the cellulose acylate to cellulose acylate having desired substitution degree of acyl group.

At the time when desired cellulose acylate is obtained, a catalyst remaining in the reaction system may be completely neutralized by the use of the above-described neutralizing agent, or a solution of cellulose acylate may be put into water or an aqueous solution of acetic acid without neutralization (or vise versa) to separate cellulose acylate, washed and subjected to stabilization treatment; by such a manner, the desired cellulose acylate can be obtained.

When the impurities in cellulose acylate (such as sulfuric acid, perchloric acid, trifluoroacetic acid, p-toluenesulfonic acid, methanesulfonic acid, etc.) or combined ester (sulfuric ester, etc.) are removed by such treatment as above described, an effect can be obtained that the thermal stability of cellulose acylate is improved. Such an effect is available in the reduction in thermo-discoloration of cellulose acylate particularly when a casting film-formation method is carried out.

Next, minute contaminants in cellulose acylate are described in detail.

Minute contaminants in cellulose acylate are hard to recognize visually, but can be observed by a polarizing microscope. When a protective film of a polarizing plate is formed from cellulose acylate containing minute contaminants and built in a liquid crystal display device, it suffers damage from light leakage particularly in the case of black display intercepting all of lights.

This minute contaminant has a diameter in the range from 1 μm to less than 10 μm and can be observed by a polarizing microscope under a Cross-Nicol prism. Its allowable amount for an optical film is preferably from 0/mm² to 10/mm², more preferably from 0/mm² to 8/mm², and particularly preferably from 0/mm² to 5/mm².

The polymerization degree (viscosity average) of a cellulose acylate that can be preferably produced or used in the present invention is generally from 100 to 700, preferably from 120 to 600, more preferably from 130 to 450. The average polymerization degree can be measured by a limiting viscosity method by Uda et al., (Kazuo Uda and Hideo Saito, “The Journal of the Society of Fiber Science and Technology, Japan”, vol. 18, No. 1, pp. 105-120, 1962), or by a GPC method. The method is also described in detail in JP-A-9-95538. The polymerization degree can be controlled by the reaction conditions and the ripening conditions. In addition, the adjustment of the polymerization degree can be performed by removal of low-molecular-weight components. If low molecular weight components are removed from the cellulose acylate, the average molecular weight (polymerization degree) thereof becomes high. However, the viscosity thereof becomes lower than that of ordinary cellulose acylate. Thus, the removal is useful. Removal of low molecular weight components can be carried out by washing the cellulose acylate with an appropriate organic solvent.

The cellulose ester obtained by the method of preparation of the present invention preferably has a molecular weight ratio Mw/Mn (Mw is a mass average molecular mass and Mn is a number average molecular mass) of from 1.5 to 6, more preferably from 2.0 to 5.0, further more preferably from 2.3 to 5.0, and particularly preferably from 2.4 to 4.0.

Next, a treatment of pressing the cellulose is described in detail.

Inventors of the present invention have found that when a liquid crystal display device comprising a conventional cellulose acylate film built therein is used as a black display, a trouble or failure in display occurs and that such a trouble of failure in display is caused by a minute polarizing contaminant contained in cellulose acylate as a raw material. Cellulose acylate which is currently industrially produced and commercially available contains a large number of minute polarizing contaminant which is hard to remove by a usual filtration; thereby the minute polarizing contaminant remains on the surface of a film when the cellulose acylate is formed into a film. Inventors of the present invention presumed that such a minute polarizing contaminant is non-reacted cellulose or inadequately reacted cellulose acylate at the time of preparation of cellulose acylate, and we worked on an improvement in reactivity of cellulose in mixed acylation. As a result, the inventors of the present invention have found that a minute polarizing contaminant can be made to disappear by introducing a step of activating cellulose by water, at least one kind of carboxylic acid having 2 to 6 carbon atoms, or a mixture thereof, under a specific pressure, in the preparation of cellulose acylate. Further, the inventors of the present invention have unexpectedly found that peelability of a film formed of cellulose acylate off from a supporting structure (support) can be remarkably improved, according to the above-described treatment. That is to say, the inventors of the present invention have found that the productivity of a film can be increased by the use of cellulose acylate prepared according to the above-described process and that a trouble or failure in display of a liquid crystal display device comprising such a film built therein can be resolved. This embodiment of the present invention has been attained on the basis of the above-described findings.

An acyl group of cellulose acylate of the present invention may be an aliphatic acyl group or an aromatic acyl group. When an acyl group is an aliphatic acyl group, the number of carbon atoms is preferable from 2 to 22, more preferably from 2 to 6, and particularly preferably from 2 to 4. An aliphatic acyl group preferably includes an alkylcarbonyl group, alkenylcarbonyl group, or alkynylcarbonyl group, etc. When an acyl group is an aromatic acyl group, the number of carbon atoms is preferably from 7 to 22, more preferably from 7 to 18, and particularly preferably from 7 to 12. Each of these acyl groups may have another substituent.

An acyl group preferably includes, e.g., an acetyl group, propionyl group, butyryl group, pentanoyl group, hexanoyl group, dodecanoyl group, octadecanoyl group, t-butanoyl group, oleyl group, benzoyl group, naphthalencarbonyl group, cinnamoyl group, etc. Among them, an acetyl group, propionyl group, butyryl group, pentanoyl group, hexanoyl group, etc. are more preferable, and an acetyl group, propionyl group, or butyryl group is particularly preferable. In this embodiment also, obtained cellulose acylate may preferably satisfy the substitution degree represented in formulas (1) to (3). For the cellulose in this embodiment, A is the substitution degree of an acetyl group as described above, and B may be the sum total of the substitution degrees of an propionyl group, butyryl group, pentanoyl group, and hexanoyl group.

As a preferable range of the substitution degree is defined above, when the substitution degree of an acetyl group is made small and the total number of substitution degrees of propionyl group, butyryl group, pentanoyl group and hexanoyl group is made large, unevenness in elongation hardly occurs during a stretching process, and irregularities in retardation (Re) and retardation in the direction of thickness (Rth) hardly occur, and crystal-melting temperature (Tm) can be decreased. Particularly, when an extrusion film-formation method is carried out, it is possible to suppress the occurrence of yellowing due to decomposition by heat for melting the film.

When the substitution degree represented in B becomes large, the glass transition temperature (Tg) or modulus of elasticity is remarkably lowered. For an optical film, a substituent group represented in B preferably includes a propionyl group, butyryl group, pentanoyl group or hexanoyl group, more preferably a propionyl group and a butyryl group, and particularly preferably a propionyl group.

The polymerization degree (viscosity average) of a cellulose acylate that can be preferably used in this embodiment is preferably from 50 to 700, more preferably from 70 to 550, further more preferably from 100 to 400, particularly preferably from 100 to 350. The value of Mw/Mn (Mw is a mass average molecular mass and Mn is a number average molecular mass) is preferably from 1.5 to 6, more preferably from 2.0 to 5.5, further more preferably from 2.2 to 5.0, and most preferably from 2.4 to 5.0.

Cellulose acylate may be used singly or in combination of two or more different types thereof. A polymer component other than cellulose acylate may be mixed with cellulose acylate, if necessary.

Cellulose used as a raw material in the present invention is not specifically limited, but may be used, for example, an ordinal cotton linter, or wood pulp.

A synthetic method of cellulose acylate of the present invention can be carried out in three steps, with reference to a method of preparing triacetylcellulose described, for example, by Migita, et al: in “Wood Chemistry”; KYORITSU PUBLISHING CO., 1968; pp180-190.

The first step may be a cellulose activation treatment step in which a cellulose material such as cotton linter or wood pulp is swollen by the use of water, at least one carboxylic acid having 2 to 6 carbon atoms, or a mixture of water with at least one carboxylic acid having 2 to 6 carbon atoms. By carrying out the activation treatment step, the progress of acylation of cellulose can be accelerated. In the present invention, it is preferable to carry out the cellulose activation treatment step under high pressure in a hermetically sealed container. By pressurizing, cellulose can be swollen uniformly and a next mixed acylation can be made to proceed smoothly. Otherwise, cellulose is apt to be swollen nonuniformly. As a result, the next step of mixed acylation does not proceed sufficiently and a minute contaminant remains in cellulose acylate to be obtained finally.

A preferred example of an activation treatment is described below. First, cellulose is cut into a proper size, put into a pressure-resistant container, and is added a selling medium and then agitated. A swelling medium is water, at least one carboxylic acid having 2 to 6 carbon atoms, or a mixture thereof. The smaller molecule of the swelling medium is, the more deeply the swelling medium penetrates into cellulose. Therefore, the swelling medium having smaller molecule shows high effect on swelling of cellulose. For this reason, water shows the highest effect. Water, however, must be quenched before acylation, thereby increasing cost of treatment. Accordingly, carboxylic acid having 2 to 6 carbon atoms alone, a mixture of carboxylic acid having 2 to 6 carbon atoms with water, or a combination of two or more types of carboxylic acid having 2 to 6 carbon atoms may be preferably used as a swelling medium. Among the carboxylic acids having 2 to 6 carbon atoms, acetic acid, propionic acid, or butyric acid is more preferable, since they have higher effect on swelling of cellulose, than other carboxylic acids. For the same reason, acetic acid or a mixture of two or more types of carboxylic acid including acetic acid is more preferable, and single use of acetic acid is most preferable. While the temperature in the inside of a container is not specifically limited, activation can be accelerated at higher temperatures. However, when the temperature in the inside of a container is higher than 100° C., there may be a case where cellulose is decomposed. As a means for heating may be used microwave. Temperature at this step is preferably 100° C. or below. After the temperature is constant, pressurization is preferably carried out.

As a media for pressurization, while any gases which are unreactive with cellulose may be used, and air or inert gas may preferably be used, air or nitrogen is more preferably used, and nitrogen is most preferably used. Pressure is from 1.5 atm (0.15 MPa) to 100 atm (10.13 MPa). When the pressure is too low, activation becomes insufficient. When the pressure is too high, cellulose is decomposed. The pressure is preferably from 2.0 atm to 70 atm and more preferably from 2.0 atm to 50 atm. Under such conditions of pressure, agitation is continued for a period of time generally from 30 minutes to 24 hours, preferably from one hour to 12 hours, more preferably from one hour to 12 hours. Agitation may be carried out in a usual manner. Temperature under pressurization is preferably 100° C. or below. After the completion of activation, the pressurized container is cooled to about room temperature and pressure is released from the container.

The second step may be a complete acylation of cellulose in which a total of substitution degrees of acyl group at 2-position, 3-position and 6-position is taken as about 3.00. Preferably, an acylating agent is added to swollen cellulose activated at the first step. By addition of an acylating agent, heat of reaction is generated by acylation, and depolymerization of cellulose is accelerated. It is, therefore, preferable to add an acylating agent at low temperatures. When swollen cellulose in a reactor is cooled and an acylating agent to be added is also cooled, high effect of suppression on depolymerization can be obtained. An acylating agent comprises, preferably, carboxylic acid such as acetic acid and carboxylic acid anhydride as a solvent, and proton acid such as sulfuric acid or perchloric acid or Lewis acid such as zinc chloride etc. as a catalyst. Amount of catalyst is preferably 0.5 to 25 parts by weight, more preferably 1.0 to 12 parts by weight, and most preferably 1.0 to 10 parts by weight to 100 parts by weight of cellulose. A proportion of carboxylic acid such as acetic acid and carboxylic acid anhydride as the solvent depends on the composition ratio of cellulose acylate to be prepared.

As a method of acylation may be adopted such a method as described below: (1) a method, in which anhydrides of two types of carboxylic acid as an acylating agent other than catalyst are mixed to react or reacted by sequential addition thereof; (2) a method, in which an anhydride of mixed acid of two types of carboxylic acid (for example, an anhydride of mixed acid of acetic acid and propionic acid) is used; (3) a method, in which an anhydride of mixed acid (for example, an anhydride of mixed acid of acetic acid and propionic acid) is synthesized in a reaction system by the use of carboxylic acid and anhydride of another carboxylic acid (for example, acetic acid and propionic acid anhydride) as raw materials, which is reacted with cellulose; (4) a method, in which cellulose acylate having the substitution degree of less than three is synthesized and then the remaining hydroxyl group is acylated by the use of acid anhydride or acid halide. It is, therefore, important for the acylating agent that composition of catalyst, solvent and acid anhydride is properly optimized, according to procedures of acylation. For example, when an activation step is carried out by acetic acid, cellulose acylate can be obtained only by adding a catalyst and anhydride of another carboxylic acid. When the reaction temperature in acylation is high, depolymerization progresses and molecular weight of cellulose acylate obtained is small. On the other hand, when the reaction temperature is low, the rate of acylation becomes low. Reaction temperature may be from 0° C. to 40° C., preferably from 10° C. to 30° C., more preferably from 15° C. to 25° C. The time when an acylated mixture thus obtained becomes a transparent solution of high viscosity is determined to be termination of reaction. It is, however, preferable to continue the reaction further for several hours in order to make unreacted substances (reactants) disappear. Time period for acylation is preferably from 0.5 hours to 24 hours, more preferably from one hour to 12 hours, particularly preferably from 1.5 hours to 6 hours. When it is less than 0.5 hours, the reaction does not progress sufficiently under usual reaction conditions. When the time for acylation is more than 24 hours, it is not preferable from the standpoint of industrial production.

The third step may be partial hydrolysis of cellulose acylate completely acylated. After completion of acylation, water is added and an excess of carboxylic acid anhydride remaining in the reaction system is quenched. Since an acylating catalyst (usually, remaining sulfuric acid) remains in the reaction system, the completely mixed cellulose acylate formed can be changed to mixed cellulose acylate having desired substitution degree of acyl groups and polymerization degree, in maintaining a temperature of the system in the range of from 50 to 90° C. In order to neutralize proton acid or Lewis acid as catalyst, an aqueous solution of neutralizing agent such as a carbonate, acetate, hydroxide or oxide of calcium, magnesium, iron, aluminum or zinc) may be added. Lastly, water may be added dropwise to reprecipitate cellulose acylate. By carrying out washing and stabilization treatment, cellulose acylate can be obtained.

Next, a preferred embodiment of a film-formation method using cellulose acylate prepared by a method of the present invention is described.

In order to prepare a film, cellulose acylate prepared by the present invention can be used singly or as a mixture of two or more different types thereof, or a polymer component other than cellulose acylate prepared by the present invention can be mixed if necessary. A polymer component to be mixed is preferably a polymer having good compatibility with cellulose ester, and a transmittance rate of an obtained film is preferably 80% or above, more preferably 90% or above and particularly preferably 92% or above.

<Plasticizer>

It is also preferred to lower the crystalline melting temperature (Tm) of the cellulose acylate, by adding a plasticizer to the cellulose acylate according to the present invention. The molecular weight of the plasticizer that can be used in the present invention is not particularly limited, and a low-molecular weight compound or a high-molecular weight compound may be used. Examples of the plasticizer include a phosphate, an alkyl phthalyl alkyl glycolate, a carboxylate, and a fatty acid ester of a polyhydric alcohol. The form of the plasticizer may be in a solid state or liquid state. In other words, the plasticizer is not particularly limited by its melting point or boiling point. For film formation by melting, a plasticizer having low volatility can be used particularly preferably.

Specific examples of the phosphate include triphenyl phosphate, tributyl phosphate, tributoxyethyl phosphate, tricresyl phosphate, trioctyl phosphate, trinaphthyl phosphate, trixylyl phosphate, tris-ortho-biphenyl phosphate, cresyl phenyl phosphate, octyl diphenyl phosphate, biphenyl diphenyl phosphate, and 1,4-phenylene-tetraphenyl phosphate. Phosphate-based plasticizers disclosed in claims 3 to 7 of JP-T-6-501040 (“JP-T” means a searched and published Japanese patent application) can also preferably be used.

Examples of the alkyl phthalyl alkyl glycolate include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, octyl phthalyl ethyl glycolate, etc.

Examples of the carboxylate include: a phthalate, e.g. dimethyl phthalate, diethyl phthalate, dibutyl phthalate, dioctyl phthalate, diethylhexyl phthalate; a citrate, e.g. acetyltrimethyl citrate, acetyltriethyl citrate, acetyltributyl citrate; an adipate, e.g. dimethyl adipate, dibutyl adipate, diisobutyl adipate, bis(2-ethylhexyl) adipate, diisodecyl adipate, bis(butyl diglycol adipate); an aromatic polyvalent carboxylate, e.g. tetraoctyl pyromellitate, trioctyl trimellitate; an aliphatic polyvalent carboxylate, e.g. dibutyl adipate, dioctyl adipate, dibutyl sebacate, dioctyl sebacate, diethyl azelate, dibutyl azelate, dioctyl azelate; and an fatty acid ester of a polyhydric alcohol, e.g. glycerin triacetate, diglycerin tetraacetate, acetylated glyceride, monoglyceride, and diglyceride. Further, other than those as described above, butyl oleate, methylacetyl ricinoleate, dibutyl sebacate, triacetin, etc. may be used singly or as a mixture thereof.

Further, use may also be made of a high-molecular weight plasticizer, for example, an aliphatic polyester of a glycol and a dibasic acid, e.g. polyethylene adipate, polybutylene adipate, polyethylene succinate, and polybutylene succinate; an aliphatic polyester of an oxycarboxylic acid, e.g. polylactic acid and polyglycolic acid; an aliphatic polyester of a lactone, e.g. polycaprolactone, polypropiolactone, and polyvalerolactone; and a vinyl polymer, e.g. polyvinylpyrrolidone. Those plasticizers may be used singly or in combination with a low-molecular weight plasticizer.

Examples of the polyhydric alcohol-based plasticizer, which has high compatibility with a cellulose fatty acid ester and which exhibits a marked thermal plasticizing effect, include glycerin-based ester compounds, e.g. glycerin esters and diglycerin esters; and compounds each having an acyl group bonded to the hydroxyl group of polyalkylene glycol, e.g. polyethylene glycol and polypropylene glycol.

Specific examples of glycerin esters include, but are not limited to, glycerol diacetate stearate, glycerol diacetate palmitate, glycerol diacetate mystirate, glycerol diacetate laurate, glycerol diacetate caprate, glycerol diacetate nonanate, glycerol diacetate octanoate, glycerol diacetate heptanoate, glycerol diacetate hexanoate, glycerol diacetate pentanoate, glycerol diacetate oleate, glycerol acetate dicaprate, glycerol acetate dinonanate, glycerol acetate dioctanoate, glycerol acetate diheptanoate, glycerol acetate dicaproate, glycerol acetate divalerate, glycerol acetate dibutyrate, glycerol dipropionate caprate, glycerol dipropionate laurate, glycerol dipropionate mystirate, glycerol dipropionate palmitate, glycerol dipropionate stearate, glycerol dipropionate oleate, glycerol tributyrate, glycerol tripentanoate, glycerol monopalmitate, glycerol monostearate, glycerol distearate, glycerol propionate laurate, and glycerol oleate propionate, which may be used singly or in combination of two or more thereof.

Of those, glycerol diacetate caprylate, glycerol diacetate pelargonate, glycerol diacetate caprate, glycerol diacetate laurate, glycerol diacetate myristate, glycerol diacetate palmitate, glycerol diacetate stearate, and glycerol diacetate oleate are preferable.

Specific examples of diglycerol esters include, but are not limited to, mixed acid esters of diglycerol, e.g. diglycerol tetraacetate, diglycerol tetrapropionate, diglycerol tetrabutyrate, diglycerol tetravalerate, diglycerol tetrahexanoate, diglycerol tetraheptanoate, diglycerol tetracaprylate, diglycerol tetrapelargonate, diglycerol tetracaprate, diglycerol tetralaurate, diglycerol tetramystirate, diglycerol tetrapalmitate, diglycerol triacetate propionate, diglycerol triacetate butyrate, diglycerol triacetate valerate, diglycerol triacetate hexanoate, diglycerol triacetate heptanoate, diglycerol triacetate caprylate, diglycerol triacetate pelargonate, diglycerol triacetate caprate, diglycerol triacetate laurate, diglycerol triacetate mystirate, diglycerol triacetate palmitate, diglycerol triacetate stearate, diglycerol triacetate oleate, diglycerol diacetate dipropionate, diglycerol diacetate dibutyrate, diglycerol diacetate divalerate, diglycerol diacetate dihexanoate, diglycerol diacetate diheptanoate, diglycerol diacetate dicaprylate, diglycerol diacetate dipelargonate, diglycerol diacetate dicaprate, diglycerol diacetate dilaurate, diglycerol diacetate dimystirate, diglycerol diacetate dipalmitate, diglycerol diacetate distearate, diglycerol diacetate dioleate, diglycerol acetate tripropionate, diglycerol acetate tributyrate, diglycerol acetate trivalerate, diglycerol acetate trihexanoate, diglycerol acetate triheptanoate, diglycerol acetate tricaprylate, diglycerol acetate tripelargonate, diglycerol acetate tricaprate, diglycerol acetate trilaurate, diglycerol acetate trimystirate, diglycerol acetate tripalmitate, diglycerol acetate tristearate, diglycerol acetate trioleate, diglycerol laurate, diglycerol stearate, diglycerol caprylate, diglycerol mystirate, and diglycerol oleate, which may be used singly or in combination of two or more thereof.

Of those, diglycerol tetraacetate, diglycerol tetrapropionate, diglycerol tetrabutyrate, diglycerol tetracaprylate, and diglycerol tetralaurate are preferable.

Specific examples of polyalkylene glycols include, but are not limited to, polyethylene glycol and polypropylene glycol each having a number average molecular weight of 200 to 1,000, which may be used singly or in combination of two or more thereof.

Specific examples of compounds each having an acyl group bonded to the hydroxyl group of polyalkylene glycol include, but are not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linolate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linolate, which may be singly or in combination of two or more thereof.

The amount to be added of the plasticizer is preferably 0 to 20 mass %, more preferably 2 to 18 mass %, most preferably 4 to 15 mass %, to the cellulose acylate.

When the amount of the plasticizer to be added is more than 20 mass %, the plasticizer bleeds out to the surface of a film formed by melting and the glass transition temperature Tg which is an index for heat resistance lowers, although the thermal fluidity of cellulose acylate improves.

<Stabilizer>

In the present invention, a phosphite-based compound, phosphorous ester compound, phosphate, thiophosphate, weak organic acid, epoxy compound, or the like may be added singly or in combination of two or more thereof, as long as that do not impair the required properties, as a stabilizer for preventing heat deterioration or coloring. Specific examples of the phosphite-based stabilizer that can be preferably used, include compounds as described in the paragraphs [0023] to [0039] of JP-A-2004-182979. Specific examples of the phosphorous ester-based stabilizer that can be used, include compounds as described in JP-A-51-70316, JP-A-10-306175, JP-A-57-78431, JP-A-54-157159, and JP-A-55-13765.

The amount of the stabilizer to be added in the present invention is preferably 0.005 to 0.5 mass %, more preferably 0.01 to 0.4 mass %, particularly preferably 0.05 to 0.3 mass % based on cellulose acylate. An amount of the stabilizer of smaller than 0.005 mass % is not preferable, because a preventing effect on deterioration and a controlling effect on coloring may become unsatisfactory when a film is formed by melting. On the other hand, an amount of larger than 0.5 mass % is not preferable, because the stabilizer may bleed out to the surface of a cellulose acylate film formed by melting.

It is also preferred to add a degradation inhibitor and/or an antioxidant. By adding a phenol-based compound, thioether-based compound, phosphorus-based compound, or the like as a degradation inhibitor or antioxidant, synergistic effect on preventing degradation and oxidation can be exhibited. Further, as other stabilizers, use may be preferably made of materials as described in detail in pages 17 to 22 of the technical report of the Japan Institute of Invention and Innovation (technical report Ko-Gi No. 2001-1745, published by the Japan Institute of Invention and Innovation, on Mar. 15, 2001).

<Ultraviolet Ray Absorbent>

To the cellulose acylate according to the present invention, a ultraviolet ray absorbent may be added, which may be one kind or two or more kinds in combination. From the viewpoint of prevention of degradation of liquid crystal, the ultraviolet absorbent preferably has a large absorbance at wavelength 380 nm or less; and from the viewpoint of displaying property of image, the ultraviolet absorbent preferably has a small absorbance at wavelength 400 nm or more. Examples of preferred compounds include oxybenzophenone-series compounds, benzotriazole-series compounds, salicylate-series compounds, benzophenone-series compounds, cyanoacrylate-series compounds, and nickel complex-series compounds. The ultraviolet absorbent is more preferably a benzotriazole-series compound, or a benzophenone-series compound. The ultraviolet absorbent is particularly preferably a benzotriazole-series compound, since it is less in unnecessary coloring to the cellulose acylate.

Preferable examples of the ultraviolet absorbent include 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylene-bis[3-(3,5-di-tert-butyl-4-hydroxyphenyl)propionate], octadecyl-3-(3,5-di-tert-butyl-4-hydroxyphenyl)propionate, N,N′-hexamethylene-bis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)isocyanurate.

In addition to the above, as an ultraviolet absorbing agent, use may be also preferably made, for example, of a mixture of 2-ethylhexyl-3-[3-tert-butyl-4-hydroxy-5-(5-chloro-2H-benzotriazol-2-yl)phenyl]propionate and octyl-3-[3-tert-butyl-4-hydroxy-5-(chloro-2H-benzotriazol-2-yl)phenyl]propionate, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylene-bis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2H-benzotriazol-2-yl)-6-(linear chain and side chain dodecyl)-4-methylphenol, or a macromolecule ultraviolet absorbing agent, and the polymer type ultraviolet absorbing agent, as described in JP-A-06-148430.

Further, it is preferable to use 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate]. Further, combination use may be made, for example, of a hidrazine-series metal deactivating agent, e.g. N,N′-bis[3-(3,5-di-tert-butyl-4-hidroxyphenyl)propionyl]hidrazine; or a phosphor-series processing stabilizer, e.g. tris(2,4-di-tert-butylphenyl)phosphite. The amount to be added of any of these compound is preferably 1 ppm to 3.0%, more preferably 10 ppm to 2%, in terms of mass ratio to the cellulose acylate.

In addition to the above, any of various additives (e.g. an optical anisotropy controller, fine particles, an infrared absorber, a surfactant, an odor-trapping agent (e.g. amine), and the like) may be added to the cellulose acylate. The infrared absorbent may be, for example, one described in JP-A-2001-194522, and the ultraviolet ray absorbent may be, for example, one described in JP-A-2001-151901. Each of these is preferably incorporated at a ratio of 0.001 to 5 wt % to the cellulose acylate. The fine particles are preferably ones having an average particle diameter of 5 to 3,000 nm, and may be made of metal oxide or crosslinked polymer, which are preferably incorporated at a ratio of 0.001 to 5 wt % to the cellulose acylate. The deterioration inhibitor is preferably incorporated at a ratio of 0.0001 to 2 wt % to the cellulose acylate. The optical anisotropy controller may be, for example, one described in JP-A-2003-66230 or JP-A-2002-49128, and is preferably incorporated at a ratio of 0.1 to 15 wt % to the cellulose acylate.

The cellulose acylate film of the present invention can be formed by a solution-casting film formation method (hereinafter, this may also be referred to as “solution film formation”) or a melt-casting film formation method (hereinafter, this may also be referred to as “melt film formation”). Concrete methods of solution film-formation and melt-film-formation are described below.

(Solution Film Formation)

In solution film formation of the cellulose acylate in the present invention, the polymerization degree (viscosity average) of a cellulose acylate is preferably in the range from 150 to 500, more preferably from 200 to 450, and most preferably from 230 to 400. In molten film formation of the cellulose acylate in the present invention, the average polymerization degree of a cellulose acylate is preferably in the range from 130 to 700, more preferably from 150 to 600, and particularly preferably from 200 to 450.

(1) Solvent

In the present invention, either a halogen-type solvent or non-halogen-type solvent described below can be used to dissolve cellulose acylate.

(a) Halogen-Containing Solvent

The halogen-containing organic solvent is preferably dichloromethane or chloroform. Dichloromethane is particularly preferable. Any organic solvent other than the halogen-containing organic solvent may be mixed. In this case, it is necessary to use dichloromethane at a proportion of at least 50 wt %.

A halogen-free solvent used in combination with a halogen-containing solvent used as a main solvent in the present invention, is described below. Preferred examples of the halogen-free solvent include an ester, a ketone, an ether, an alcohol, and a hydrocarbon, each which have 3 to 12 carbon atoms. The ester, ketone, ether, or alcohol may have a cyclic structure. A compound having two or more functional groups of ester, ketone or ether (—O—, —CO— or —COO—) is also usable as the solvent. The organic solvent may have other functional groups such as alcoholic hydroxyl. If the solvent is the compound having two or more functional groups, the number of carbon atoms is in any of the above ranges. Examples of the ester having 3 to 12 carbon atoms include ethyl formate, propyl formate, pentyl formate, methyl acetate, ethyl acetate, and pentyl acetate. Examples of the ketone having 3 to 12 carbon atoms include acetone, methylethyl ketone, diethyl ketone, diisobutyl ketone, cyclopentanone, cyclohexanone and methylcyclohexane. Examples of the ether having 3 to 12 carbon atoms include diisopropyl ether, dimethoxymethane, dimethoxyethane, 1,4-dioxane, 1,3-dioxolan, tetrahydrofuran, anisole and phenetole. Examples of the compound having two or more functional groups include 2-ethoxyethyl acetate, 2-methoxyethanol and 2-butoxyethanol.

In the alcohol used with halogen-containing solvent, it may be in a straight, branched, or cyclic form. In particular, it is preferably an alcohol derived from a saturated aliphatic hydrocarbon. The alcohol may be any one of primary, secondary, and tertiary alcohols. Examples of the alcohol include methanol, ethanol, 1-propanol, 2-propanol, 1-butanol, 2-butanol, t-butanol, 1-pentanol, 2-methyl-2-butanol, and cyclohexanol.

The alcohol may be a fluorinated alcohol, e.g., 2-fluoroethanol, 2,2,2-trifluoroethanol, and 2,2,3,3-tetrafluoro-1-propanol. Further, the hydrocarbon may be in a straight, branched, or cyclic form. The hydrocarbon may be an aromatic hydrocarbon or an aliphatic hydrocarbon. The aliphatic hydrocarbon may be saturated or unsaturated. Examples of the hydrocarbon include cyclohexane, hexane, benzene, toluene, and xylene.

The halogen-free organic solvent which is used together with the halogen-containing organic solvent is not particularly limited, but may be selected from methyl acetate, ethyl acetate, methyl formate, ethyl formate, acetone, dioxolane, dioxane, ketones and acetoacetic acid esters having 4 to 7 carbon atoms, and alcohols and hydrocarbons having 1 to 10 carbon atoms. Preferable examples of the halogen-free organic solvent which is used together include methyl acetate, acetone, methyl formate, ethyl formate, methyl ethyl ketone, cyclopentanone, cyclohexanone, methyl acetylacetate, methanol, ethanol, 1-propanol, 2-propanol, 1-butanol, 2-butanol, cyclohexanol, cyclohexane, and hexane.

Preferable examples of the combination of the halogen-containing organic solvents used as a main solvent in the method of preparing cellulose acylate of the present invention are described below. However, the combination is not limited to these examples.
Dichloromethane/methanol/ethanol/butanol (80/10/5/5, mass parts),
Dichloromethane/acetone/methanol/propanol (80/10/5/5, mass parts),
Dichloromethane/methanol/butanol/cyclohexane (80/10/5/5, mass parts),
Dichloromethane/methyl ethyl ketone/methanol/butanol (80/10/5/5, mass parts),
Dichloromethane/acetone/methyl ethyl ketone/ethanol/isopropanol (75/10/5/5/5, mass parts),
Dichloromethane/cyclopentanone/methanol/isopropanol (80/10/5/5, mass parts),
Dichloromethane/methyl acetate/butanol (80/10/10, mass parts),
Dichloromethane/cyclohexanone/methanol/hexane (70/20/5/5, mass parts),
Dichloromethane/methyl ethyl ketone/acetone/methanol/ethanol (50/20/20/5/5, mass parts),
Dichloromethane/1,3-dioxolan/methanol/ethanol (70/20/5/5, mass parts),
Dichloromethane/dioxane/acetone/methanol/ethanol (60/20/10/5/5, mass parts),
Dichloromethane/acetone/cyclopentanone/ethanol/isobutanol/cyclohexane (65/10/10/5/5/5, mass parts),
Dichloromethane/methyl ethyl ketone/acetone/methanol/ethanol (70/10/10/5/5, mass parts),
Dichloromethane/acetone/ethyl acetate/ethanol/butanol/hexane (65/10/10/5/5/5, mass parts),
Dichloromethane/acetomethyl acetate/methanol/ethanol (65/20/10/5, mass parts),
Dichloromethane/cyclopentanone/ethanol/butanol (65/20/10/5, mass parts).
   (b) Halogen-Free Solvent

Halogen-free solvent which is preferably selected from an ester having 3 to 12 carbon atoms, a ketone having 3 to 12 carbon atoms, and an ether having 3 to 12 carbon atoms. The ester, the ketone, or the ether may have a cyclic structure. A compound having two or more functional groups of ester, ketone, or ether (that is, —O—, —CO—, or —COO—) is also usable as a main solvent. The solvent may have other functional group such as alcoholic hydroxyl group. If the main solvent is a compound having two or more kinds of functional groups, the number of carbon atoms of the solvent is within the limitation for a compound having either of the functional groups. Examples of the ester having 3 to 12 carbon atoms include ethyl formate, propyl formate, pentyl formate, methyl acetate, ethyl acetate, and pentyl acetate. Examples of the ketone having 3 to 12 carbon atoms include acetone, methylethyl ketone, diethyl ketone, diisobutyl ketone, cyclopentanone, cyclohexanone, and methylcyclohexanone. Examples of the ether having 3 to 12 carbon atoms include diisopropyl ether, dimethoxymethane, dimethoxyethane, 1,4-dioxane, 1,3-dioxolane, tetrahydrofuran, anisole, and phenetole. Examples of the compound having two or more kinds of functional groups include 2-ethoxyethyl acetate, 2-methoxyethanol, and 2-butoxyethanol.

The solvent used for the method of preparing the cellulose acylate of the present invention is preferably a mixed solvent composed of three or more kinds of solvents different from each other. The first solvent may be one selected from the following or a mixed solvent composed of two or more selected from the following: methyl acetate, ethyl acetate, methyl formate, ethyl formate, acetone, dioxolane, and dioxane. The second solvent may be one selected from ketones and acetoacetic acid esters having 4 to 7 carbon atoms. The third solvent may be selected from alcohols or hydrocarbons having 1 to 10 carbon atoms, preferably alcohols having 1 to 8 carbon atoms. When the first solvent is a mixed liquid composed of two or more solvents, none of the second solvent may be used. The first solvent is preferably methyl acetate, acetone, methyl formate, ethyl formate, or a mixture thereof. The second solvent is preferably methyl ethyl ketone, cyclopentanone, cyclohexanone, methyl acetylacetate, or a mixed liquid thereof.

The alcohol as the third solvent may be in a straight, branched, or cyclic form, particularly preferably in an aliphatic hydrocarbon. The alcohol may be any one of primary, secondary, and tertiary alcohols. Examples of the alcohol as the third solvent include methanol, ethanol, 1-propanol, 2-propanol, 1-butanol, 2-butanol, t-butanol, 1-pentanol, 2-methyl-2-butanol, and cyclohexanol. The alcohol may be a fluorinated alcohol.

Examples thereof include 2-fluoroethanol, 2,2,2-trifluoroethanol, and 2,2,3,3-tetrafluoro-1-propanol. Further the hydrocarbon may be in a straight, branched, or cyclic form. The hydrocarbon may be an aromatic hydrocarbon or an aliphatic hydrocarbon. The aliphatic hydrocarbon may be saturated or unsaturated. Examples of the hydrocarbon include cyclohexane, hexane, benzene, toluene, and xylene. The alcohols and the hydrocarbons as the third solvents may be used alone or in the form of a mixture of two or more thereof; there is no particular limitation on this. As the third solvent, specific examples of the preferred compound include, as alcohols: methanol, ethanol, 1-propanol, 2-propanol, 1-butanol, 2-butanol, and cyclohexanol; and cyclohexane, and hexane. Among these, methanol, ethanol, 1-propanol, 2-propanol, and 1-butanol are more preferable.

The mixed solvent of three kinds preferably contains 20 to 95 wt % of the first solvent, 2 to 60 wt % of the second solvent, and 2 to 30 wt % of the third solvent; more preferably 30 to 90 wt % of the first solvent, 3 to 50 wt % of the second solvent, and 3 to 25 wt % of the third solvent; most preferably 30 to 90 wt % of the first solvent, 3 to 30 wt % of the second solvent, and 3 to 15 wt % of the third solvent. When the first solvent is a mixed liquid and the second solvent is not used, a mixed solvent preferably contains 20 to 90 wt % of the first solvent and 5 to 30 wt % of the third solvent; more preferably 30 to 86 wt % of the first solvent and 7 to 25 wt % of the third solvent. The above-described horogen-free organic solvents used in the present invention are described in more detail in “Kokai Gihou,” 2001-1745, Mar. 15, 2001, pp. 12-16.

Preferable examples of the combination of the halogen-free organic solvents in the present invention are described below. However, the combination is not limited to these examples.
Methyl acetate/acetone/methanol/ethanol/butanol (75/10/5/5/5, mass parts),
Methyl acetate/acetone/methanol/ethanol/propanol (75/10/5/5/5, mass parts),
Methyl acetate/acetone/methanol/butanol/cyclohexane (75/10/5/5/5, mass parts),
Methyl acetate/acetone/ethanol/butanol (81/8/7/4, mass parts);
Methyl acetate/acetone/ethanol/butanol (82/10/4/4, mass parts),
Methyl acetate/acetone/ethanol/butanol (80/10/4/6, mass parts),
Methyl acetate/methyl ethyl ketone/methanol/butanol (80/10/5/5, mass parts)
Methyl acetate/acetone/methyl ethyl ketone/ethanol/isopropanol (75/10/5/5/5, mass parts)
Methyl acetate/cyclopentanone/methanol/isopropanol (80/10/5/5, mass parts)
Methyl acetate/acetone/butanol (85/10/5)
Methyl acetate/cyclopentanone/acetone/methanol/butanol (60/15/15/5/5/5, mass parts)
Methyl acetate/cyclohexanone/methanol/hexane (70/20/5/5, mass parts),
Methyl acetate/methyl ethyl ketone/acetone/methanol/ethanol (50/20/20/5/5, mass parts),
Methyl acetate/1,3-dioxolane/methanol/ethanol (70/20/5/5, mass parts),
Methyl acetate/dioxane/acetone/methanol/ethanol (60/20/10/5/5, mass parts),
Methyl acetate/acetone/cyclopentanone/ethanol/isobutanol/cyclohexane (65/10/10/5/5/5, mass parts),
Methyl formate/methyl ethyl ketone/acetone/methanol/ethanol (50/20/20/5/5, mass parts),
Methyl formate/acetone/ethyl acetate/ethanol/butanol/hexane (65/10/10/5/5/5, mass parts),
Acetone/methyl acetoacetate/methanol/ethanol (65/20/10/5, mass parts),
Acetone/cyclopentanone/ethanol/butanol (65/20/10/5, mass parts),
Acetone/1,3-dioxolane/ethanol/butanol (65/20/10/5, mass parts),
1,3-Dioxolane/cyclohexanone/methyl ethyl ketone/methanol/butanol (60/20/10/5/5, mass parts).

Further, after dissolution of cellulose acylate, it is preferable that a part of solvent is added into cellulose acylate additionally to dissolve cellulose acylate in multiple dissolution steps described below.
Preparation of a solution of cellulose acylate, using methyl acetate/acetone/ethanol/butanol (81/8/7/4 mass parts), the application of filtration to the solution, the concentration of the solution, and further addition of 2 parts by mass of butanol thereto;
Preparation of a solution of cellulose acylate, using methyl acetate/acetone/ethanol/butanol (84/10/4/2 mass parts), the application of filtration to the solution, the concentration of the solution, and further addition of 4 parts by mass of butanol thereto; and
Preparation of a solution of cellulose acylate, using methyl acetate/acetone/ethanol (84/10/6 mass parts), the application of filtration to the solution, the concentration of the solution, and further addition of 5 parts by mass of butanol thereto.
   (2) Dissolution

Whether the solvent of the dope of the present invention contains chlorine or no chlorine, cellulose acylate is dissolved in this solvent preferably at a ratio of 10 to 35 wt %, more preferably at a ratio of 13 to 33 wt %, most preferably at a ratio of 15 to 30 wt %.

In advance of dissolution, it is preferable that cellulose acylate, which is not yet formed into a film or is already formed into a film, is dried, and that its water contents is made to be preferably of 2 wt % or below, more preferably of 1 wt % or below.

It is preferable that cellulose acylate is swollen at temperatures from 0° C. to 50° C. for one hour to 100 hours, after mixing these cellulose acylate with a solvent.

The various additives may be added to the solution before the swelling step, in the middle of the step, or after the step. Alternatively, after the swelling step, the additives may be added thereto in the middle of the step of cooling and dissolving the cellulose acylate or after this step. Examples of the additives include, for example, a plasticizer, an ultraviolet absorber, a deterioration inhibitor, an optical anisotropy controller, fine particles, an infrared absorber, and a surfactant. The plasticizer may be, other than those described above, for example, one described in JP-A-2000-352620, and is preferably incorporated at a ratio of 0.1 to 25 wt % of the cellulose acylate, more preferably of 0.5 to 15 wt %, and most preferably of 1 to 10 wt %. The infrared absorbent may be, for example, one described in JP-A-2001-194522, and the ultraviolet ray absorbent may be, for example, one described in JP-A-2001-151901. Each of them is preferably incorporated at a ratio of 0.001 to 5 wt % of the cellulose acylate. The fine particles may be preferably ones having an average particle size of 5 to 3000 nm, and may be made of metal oxide or crosslinked polymer. The fine particles are preferably incorporated at a ratio of 0.001 to 5 wt % of the cellulose acylate. The deterioration inhibitor is preferably incorporated at a ratio of 0.0001 to 2 wt % of the cellulose acylate. The optical anisotropy controller may be, for example, one described in JP-A-2003-66230 or 2002-49128, and is preferably incorporated at a ratio of 0.1 to 15 wt % of the cellulose acylate.

In the present invention, cellulose acylate may be dissolved at ordinary temperature or dissolved by a cooling-temperature rise method. At this time, the following method can be used: a method described in JP-A-11-323017, 10-67860, 10-95854, 10-324774 or 11-302388. That is, the cellulose acylate is mixed with the solvent, swelled, and dissolved in the solvent by use of a screw-shaped kneader to which a cooling jacket is fitted.

Usually, the dope of the present invention is preferably subjected to concentration and filtration. These are described in detail in “Kokai Gihou” 2001-1745, Mar. 15, 2001, p. 25.

(3) Film-Formation

A specific method of embodiments of a solution film-formation method is described in order of its procedures.

Cellulose acylate prepared according to the above described process is dissolved in such a manner as described above to form a dope, which is a high concentrated solution of cellulose acylate. The dope is filtered and deaerated, and then maintaining at 35° C. Thereafter, the dope thus maintained at 35° C. is sent to a pressurized die through a metering pump (for example, a pressurized metering gear pump capable of metering and sending liquid highly precisely by the number of revolutions), and cast uniformly onto a metal-made flat supporting structure such as a drum, band, etc. via an extruder head (slit). In the flow casting, one kind cellulose acylate solution for a monolayer may be cast, or two or more kinds of cellulose acylate solutions may be multi-cast simultaneously or successively. In the case of carrying out casting steps for forming two or more layers, the kinds of the cellulose acylates, solvents and additives for the respective layers, and the concentrations thereof may be the same or different.

After casting, the dope is dried on the flat supporting structure and is peeled off to obtain half-dried dope. The half-dried dope film, the so-called “web”, is dried while transferring and is peeled off in a state of half-dried dope containing the remaining solvent in 20 wt % or above. After the dope thus obtained is dried in such a manner as described above, its both edges are trimmed off. Thereafter, the dope thus trimmed is subjected to an embossing process (knurling process) and then is wound up around a wind-up roll. The ratio of the solvent remaining in the film is preferably from 0 to 5%, more preferably from 0 to 2%, even more preferably from 0 to 1% after the drying of the film is finished. After the finish of the drying, the film is wound up while both ends (i.e., both side ends) of the film are trimmed. In the first embodiment of the present invention, the trimmed scraps are cut, and the cut scraps are used as collected wastes to produce a dope, as described above. The width of the film after the trimming is preferably from 0.5 to 5 m, more preferably from 0.7 to 3 m, even more preferably from 1 to 2 m. The length of the wound film is preferably from 300 to 30,000 m, more preferably from 500 to 10,000 m, even more preferably from 1,000 to 7,000 m.

(Melt Film Formation)

To form a film from the cellulose acylate according to the present invention by melt film-forming, the acyl-substitution degree of cellulose acylate preferably satisfies the following formulas (1a) to (3a):
2.0≦A+B≦3.0 formula (1a)
0≦A≦2.0 formula (2a)
1.2≦B≦2.9 formula (3a)
wherein A is the substitution degree of acetyl group, B is the sum total of the substitution degree(s) of an acyl group(s) having 3 to 7 carbon atoms.

Among the acyl groups having 3 to 7 carbon atoms, which are subject for the above substitution degree B, preferable examples include propionyl, butyryl, 2-methylpropionyl, pentanoyl; 3-methylbutyryl, 2-methylbutyryl, 2,2-dimethylpropionyl (pivaloyl), hexanoyl, 2-methylpentanoyl, 3-methylpentanoyl, 4-methylpentanoyl, 2,2-dimethylbutyryl, 2,3-dimethylbutyryl, 3,3-dimethylbutyryl, cyclopentancarbonyl, heptanoyl, cyclohexanecarbonyl, and benzoyl. The acyl group for the above substitution degree B is more preferably propionyl, butyryl, pentanoyl, hexanoyl or benzoyl, particularly preferably propionyl or butyryl, and most preferably propionyl.

When a film is formed from the cellulose acylate according to the present invention by melt film-forming, (A+B) is preferably 2.0 to 3.0, more preferably 2.4 to 3.0, particularly preferably 2.5 to 2.95. (A+B) of smaller than 2.0 is not preferable, since the hydrophilic nature of cellulose acylate increases and the moisture permeability of the obtained film increases.

Preferably, A satisfies to be 0 to 2.0, more preferably 0.05 to 1.8, particularly preferably 0.1 to 1.6.

Preferably, B satisfies to be 1.2 to 2.9, more preferably 1.3 to 2.9, particularly preferably 1.5 to 2.9.

Further, the cellulose acylate according to the present invention is preferably to be set the amount of the residual sulfate group to the range from 0 to 300 ppm, more preferably 0 to 200 ppm, particularly preferably 0 to 100 ppm, to improve heat stability. Cellulose acylate having high heat stability is less in being colored when a film is formed therefrom by melt film-forming, and a cellulose acylate optical film having high transparency can be obtained.

The term “amount of the residual sulfate group” as used herein means the total amount of free sulfuric acid, salt, ester, complex, and the like contained in cellulose acylate, and it is defined by the content of sulfur atoms. That is, the content of sulfur atoms is determined, for example, by converting 98 g of sulfuric acid to 32 g of sulfur atoms.

The amount of the sulfate group can be measured by: an oxidation decomposition/coulometric titration method in which sulfur dioxide formed by thermally decomposing the sulfate group contained in a specimen and burning it in an oxygen stream is absorbed into an electrolyte in a titration cell and subjected to coulometric titration with triiodide ions; an oxidation decomposition/ultraviolet fluorescent method; ASTM D-817-96; or the like.

To form a film from the cellulose acylate according to the present invention by melt film-forming, the average polymerization degree of cellulose acylate is preferably 100 to 700, more preferably 120 to 600, and particularly preferably 130 to 450. The average polymerization degree can be measured by, for example, a molecular weight distribution measuring method making use of gel permeation chromatography (GPC), as described in “Intrinsic viscosity method” of Uda et al. (Kazuo Uda, Hideo Saito, Journal of the Society of Fiber and Technology (Sen-i Gakkai), vol. 18, No. 1, pp. 105 to 120, 1962). Further, the method of measuring the average polymerization degree is described in detail in JP-A-09-95538.

To form a film of the cellulose acylate according to the present invention by melt film-forming, the ratio of weight average polymerization degree to number average polymerization degree measured by GPC of cellulose acylate is preferably 2.0 to 6.0, more preferably 2.2 to 5, particularly preferably 2.4 to 4.0.

(1) Drying

A raw material for forming a film of cellulose acylate of the present invention is preferably pelletized cellulose acylate. That is to say, water contents in a pellet is made to be preferably 1% or below, more preferably 0.5% or below in advance of melt film-formation and the pellet thus treated is put into a hopper of a casting extruder. At this time, the hopper is maintained preferably in the range from Tg−50° C. to Tg+30° C., more preferably in the range from Tg−40° C. to Tg+10° C., and specifically in the range from Tg−30° C. to Tg. Thereby, re-absorption of water inside the hopper can be suppressed and the efficiency of the above-described drying can be easily improved.

(2) Kneading Extrusion

Kneading extrusion is carried out preferable at temperatures of 120° C. to 250° C., more preferably 140° C. to 220° C., and particularly preferably 150° C. to 200° C. At this time, melting may be carried out at a constant temperature or at different temperatures in several steps. Kneading time is preferably from two minutes to 60 minutes, more preferably from three minutes to 40 minutes and particularly preferably from four minutes to 30 minutes. It is also preferable to carry out kneading extrusion by the use of a casting extruder the inside of which is purged with inert gas such as nitrogen gas, etc. Or, it is also preferable to carry out kneading extrusion while evacuating the inside of a casting extruder equipped with a vent.

(3) Film-Formation

Molten resin may be passed through a gear pump and filtered through a metal mesh filter after removal of pulsation of an extruder, and extruded in a state of sheet onto a cooling drum from a T-die mounted at the back of the extruder. A single layer of sheet of resin may be extruded or multi-layer of sheet of resin may be extruded by the use of a multi-manifold die or feed block die. At this time, unevenness of crosswise thickness can be adjusted by adjusting the space between lips of the die.

Thereafter, the sheet may be extruded onto a casting drum. At this time, it is preferable to increase the adhesion between the casting drum and the casting-extruded sheet by an electrostatic application method, an air knife method, an air chamber method, a vacuum nozzle method, a touch roll method, etc. Such a method of improving adhesion as described above may be applied onto the whole surface of the cast-extruded sheet or a par thereof.

The casting drum is maintained preferably at temperatures from 60° C. to 160° C., more preferably at temperatures from 70° C. to 150° C., and particularly preferably at temperatures from 80° C. to 150° C. Thereafter, the sheet may be peeled off from the casting drum and wound up around a wind-up roll via a nip-roll. Wind-up speed is preferably from 10 m/minute to 100 m/minute, more preferably from 15 m/minute to 80 m/minute, and particularly preferably from 20 m/minute to 70 m/minute.

The width of the film thus formed is preferably from 1 m to 5 m, more preferably from 1.2 m to 4 m and particularly preferably from 1.3 m to 3 m. The thickness of a non-stretched film thus obtained is preferably from 30 μm to 400 μm, more preferably from 40 μm to 300 μm and particularly preferably from 50 μm to 200 μm.

The sheet thus obtained is preferably wound-up around a wind-up roll after both edges of the sheet are trimmed off. Then, both edges of the sheet are ground and are subjected to a granulation process or depolymerization or re-polymerization process, if necessary to obtain a reground material. The reground material thus obtained may be reused as a raw material for the same kind of film as the reground material or for the different kinds of films from the reground material. Before the sheet is wound-up around a wind-up roll, it is preferable from the standpoint of prevention of scratch to bond a laminated film on at least one surface of the sheet.

In the present invention, Re and the Rth indicate the in-plane retardation and the retardation in the direction of the thickness respectively. Re is measured by making light having a wavelength of λ nm incident in the direction of the normal of the film in KOBRA 21ADH (trade name, manufactured by Oji Scientific Instruments). Rth is calculated by KOBRA 21ADH based on the retardation values measured in plural directions, such as the above Re, the retardation value measured by allowing light having a wavelength of λ nm to be incident from a direction inclined at an angle of +40° with the direction of the normal of the film by adopting the slow axis (which is determined by the KOBRA 21ADH) within the surface as a slant axis (rotation axis), and the retardation value measured by allowing light having a wavelength of λ nm to be incident from a direction inclined at an angle of −40° with the direction of the normal of the film by adopting the slow axis within the surface as a slant axis (rotation axis). The wave length of λ nm may be in the range of from 450 to 750 nm, in the present invention, it is 550 unless other specific value is not described. Herein, as the hypothetical value of the average refractive index, the values described in “Polymer Handbook” (JOHN WILEY & SONS, INC) and the values described in the catalogues of various optical films may be used. Unknown average refractive indexes may be determined by Abbe refractometer. Average refractive indexes of major optical films are described as follows: cellulose acylate (1.48), cycloolefine polymer (1.52), polycarbonate (1.59), polymethyl methacrylate (1.49), and polystyrene (1.59).

KOBRA21ADH calculates nx (refractive index in the direction of the slow axis within the surface), ny (refractive index in the direction of the fast axis within the surface) and nz (refractive index in the direction of the thickness of the film), by inputting these hypothetical values of the average refractive index and the film thickness.

The cellulose acylate film of the present invention preferably satisfies Re and Rth described below. Re is preferably from 0 to 300 mm, more preferably from 0 to 250 nm, and most preferably from 10 to 200 nm. Rth is preferably from 0 to 500 nm, more preferably from 20 to 400 mm, and most preferably from 30 to 350 nm.

(Stretching)

Next, stretching of a cellulose acylate film prepared by a solution film-formation method or a melt film-formation method according to the present invention is described.

It is preferable to stretch a cellulose acylate film in order to develop Re and Rth. The stretching may be carried out on-line in the process of film-formation or may be carried out off-line after a cellulose acylate film is wound-up after completion of film-formation. That is to say, in the case of a solution film-formation method, the stretching may be carried out in a state of non-dried film in the process of film-formation (for example, between the time when peeling-off of the sheet from the casting supporting structure and the time of the completion of drying) or may be carried out after the completion of drying; in the case a melt film-formation method, the stretching may be carried out before the completion of cooling in the process of film-formation or after the completion of cooling. The stretching may be carried out at temperature in the range of preferably from Tg to Tg+50, more preferably from Tg+1° C. to Tg+30° C., and most preferably from Tg+2° C. to Tg+20° C. A stretching ratio may be preferably from 10 to 300%, more preferably from 20 to 250%, and most preferably from 30 to 200%. The stretching may be carried out in a single step or multiple steps. The stretching ratio herein used is defined as described below:
Stretch ratio (%)=100×[(length after stretching)−(length before stretching)]/(length before stretching).

Such stretching may be carried out by lengthwise stretching, crosswise stretching or combination thereof. The lengthwise stretching may be carried out by the use of (1) a roll stretching method in which stretching is performed in the direction of the length by the use of two or more pairs of nip roles the peripheral speed at the outlet of which is higher, (2) a fixed-edge stretching method in which both edges of a film are grasped and transferred lengthwise at the speed gradually increased to perform the stretching in the direction of the length of film, etc. The crosswise stretching may be carried out by the use of a tenter in which both edges of a film are grasped by a chuck and extended to crosswise direction (in the direction perpendicular to lengthwise direction) to perform the stretching. The lengthwise stretching and the crosswise stretching may be carried out singly (monoaxial stretching) or in combination thereof (biaxial stretching). In the case of biaxial stretching, the lengthwise stretching and the crosswise stretching may be sequentially carried out (sequential stretching) or simultaneously (simultaneous stretching).

The stretching speeds of the lengthwise stretching and the crosswise stretching are preferably from 10%/minute to 10000%/minute, more preferably from 20%/minute to 1000%/minute, and particularly preferably from 30%/minute to 800%/minute, In the case of multiple-step stretching, such stretching speeds refer to mean value of the stretching speed at each of steps.

Following such stretching as above described, relaxation is preferably carried out to the lengthwise direction or crosswise direction by from 0% to 10%. Further, following the stretching, heat setting is preferably carried out at temperatures in the range from 150° C. to 250° C. for time from 1 second to three minutes.

Rth developed by such stretching as above described is preferably from 0 nm to 500 nm, more preferably from 40 nm to 400 nm, and specifically preferably from 60 nm to 350 nm, Re is preferably from 0 nm to 300 nm, more preferably from 20 nm to 250 nm, and particularly preferably from 40 nm to 200 nm.

The relationship between Re and Rth is preferably Re≦Rth, more preferably Re×1.5≦Rth and particularly preferably Re×2≦Rth. Such relationship between Re and Rth can be obtained by fixed-edge monoaxial stretching, more preferably by lengthwise and crosswise biaxial stretching. That is to say, by stretching a film to lengthwise direction and crosswise direction, difference between the refractive index (n_{md}, n_{td}) of the inside of a stretched film can be made small and, as a result, Re can be made small. Further, by stretching a film to lengthwise direction and crosswise direction to enlarge the area of a stretched film, orientation toward the thickness of a stretched film can be made strong while the thickness decreases, and Rth can be made large. By setting Re and Rth in such a manner as above described, light leakage in a black display can be decreased.

The thickness of a film stretched in such a manner as above described is preferably from 10 to 300 μm, more preferably from 20 to 200 μm and particularly preferably from 30 to 100 μm.

An angle (θ) which the direction of film-formation (lengthwise direction) forms with a retardation axis of Re of a film is preferably as closer as possible to 0 degree, +90 degree or −90 degree. That is to say, in the case of lengthwise stretching, such an angle (θ) is preferably as closer as possible to 0 degree, more preferably 0±3 degree, further more preferably 0±2 degree and particularly preferably 0±1 degree; in the case of crosswise stretching, such an angle (θ) is preferably 90±3 degree or −90±3 degree, more preferably 90±2 degree or −90±2 degree and particularly preferably 90±1 degree or −90±1 degree.

The above-described non-stretched or stretched cellulose acylate film may be used singly, or may be used in combination with a polarizing plate. Alternatively, a liquid crystal layer, a refractive index controlling layer (low reflective layer) or a hard coat layer may be bonded on them to use.

(Elasto-Optic Factor)

The cellulose acylate film of the present invention may be preferably used for a polarizing plate protective film or a phase contrast plate. When the cellulose acylate film of the present invention is used for a polarizing plate protective film or a phase contrast plate, double refraction (Re, Rth) may change by stress caused by elongation and shrinkage of a film by moisture absorption. Such change in double refraction caused by stress can be measured as an elasto-optic factor; it is preferably from 5×10⁻⁷(cm²/kgf) to 30×10⁻⁷(cm²/kgf), more preferably from 6×10⁻⁷(cm²/kgf) to 25×10⁻⁷(cm²/kgf) and particularly preferably from 7×10⁻⁷(cm²/kgf) to 20×10⁻⁷(cm²/kgf).

(Surface Treatment)

A stretched or non-stretched cellulose acylate film may be subjected to a surface treatment, if necessary, in order to achieve strong adhesion between the cellulose acylate film and each functional layers (e.g., subbing layer and backing layer). For example, a glow discharge treatment, an ultraviolet ray treatment, a corona discharge treatment, a flame treatment, an acid treatment, and an alkali treatment may be applied. The glow discharge treatment referred to herein may be a treatment with low-temperature plasma (thermal plasma) generated in a low-pressure gas having a pressure of 10⁻³ to 20 Torr, or preferably with plasma under the atmospheric pressure. A plasma excitation gas is a gas which can be excited to plasma under conditions as described above, and examples thereof include argon, helium, neon, krypton, xenon, nitrogen, carbon dioxide, frons such as tetrafluoromethane, and a mixture thereof. Details thereof are described in “Kokai Gihou,” 2001-1745, published on Mar. 15, 2001, pp. 30-32. In the plasma treatment under the atmospheric pressure, to which attention has been paid in recent years, for example, a radiating energy of 20 to 500 kGy is used under a condition of 10 to 1,000 keV, and preferably a radiating energy of 20 to 300 kGy is used under a condition of 30 to 500 keV. Of these treatments, an alkali saponifying treatment is particularly preferable, which treatment is quite effective as the surface treatment for the cellulose acylate film.

The alkali saponifying treatment may be conducted by immersing the film into a saponifying solution, or applying a saponifying solution onto the film. In the case of the immersing method, the treatment can be attained by passing the film into a tank wherein an aqueous solution of NaOH, KOH or the like which has a pH of 10 to 14 and is heated to 20 to 80° C. is put for 0.1 to 10 minutes, neutralizing the solution on the film, washing the film, and drying the film.

The application method includes dip coating, curtain coating, extrusion coating, bar coating and type E coating. As the solvent in the alkali saponifying treatment coating solution, it is preferable to employ a solvent which has an excellent wettability appropriate for applying the saponifying solution to a transparent support and can hold favorable surface conditions without forming any irregularity on the transparent support surface. More specifically speaking, it is preferable to use an alcoholic solvent, and particularly preferably isopropyl alcohol. It is also possible to employ an aqueous solution of a surfactant as the solvent. As the alkali in the liquid saponifying solution, it is preferable to use an alkali soluble in the above-described solvent and KOH and NaOH are still preferable. It is preferable that the liquid saponifying agent has a pH value of 10 or more, still preferably 12 or more. Concerning the reaction conditions, it is preferable to perform the saponification at room temperature for 1 to 5 minutes, still preferably for 5 seconds to 5 minutes and particularly preferably for 20 seconds to 3 minutes. After the completion of the alkali saponification reaction, it is preferable to wash with water; or wash with acid and then wash with water, the face coated with the liquid saponifying agent. The solution-applying manner saponifying treatment, and the application of an oriented film, which will be detailed later, may be continuously conducted. In the case, the number of steps can be reduced. These saponifying methods are specifically described in, for example, JP-A-2002-82226 and WO 02/46809.

It is preferable to form an undercoat layer on the film in order to bond the film to a functional layer. This layer may be applied onto the film after the above-mentioned surface treatment is conducted, or without conducting any surface treatment. Details of the undercoat layer are described in “Kokai Gihou” 2001-1745, Mar. 15, 2001, p. 32.

The surface treatment, and the undercoating step may be integrated, as a final stage, into the film forming process, or may be carried out independently or in the middle of the step of forming the functional layer, which will be detailed just below.

(Functional Layer)

It is preferable to combine the cellulose acylate film of the present invention with one or more out of the functional layers details of which are described in “Kokai Gihou” 2001-1745, Mar. 15, 2001, pp. 32-45. Of these functional layers, preferable are a light-polarizing layer, which is used to form a polarizing plate, an optically compensating layer, which is used to form an optically compensating sheet, and an antireflection layer, which is used to an antireflection film.

(1) Addition of a Light Polarizing Layer (Production of a Polarizing Plate)

[Material to be Used]

At present, a commercially available light-polarizing layer may be generally formed by immersing a drawn polymer into a solution of iodine or a dichroic dye in a bath, thereby causing the iodine or dichroic dye to permeate the binder. As the light-polarizing film, a coating type light-polarizing film, typical examples of which are manufactured by Optiva Inc., can also be used. The iodine or the dichroic dye in the light-polarizing film is oriented in the binder, thereby exhibiting light-polarizing performance. Examples of dichroic dyes include azo-series dyes, stilbene-series dyes, pyrazolone-series dyes, triphenylmethane-series dyes, quinoline-series dyes, oxazine-series dyes, thiazine-series dyes and anthraquinone-series dyes. Of these dyes, water-soluble dyes are preferred. The dichroic dyes preferably contains hydrophilic substituent, such as sulfonic acid, amino and hydroxyl groups. Examples thereof include compounds described in “Kokai Gihou” 2001-1745, Mar. 15, 2001, p. 58.

The binders of light-polarizing film can be polymers capable of cross-linking by themselves, polymers capable of undergoing cross-linking reaction in the presence of a cross-linking agent, or combinations thereof. Examples of these binders include methacrylate-series copolymer, styrene-series copolymers, polyolefins, polyvinyl alcohols (PVAs), modified PVAs, poly(N-methylolacrylamides), polyesters, polyimides, vinyl acetate copolymers, carboxymethyl celluloses, polycarbonates, and the like described in paragraph [0022] of the specification in JP-A-8-338913. A silane coupling agent can be used as a polymer.

These binders preferably include water-soluble polymers such as poly(N-methylolacrylamides), carboxymethyl celluloses, gelatin, PVAs and modified PVAs, more preferably gelatin, PVAs and modified PVAs, most preferably PVAs and modified PVAs. It is particularly preferred to use two kinds of polyvinyl alcohols or modified polyvinyl alcohols having different polymerization degrees. PVAs usable in the invention have a saponification degree in the range of, preferably 70 to 100%, more preferably 80 to 100%. The suitable polymerization degree thereof is from 100 to 5,000.

The modified PVAs used to particular advantage includes the compounds disclosed in JP-A-8-338913, JP-A-9-152509 and JP-A-9-316127. Two or more kinds of polyvinyl alcohols or modified polyvinyl alcohols may be used together.

The lower limit of the thickness of the binder is preferably 10 μm. The upper limit of the thickness is preferably as thin as possible from the viewpoint of light leakage from the liquid crystal display device. The thickness is preferably thinner than the thickness (about 30 μm) of polarizing plates commercially available at the present, and is more preferably 25 μm or less, further preferably 20 μm or less.

The binder in the light-polarizing film may be crosslinked. A polymer or monomer having a crosslinkable functional group may be incorporated into the binder, or a crosslinkable functional group may be given to the binder polymer itself. The crosslinking may be attained by light, heat, or pH change, so as to make it possible to cause the binder to have a crosslinked structure. Crosslinking agents are described in U.S. Patent Re-issue No. 23297. A boron compounds (such as boric acid or borax) also may be used as a crosslinking agent. The amount of the crosslinking agent added to the binder is preferably from 0.1 to 20 wt % of the binder. In this case, the orientation of the polarizer and the wet heat resistance of the light-polarizing film become good.

After the end of the crosslinking reaction, the amount of the crosslinking agent which has not reacted is preferably 1.0 wt % or less, more preferably 0.5 wt % or less. This way makes it possible to improve the weather resistance of the film.

[Drawing]

It is preferable that the light-polarizing film is drawn (drawing process) or is rubbed (rubbing process), and subsequently the film is dyed with iodine or a dichroic dye.

In the case of the drawing process, the draw ratio of the film is preferably from 2.5 to 30.0, more preferably from 3.0 to 10.0. The drawing can be carried out by dry drawing in the air or wet drawing in the state that the film is immersed in water. The draw ratio in the dry drawing is preferably from 2.5 to 5.0, and the draw ratio in the wet drawing is preferably from 3.0 to 10.0. The drawing may be performed in parallel to the direction along which the film is carried (parallel drawing), perpendicularly to the film-carried direction (lateral one-axial drawing), or obliquely (oblique drawing). This drawing may be attained by one drawing operation or plural drawing operations. The drawing based on the plural drawing operations makes it possible to draw the film homogeneously even when a high-ratio drawing is performed.

More preferable is oblique drawing wherein the film is drawn at an angle of 10 to 80 degrees oblique to the film-carried direction.

(a) Parallel Drawing Process

Before the film is drawn, the PVA film may be swelled. The swelling degree thereof (the ratio by weight of the film before the swelling to the film after the swelling) is preferably from 1.2 to 2.0. Thereafter, while the film may be continuously carried through guide rollers and so on, the film is drawn in an aqueous medium bath or a dyeing bath wherein a dichroic material is dissolved at a bath temperature of preferably 15° C. to 50° C., more preferably 17° C. to 40° C. The drawing can be attained by grasping the film by means of two pairs of nip rollers, the carrying rate of the backward nip rollers being made larger than that of the forward nip rollers. The draw ratio, which is the ratio of the length of the drawn film to that of the film at the initial stage (this being the same hereinafter), is preferably from 1.2 to 3.5, more preferably from 1.5 to 3.0 from the viewpoint of the above-mentioned effects and advantages. Thereafter, the film may be dried at 50 to 90° C. to yield a light-polarizing film.

(b) Oblique Drawing Process

As this process, a method described in JP-A-2002-86554 can be used wherein a tenter projected in an oblique direction is used to perform drawing. Since this drawing is performed in the air, it is necessary to hydrate the film beforehand so as to be made easy to draw. The water content in the film is preferably from 5 to 100%, more preferably from 10 to 100%.

The temperature when the film is drawn is preferably from 40° C. to 90° C., more preferably from 50° C. to 80° C. The humidity is preferably from 50 to 100% RH, more preferably from 70 to 100% RH, further preferably from 80 to 100% RH. The advance speed in the longitudinal direction is preferably 1 m/minute or more, more preferably 3 m/minute or more.

After the end of the drawing, the film is dried preferably at 50° C. to 100° C., more preferably at 60° C. to 90° C., preferably for 0.5 to 10 minutes, more preferably for 1 to 5 minutes.

The angle of the absorption axis of the thus-obtained light-polarizing film is preferably from 10 to 80 degrees, more preferably from 30 to 60 degrees, further preferably substantially 45 degrees (from 40 to 50 degrees).

[Adhesion]

The saponified cellulose acylate film and the light-polarizing layer prepared by the drawing may be adhered to each other to prepare a polarizing plate. About the direction along which they are adhered to each other, the angle between the direction of the flow casting axis of the cellulose acylate film and the draw axis of the polarizing plate is preferably set to 45 degrees.

The adhesive agent for the adhesion is not particularly limited. Examples thereof include PVA-series resins (which may be modified with an acetoacetyl, sulfonic acid, carboxyl, oxyalkylene or some other group); and an aqueous solution of a boron compound. The PVA-series resins are particularly preferable. The thickness of the adhesive agent layer is preferably from 0.01 to 10 μm, more preferably from 0.05 to 5 μm after the layer is dried.

It is more preferable that the light transmittance of the thus-obtained polarizing plate is higher and the polarization degree thereof is higher. The light transmittance of the polarizing plate to light having a wavelength of 550 nm is preferably from 30 to 50%, more preferably from 35 to 50%, most preferably from 40 to 50%. The polarization degree thereof to light having a wavelength of 550 nm is preferably from 90 to 100%, more preferably from 95 to 100%, most preferably from 99 to 100%.

The thus-obtained polarizing plate is laminated on a λ/4 plate, whereby a circular polarization plate can be produced. In this case, the laminating is preferably carried out to set the angle between the retarded phase axis of the λ/4 plate and the absorption axis of the polarizing plate to 45 degrees. At this time, the λ/4 plate is not particularly limited, and is preferably a λ/4 plate having a wavelength dependency such that the retardation thereof is smaller to a lower wavelength. It is also preferable to use a λ/4 plate composed of a light-polarizing film having an absorption axis inclined at an angle of 20 to 70 degrees to the longitudinal direction and an optically anisotropic layer made of a liquid crystal compound.

The thickness of the polarizing film (layer) is preferably from 25 to 350 μm, more preferably from 30 to 200 μm, most preferably from 40 to 120 μm. When the cellulose acylate film of the present invention is used as a protective film of a polarizing layer, either stretched film or non-stretched film may be applied for the purpose. Further, the stretched cellulose acylate film of the present invention may be used as a functional film for protection of polarizing layer, and preferably used as a functional film for compensation of phase difference. Polarizing plate thus obtained preferably has a construction described below. In the embodiment described below, non-stretched cellulose acylate film includes, for example, “FUJITAC TD80, TD80U, TD80UF” (trade mark) manufactured from FUJI PHOTO FILM CO.LTD.
Polarizing plate A: non-stretched cellulose acylate film/polarizing film/non-stretched cellulose triacetate film,
Polarizing plate B: non-stretched cellulose acylate film/polarizing film/non-stretched cellulose acylate film,
Polarizing plate C: stretched cellulose acylate film/polarizing film/non-stretched cellulose triacetate film,
Polarizing plate D: stretched cellulose acylate film/polarizing film/non-stretched cellulose acylate film,
Polarizing plate E: stretched cellulose acylate film/polarizing film/stretched cellulose acylate film.
   (2) Addition of an Optically Compensating Layer (Production of an Optically Compensating Sheet)

The optically anisotropic layer is a layer for making compensation for a liquid crystal compound in a liquid crystal cell in a liquid crystal display device at the time of black display, and is added by forming an oriented film on the cellulose acylate film and further forming an optically anisotropic layer thereon.

[Oriented Film]

An oriented film may be formed on the above-mentioned surface-treated cellulose acylate film. This film has a function of deciding the orientation direction of liquid crystal molecules. However, if a liquid crystal compound is oriented and subsequently the orientation state is fixed, the oriented film is not necessarily essential as a constituent of the present invention since the oriented film has fulfilled the function thereof. In other words, only the optically anisotropic layer which is in a fixed orientation state and is formed on the oriented film is transferred onto a polarizer, whereby the polarizing plate using the cellulose acylate film of the present invention can be produced.

The orientation film can be provided by rubbing an organic compound (preferably a polymer), oblique evaporation of an inorganic compound, forming a layer having a micro group, or accumulation of an organic compound (for example, ω-tricosanoic acid, dioctadecylmethylammonium chloride or methyl stearate) by the Langmuir-Blodgett method (LB film). Furthermore, there have been known orientation films having an orienting function imparted thereto by applying an electrical field, applying a magnetic field or irradiating with light.

It is preferable to form the oriented film by subjecting a polymer to rubbing treatment. In principle, the polymer used in the oriented film has a molecular structure having a function of orienting liquid crystal molecules.

In the present invention, it is preferable to not only cause the polymer used in the oriented film to have the above-mentioned function of orienting liquid crystal molecules, but also introduce, into the main chain of the polymer, a side chain having a crosslinkable functional group (for example, a double bond), or it is preferable to introduce, into a side chain of the polymer, a crosslinkable functional group having a function of orienting liquid crystal molecules.

The polymers used in the invention may be polymers capable of cross-linking by themselves, polymers capable of undergoing cross-linking reaction in the presence of a cross-linking agent, or combinations thereof. Examples of polymers usable in the invention include styrene-series copolymers, polyolefins, polyvinyl alcohols (PVAs), modified PVAs, poly(N-methylolacrylamides), polyesters, polyimides, vinyl acetate copolymers, carboxymethyl celluloses, polycarbonates, methacrylate-series copolymers described in paragraph [0022] of the specification in JP-A-8-338913, compounds such as a silane coupling agent, and the like. Of these polymers, water-soluble polymers such as poly(N-methylolacrylamides), carboxymethyl celluloses, gelatin, PVAs or modified PVAs is preferred. Further, gelatin, PVAs or modified PVAs is more preferably, PVAs or modified PVAs is most preferably. It is particularly preferable to use of two kinds of polyvinyl alcohols or modified polyvinyl alcohols having different polymerization degrees. PVAs usable in the invention have a saponification degree in the range of, preferably 70 to 100%, more preferably 80 to 100%. The suitable polymerization degree thereof is from 100 to 5,000.

The side chain having a function of orienting liquid crystal molecules in general has a hydrophobic group as a functional group. The specific kind of the functional group is decided dependently on the kind of the liquid crystal molecules and a required orientation state.

Modifying groups of the modified polyvinyl alcohol can be introduced by copolymerization, by chain transfer and by block polymerization. Examples of the modifying group include a hydrophilic group (e.g., carboxylic group, sulfonic group, phosphonic group, amino group, ammonium group, amido group, thiol group), a hydrocarbon group having 10 to 100 carbon atoms, a fluorine-substituted hydrocarbon group, a thioether group, a polymerizable group (unsaturated polymerizable group, epoxy group, aziridinyl group), and an alkoxysilyl group (trialkoxysilyl, dialkoxysilyl, monoalkoxysilyl). The modified polyvinyl alcohols are, e.g., described in JP-A-2000-155216, paragraphs [0022] to [0145], and JP-A-2002-62426, paragraphs [0018] to [0022].

When a side chain having a crosslinkable functional group is bonded to the main chain of the oriented film polymer or a crosslinkable functional group is introduced into a side chain thereof having a function of orienting liquid crystal molecules, the oriented film polymer can be copolymerized with a polyfunctional monomer contained in the optically anisotropic layer. As a result, strong bonding based on covalent bonds is attained between the polyfunctional monomer molecules, between the oriented film polymer molecules, and between the polyfunctional monomer molecule and the oriented film polymer molecule. Consequently, the introduction of the crosslinkable functional group into the oriented film polymer makes it possible to improve the strength of the optically compensating sheet remarkably.

The crosslinkable functional group of the oriented film polymer preferably contains a polymerizable group in the same manner as the polyfunctional monomer. Specific examples thereof are described in JP-A-2000-155216, paragraphs [0080] to [0100]. The oriented film polymer can be crosslinked with a crosslinking agent, separately from the above-mentioned crosslinkable functional group.

Examples of the crosslinking agent for the polymer include aldehydes, N-methylol compounds, dioxane derivatives, compounds that works when the carboxylic group is activated, active vinyl compounds, active halogen compounds, isooxazoles and dialdehyde starch. Two or more crosslinking agents may be used in combination. Compounds described in, e.g., JP-A-2002-62426, paragraphs [0023] to [0024] can be used. Reactive aldehydes are preferred, and glutaraldehyde is particularly preferred.

The amount of the crosslinking agent is in the range of preferably 0.1 to 20 wt %, more preferably 0.5 to 15 wt % based on the amount of the polymer. The amount of non-reacted crosslinking agent remaining in the orientation layer is preferably 1.0 wt % or less, more preferably 0.5 wt % or less based on the amount of the orientation layer. The adjustment as described above makes it possible to give a sufficient endurance to the oriented film without generating any reticulation even if the oriented film is used in a liquid crystal display device for a long time or is allowed to stand still in high-temperature and high-humidity atmosphere for a long time.

The oriented film for use in the present invention can be basically formed by coating a solution containing the polymer (the oriented film forming material) and the cross-linking agent as recited above on a transparent substrate, drying by heating (to cause cross-linking reaction) and rubbing the coating surface. The cross-linking reaction, as mentioned above, may be carried out in an arbitrary stage after coating the solution on the transparent substrate. In the case of using a water-soluble polymer, such as PVA, as the oriented film forming material, a mixture of water with an organic solvent having a defoaming action, such as methanol, is preferably employed as the solvent of the coating solution. The suitable ratio of water to methanol is preferably from 0:100 to 99:1, more preferably from 0:100 to 91:9, by mass. By the use of such a mixed solvent, the generation of foams can be prevented to ensure markedly decreased defects in the oriented film, especially the surface of the optically anisotropic layer.

Examples of a coating method for the oriented film which can be adopted include a spin coating method, a dip coating method, a curtain coating method, an extrusion coating method, a rod coating method and a roll coating method. Of these methods, the rod coating method is preferred over the others. The suitable thickness of the polymer layer after drying is from 0.1 to 10 μm. The drying by heating can be performed at a temperature of 2° C. to 11° C. In order to form cross-links to a satisfactory extent, the drying temperature is preferably from 6° C. to 10° C., particularly preferably from 8° C. to 10° C. The drying time is generally from 1 minute to 36 hours, preferably from 1 to 30 minutes. Further, it is preferable to adjust the pH to an optimum value for the cross-linking agent used. In the case of using glutaraldehyde as a cross-linking agent, the suitable pH is from 4.5 to 5.5, especially 5.

The orientation layer may be provided on the transparent support or an undercoating layer. After the above-described polymer layer is crosslinked, the surface of the layer may be subjected to rubbing treatment to form the orientation layer.

For the rubbing treatment can be adopted the treatment methods widely used for orientating liquid crystals of LCD. More specifically, the method of rubbing the surface of an orientation film in a fixed direction by means of paper, gauze, felt, rubber, or nylon or polyester fiber can be employed for orientation. In general the orientation can be carried out by rubbing several times the polymer surface with cloth into which fibers having the same length and the same diameter are transplanted evenly.

When the rubbing treatment method carries out industrially, it can be achieved by contacting a rotating rubbing roll with a transported film having a polarizing layer. The circularity, cylindricality and deflection of the roll itself are preferably all 30 μm or below. The suitable wrap angle of a film with a rubbing roll is from 0.1 degree to 90 degrees. However, as disclosed in JP-A-8-160430, there is a case that the steady rubbing treatment is effected by winding a film around the roll at an angle of 360 degrees or more. It is preferable that the film is conveyed at a speed of 1 to 100 meters a minute. Further, it is appropriate to choose the rubbing angle from the range of 0 to 60 degrees. In the case of using the rubbed long film for LCD's, it is preferable to set the rubbing angle from 40 to 50 degrees. In particular, it is advantageous to adjust the rubbing angle to 45 degrees.

The film thickness of the thus-obtained oriented film is preferably from 0.1 to 10 μm.

Next, liquid crystal molecules of an optically anisotropic layer may be oriented onto the oriented film. Thereafter, the oriented film polymer may be caused to react with the polyfunctional monomer contained in the optically anisotropic layer, or a crosslinking agent may be used to crosslink the oriented film polymer, if necessary.

The liquid crystal molecules used in the optically anisotropic layer may be rod-like liquid crystal molecules or disk-like liquid crystal molecules. The rod-like liquid crystal molecule and the disk-like liquid crystal molecule may each be a high molecular weight liquid crystal or a low molecular weight liquid crystal. Furthermore, a compound about which a low molecular weight liquid crystal is crosslinked to exhibit no liquid crystallinity may be used.

[Rod-Like Liquid Crystal Molecule]

Specific examples of the rod-like liquid crystal compounds include azomethines, azoxy compounds, cyanobiphenyls, cyanophenylesters, benzoic acid esters, cyclohexane carboxylic acid phenylesters, cyanophenylcyclohexane compounds, cyano-substituted phenylpyrimidines, alkoxy-substituted phenylpyrimidines, phenyldioxanes, tolan compounds, alkenylcyclohexylbenzonitrils, and the like.

The rod-like liquid crystal molecule may include a metal complex. A liquid crystal polymer containing, as recurring units thereof, rod-like liquid crystal molecules can also be used as the rod-like liquid crystal molecule. In other words, the rod-like liquid crystal molecule may be bonded to a (liquid crystal) polymer.

Rod-like liquid crystal molecules are described in Quarterly Chemical Review, Vol. 22, “Chemistry of Liquid Crystal” edited by the Chemical Society of Japan (1994), Chapters 4, 7, and 11, and “Liquid Crystal Device Handbook” edited by Japan Society for the Promotion of Science, 142nd Committee, chapter 3.

The birefringence of the rod-like liquid crystal molecules is preferably from 0.001 to 0.7.

The rod-like liquid crystal molecule preferably has a polymerizable group in order to fix the orientation state thereof. The polymerizable group is preferably a radical polymerizable unsaturated group or a cation polymerizable group. Specific examples thereof include polymerizable groups and polymerizable liquid crystal compounds described in JP-A-2002-62427, paragraphs [0064] to [0086].

[Disk-Like Liquid Crystal Molecule]

Illustrative of the disk-like (discotic) liquid crystal molecule can include benzene derivatives disclosed in a study report of C. Destrade et al., Mol. Cryst., vol. 71, page 111 (1981); truxene derivatives disclosed in a study report of C. Destrade et al., Mol. Cryst., vol. 122, page 141 (1985), and Phyics. Lett., A, vol. 78, page 82 (1990); cyclohexane derivatives disclosed in a study report of B. Kohne et al., Angew. Chem. Soc., vol. 96, page 70 (1984); macrocycles of azacrown series and phenylacetylene series disclosed in a study report of J. M. Lehn et al., J. Chem. Commun. page 1794 (1985), a study report of and J. Zhang et al., and J. Am. Chem. Soc. vol. 116, page 2655 (1994).

The above disk-like liquid crystal molecule may include compounds, which shows liquid crystallization, having a structure in which straight chain groups such as alkyl, alkoxy, and/or substituted benzoyloxy are radially substituted as side chains of a parent core locating at the center of the molecule. The molecule or a cluster of the molecules is preferably the compound which has rotational symmetry and can give a given orientation. About the optically anisotropic layer made from the disk-like liquid crystal molecules, it is unnecessary that the compound which is finally contained in the optically anisotropic layer is made of a disk-like liquid crystal molecule. A low molecular weight disk-like liquid crystal molecule having a thermo- or photo-reactive group is polymerized or crosslinked by heat or light to form a polymer that does not behave as liquid crystal. Such polymer can be also used in the invention. Preferred examples of the disk-like liquid crystal molecule are described in JP-A-8-50206. JP-A-8-27284 discloses polymerization of a disk-like liquid crystal molecule.

In order to fix the disk-like liquid crystal molecule by polymerization, it is necessary to bond a polymerizable group as a substituent to the disk-like core of the disk-like liquid crystal molecule. A compound wherein the disk-like core and the polymerizable group are bonded through a linking group is preferred. By this structure, the orientation state of the compound can be kept in the polymerization reaction. Examples of the compound include compounds described in JP-A-2000-155216, paragraphs [0151] to [0168].

In hybride orientation, an angle between major axis (disc plane) of disk-like liquid crystal molecule and plane of light polarizing film increases or decreases with increase of distance from plane of light polarizing film and in the direction of depth from the bottom of the optically anisotropic layer. The angle preferably decreases with increase of the distance. Further, examples of variation of the angle include continuous increase, continuous decrease, intermittent increase, intermittent decrease, variation containing continuous increase and decrease, and intermittent variation containing increase or decrease. The intermittent variation contains an area where the inclined angle does not vary in the course of the thickness direction of the layer. The angle preferably totally increases or decreases in the layer, even if it does not vary in the course. The angle more preferably increases totally, and it is particularly preferred to increase continuously.

Average direction of major axis of disk-like liquid crystal molecule on the light polarizing film side can be generally controlled by selecting the disk-like liquid crystal molecule or materials of the orientation layer, or by selecting methods for the rubbing treatment. The direction of major axis (disc plane) of disk-like liquid crystal molecule on the surface side (air side) can be generally controlled by selecting the disk-like liquid crystal molecule or other compounds used together with the disk-like liquid crystal molecule. Examples of the other compound include plasticizer, surface active agent, polymerizable monomer and polymer, and the like. Further, the extent of variation of the inclined angle can be also controlled by the above selection.

[Other Components of the Optically Anisotropic Layer]

The use of a plasticizer, a surfactant, a polymerizable monomer and others together with the liquid crystal molecules makes it possible to improve the uniformity of the coating film to be obtained, the strength of the film, the orientation of the liquid crystal molecules, and others. It is preferable that these components are compatible with the liquid crystal molecules and can change the tilt angle of the liquid crystal molecules or do not hinder the orientation.

The polymerizable monomer may be a radical polymerizable compound or a cation polymerizable compound, and is preferably a polyfunctional radical polymerizable monomer. Preferably, the polymerizable monomer is a monomer copolymerizable with the above-mentioned liquid crystal compound having the polymerizable group. Examples thereof include monomers described in JP-A-2002-296423, paragraphs [0018] to [0020]. The added amount of the compound is preferably from 1 to 50%, more preferably from 5 to 30 wt % of the disk-like liquid crystal molecules.

The surfactant may be a conventional compound. A fluorine-containing compound is particularly preferable. Specific examples thereof include compounds described in JP-A-2001-330725, paragraphs [0028] to [0056].

It is preferable that the polymer used together with the disk-like liquid crystal molecules can change the tilt angle of the disk-like liquid crystal molecules.

The polymer may be a cellulose ester. Preferable examples of the cellulose ester are described in JP-A-2000-155216, paragraph [0178]. In order not to hinder the orientation of the liquid crystal molecules, the added amount of the polymer is preferably from 0.1 to 10 wt %, more preferably from 0.1 to 8 wt % of the liquid crystal molecules.

The transition temperature from discotic-nematic liquid-crystal phase to solid phase is preferably in the range of 70 to 30° C., especially 70 to 17° C.

[Formation of Optically Anisotropic Layer]

The optically anisotropic layer can be formed by applying a coating solution, which contains the liquid crystal molecule together with the following polymerization initiator and other additives, onto the orientation film.

As the solvent to be used in preparing the coating solution, it is preferable to use an organic solvent. Examples of the organic solvent include amides (for example, N,N-dimethylformamide), sulfoxides (for example, dimethyl sulfoxide), heterocyclic compounds (for example, pyridine), hydrocarbons (for example, benzene and hexane), alkyl halides (for example, chloroform, dichloromethane and tetrachloroethane), esters (for example, methyl acetate and butyl acetate), ketones (for example, acetone and methyl ethyl ketone) and ethers (for example, tetrahydrofuran and 1,2-dimethoxyethane). Alkyl halides and ketones are preferred. It is also possible to use two or more organic solvents together.

The coating solution can be applied by a publicly known method (for example, the wire bar coating method, the extrusion coating method, the direct gravure coating method, the reverse gravure coating method or the die coating method).

The film thickness of the optically anisotropic layer is preferably from 0.1 to 20 μm, more preferably from 0.5 to 15 μm, and most preferably from 1 to 10 μm.

[Holding the Oriented State of a Liquid Crystal Molecule]

The liquid crystal molecule thus oriented can be fixed while holding the oriented state. The fixation is preferably carried out by the polymerization reaction. The polymerization reaction includes a heat polymerization reaction with the use of a heat polymerization initiator and a photopolymerization reaction with the use of a photopolymerization initiator. The photopolymerization reaction is preferred.

Examples of the photopolymerization initiator include α-carbonyl compounds (described in U.S. Pat. Nos. 2,367,661 and 2,367,670), acyloin ether (described in U.S. Pat. No. 2,448,828), α-hydrocarbon-substituted acyloin compounds (described in U.S. Pat. No. 2,722,512), polynuclear quinone compounds (described in U.S. Pat. Nos. 3,046,127 and 2,951,758), combinations of a triarylimidazole dimer with p-aminophenyl ketone (described in U.S. Pat. No. 3,549,367), acridine and phenazine compounds (described in JP-A-60-105667 and U.S. Patent No. 4,239,850) and oxadiazol compounds (described in U.S. Pat. No. 4,212,970).

It is preferable to use the photopolymerization initiator in an amount of from 0.01 to 20 wt %, more preferably from 0.5 to 5 wt %, based on the solid matters in the coating solution.

In the photoirradiation for polymerizing the liquid crystal molecule, it is preferable to use UV light.

The irradiation energy preferably ranges from 20 mJ/cm² to 50 J/cm², more preferably from 20 to 5,000 mJ/cm², further preferably from 100 to 800 mJ/cm². To accelerate the photopolymerization reaction, the photoirradiation may be carried out under heating.

A protective layer may be formed on the optically anisotropic layer.

It is also preferable to combine this optically compensating film with a light-polarizing layer. Specifically, a coating solution for forming optically anisotropic layers, as described above, is applied onto the surface of a light-polarizing film, thereby forming an optically anisotropic layer. As a result, produced is a thin polarizing plate giving only a small stress (strain×sectional area×elastic modulus) with a change in the size of the light-polarizing film without using any polymer film between the light-polarizing film and the optically anisotropic layer. By fitting a polarizing plate according to the present invention into a large-sized liquid crystal display device, images having a high display quality can be displayed without causing problems, such as light leakage.

The tilt angle between the light-polarizing layer and the optically compensating layer is preferably adjusted by drawing the layers in such a manner that the angle is matched with the angle between the transmission axis of two polarizing plates adhered onto both surfaces of a liquid crystal cell which constitutes a LCD and the lengthwise or lateral direction of the liquid crystal cell. Such an angle is generally 45 degrees, but it is not always 45 degrees in some of the latest transmission, reflection or semi-transmission type LCD modes. Therefore, it is preferable that the drawing direction be adjustable in order to conform to the design of LCD.

[Liquid Crystal Display Device]

Each of liquid crystal modes wherein such an optically compensating film is used is described hereinafter.

(TN Mode Liquid Crystal Display Device)

The liquid crystal cell of TN mode is widely used in color TFT liquid crystal displays, and hence is described in many publications. In a liquid crystal cell in the TN mode, the orientation state of the liquid crystal therein at the time of black display is the state that rod-like liquid crystal molecules in the central portion of the cell stand up and the molecules lie down in portions near substrates of the cells.

(OCB Mode Liquid Crystal Display Device)

The liquid crystal cell of OCB mode is a liquid crystal cell of bend orientation mode in which rod-like liquid crystal molecules in upper part-and ones in lower part are essentially reversely (symmetrically) oriented. A liquid crystal display device having the liquid crystal cell of bend orientation mode is disclosed in U.S. Pat. Nos. 4,583,825 and 5,410,422. Since rod-like liquid crystal molecules in upper part and ones in lower part are symmetrically oriented, the liquid crystal cell of bend orientaion mode has self-optical compensatory function. Therefore, this mode is referred to as OCB (optically compensatory bend) mode.

In the same manner as in the TN mode, in a liquid crystal cell in the OCB mode, the orientation state of the liquid crystal in the cell at the time of black display is the state that rod-like liquid crystal molecules in the central portion of the cell stand up and the molecules lie down in portions near substrates of the cells.

(VA Mode Liquid Crystal Display Device)

The VA mode Liquid crystal display device is characterized by aligning rod-like liquid crystal molecules in essentially vertically direction. The liquid crystal cell of VA mode include some types:
(i) a liquid crystal cell of VA mode in a narrow sense (described in JP-A-2-176625), in which rod-like liquid crystal molecules are essentially vertically aligned while voltage is not applied, and the molecules are essentially horizontally aligned while voltage is applied;
(ii) a liquid crystal cell of MVA mode (described in SID97, Digest of tech. Papers, 28(1997), 845), in which the VA mode is modified to be multi-domain type so as to enlarge the viewing angle;
(iii) a liquid crystal cell of n-ASM mode (described in Nippon Ekisho Toronkai [Liquid crystal forum of Japan], Digest of tech. Papers (1998), 58-59), in which rod-like liquid crystal molecules are essentially vertically aligned while voltage is not applied, and the molecules are essentially oriented in twisted multi-domain alignment while voltage is applied; and
(iv) a liquid crystal cell of SURVIVAL mode (published in LCD international 98).
   (IPS Mode Liquid Crystal Display Device)

When an electric voltage is not applied, in general, rod like liquid crystal molecules are oriented substantially parallel. The orientation of liquid crystal changes with an electric voltage application, thereby allowing switching of modes. Specific devices described in JP-A-2004-365941, JP-A-2004-12731, JP-A-2004-215620, JP-A-2002-221726, JP-A-2002-55341, JP-A-2003-195333 may be used.

(Other Liquid Crystal Display Devices)

For liquid crystal display devices in ECB and STN modes, optical compensation can be attained on the basis of the same approach as described above.

(3) Addition of an Antireflection Layer (Antireflection Film)

An antireflection film is generally formed by laying a low refractive index layer, which functions as an antifouling property layer also, and at least one layer having a higher refractive index than the low refractive index layer, i.e., a high refractive index layer and/or a middle refractive index layer, on a transparent substrate.

Examples of the method for forming a multilayered film wherein transparent thin films made of inorganic compounds (such as metal oxides) having different refractive indexes are laminated include a chemical vapor deposition (CVD) method; a physical vapor deposition (PVD) method; and a method of forming a metal compound such as metal alkoxide into a film made of colloidal metal oxide particles by a sol-gel method, and subjecting the film to post-treatment (such as ultraviolet radiation described in JP-A-9-157855, or plasma treatment described in JP-A-2002-327310).

As antireflection films having a high productivity, suggested are various antireflection films obtained by laminating thin films, each of which is made of inorganic particles dispersed in a matrix, by coating.

The antireflection film used in the present invention may be an antireflection film produced by making fine irregularities in the topmost surface of the antireflection film formed by coating as described above to give anti-glare property to the surface.

Any one of the above-mentioned manners can be applied to the cellulose acylate film of the present invention. The coating manner (coating type) is preferable.

[Layer Structure of the Coating Type Antireflection Film]

An antireflection film at least having a layer structure obtained by forming, on a substrate, a middle refractive index layer, a high refractive index layer, and a low refractive index layer (the outermost layer) in this order, is preferably designed to have refractive indexes satisfying the following relationship. (The refractive index of the high refractive index layer)>(the refractive index of the middle refractive index layer)>(the refractive index of the transparent substrate)>(the refractive index of the low refractive index layer)

A hard coat layer may be formed between the transparent substrate and the middle refractive index layer. The antireflection film may be composed of a middle refractive index hard coat layer, a high refractive index layer, and a low refractive index layer. Examples thereof are described in JP-A-8-122504, JP-A-8-110401, JP-A-10-300902, JP-A-2002-243906, and JP-A-2000-111706.

A different function may be given to each of the layers. Examples thereof include a low refractive index layer having antifouling property, and a high refractive index layer having antistatic property (described in JP-A-10-206603, JP-A-2002-243906, and the like).

The haze of the antireflection film is preferably 5% or less, more preferably 3% or less. The mechanical strength of the film is preferably H or harder, further preferably 2H or harder, and most preferably 3H or harder, in terms of the pensile hardness test, according to JIS K5400.

[High-Refractive-Index Layer and Middle-Refractive-Index Layer]

The high refractive index layer of the antireflection film is a curable film containing at least inorganic compound superfine particles having a high refractive index and an average particle size of 100 nm or less, and matrix binder.

The high refractive index, inorganic compound superfine particles may be made of an inorganic compound having a refractive index of 1.65 or more, preferably a refractive index of 19 or more. Examples of the inorganic compound to be preferably used, include oxides of Ti, Zn, Sb, Sn, Zr, Ce, Ta, La, In, and the like; and composite oxides containing two or more out of these metal atoms.

Examples of the embodiment of such superfine particles to be used, include the particles whose surface is treated with a surface-treating agent (such as a silane coupling agent, as described in JP-A-11-295503, JP-A-11-153703, and JP-A-2000-9908, or an anionic compound or an organometallic coupling agent, as described in JP-A-2001-310432, and the like), the particles in which a core-shell structure is formed to have high refractive index particles be a core (as described in JP-A-2001-166104 and the like), and the particles to be used in combination with a specific dispersing agent (as described in JP-A-11-153703, JP-A-2002-2776069, U.S. Pat. No. 6,210,858B1, and the like).

The material which forms the matrix may be any of thermoplastic resins and thermosetting resins.

The material is preferably at least one composition selected from a composition comprising a polyfunctional compound containing at least two radical polymerizable groups and/or cation polymerizable groups, a composition comprising an organometallic compound containing a hydrolyzable group, and a composition comprising a partial condensate thereof. Examples of the material to be used include compounds described in JP-A-2000-47004, JP-A-2001-315242, JP-A-2001-31871, and JP-A-2001-296401

Alternately, a curable film obtained from a metal alkoxide composition and a metal alkoxide compound formed from a hydrolysis condensate of a metal alkoxide is preferably used. For example, examples are described in JP-A-2001-293818 and the like.

The refractive index of the high-refractive-index layer is preferably in the range of 1.70 to 2.20. The thickness of the high-refractive-index layer is preferably from 5 nm to 10 μm, more preferably from 10 nm to 1 μm.

The refractive index of the middle-refractive-index layer is adjusted so as to become a value (magnitude) between the refractive index of the low-refractive-index layer and the refractive index of the high-refractive-index layer. The refractive index of the middle-refractive-index layer is preferably in the range of more than 1.55 and less than 1.70.

[Low-Refractive-Index Layer]

The low-refractive-index layer is laminated on the high refractive index layer. The low-refractive-index layer has a refractive index preferably in the range of 1.20 to 1.55, more preferably in the range of 1.30 to 1.50.

This layer is preferably formed as an outermost layer having scratch resistance and antifouling property. In order to improve the scratch resistance largely, it is effective to give lubricity to the surface. For this, it is possible to use the method of the thin film layer by the introduction of a conventionally-known silicone, or the introduction of fluorine.

The refractive index of the fluorine-containing compound for use in the overcoat layer is preferably 1.35 to 1.50, more preferably 1.36 to 1.47. The fluorine-containing compound used in the over coat layer preferably contains 35 to 80 wt % of fluorine atoms.

As the fluorine-containing compound, for example, the following compounds can be preferably used: compounds described in JP-A-9-222503, paragraphs [0018] to [0026]; JP-A-11-38202, paragraphs [0019] to [0030]; JP-A-2001-40284, paragraphs [0027] to [0028]; JP-A-2000-284102; JP-A-2003-26732, paragraphs [0012] to [0077]; JP-A-2004-45462, paragraphs [0030] to [0047], and the like.

The silicone-containing compound is preferably a compound which has a polysiloxane structure; and more preferably a compound which contains, in the polymer chain thereof, a curable functional group or polymerizable functional group so as to have a crosslinked structure in the film to be formed. Examples thereof include reactive silicones (such as “Silaplane” (trade name), manufactured by Chisso Corporation), and polysiloxane containing at both ends thereof silanol groups (described in JP-A-11-258403), and the like.

It is preferable to conduct the crosslinking or polymerizing reaction of the fluorine-containing polymer and/or the siloxane polymer having a crosslinkable or polymerizable group, by radiation of light or heating at the same time of or after applying a coating solution for forming an outermost layer containing a polymerization initiator, a sensitizer, and others.

Preferable is also a sol-gel cured film obtained by curing an organometallic compound, such as a silane coupling agent, and a silane coupling agent which contains a specific fluorine-containing hydrocarbon group, in the presence of a catalyst, by condensation reaction.

Examples thereof include silane compounds which contain a polyfluoroalkyl group, or partially-hydrolyzed condensates (such as those described in JP-A-58-142958, JP-A-58-147483, JP-A-58-147484, JP-A-9-157582 and JP-A-11-106704), and silyl compounds which contains a poly(perfluoroalkyl ether) group, which is a long chain group containing fluorine (such as compounds described in JP-A-2000-117902, JP-A-2001-48590, and JP-A-2002-53804).

It is also preferable that the low refractive index layer is made to contain, as an additive other than the above, a filler {such as silicon dioxide (silica); low refractive index inorganic compound particles having a primary average particle size of 1 to 150 nm made, for example, of fluorine-containing particles (e.g. magnesium fluoride, calcium fluoride, barium fluoride); organic fine particles, as described in JP-A-11-3820, paragraphs [0020] to [0038]}, a silane coupling agent, a lubricant, a surfactant; and the like.

In the case that the low refractive index layer is positioned beneath the outermost layer, the low refractive index layer may be formed by a gas phase method (such as a vacuum vapor deposition, a sputtering method, an ion plating method, or a plasma CVD method). The low refractive index layer is preferably formed by a coating method, since the layer can be formed at low costs.

The thickness of the low-refractive-index layer is preferably from 30 to 200 nm, more preferably from 50 to 150 nm, and most preferably from 60 to 120 nm.

[Hardcoat Layer]

The polarizing plate of the present invention is preferably combined with a functional optical film provided with a hardcoat layer on the surface of a transparent support, to provide a sufficient mechanical strength for such as scratching resistance. When the hardcoat layer is used by applying it to the aforementioned antireflection film, in particular, the hardcoat layer is preferably disposed between the transparent support and the high-refractive index layer.

The hard coat layer is preferably formed by crosslinking reaction or polymerizing reaction of a curable compound through light and/or heat.

The curable functional group thereof is preferably a photopolymerizable functional group. An organometallic compound which contains a hydrolyzable functional group is preferably an organic alkoxysilyl compound.

Specific examples of these compounds are the same as exemplified as the high refractive index layer.

Specific examples of the composition which constitutes the hard coat layer to be preferably used, include compositions described in JP-A-2002-144913, JP-A-2000-9908, and WO 02/46617.

The high refractive index layer can function as a hard coat layer also. In this case, it is preferable to use the manner described about on the high refractive index layer, to disperse particles finely to be incorporated into the hard coat layer to be formed.

The hard coat layer may contain particles having an average particle size of 0.2 to 10 μm, so as to be caused to function as an anti-glare layer also. The anti-glare layer has an anti-glare function (which will be detailed in the below).

The film thickness of the hard coat layer, which may be appropriately set according to the application thereof, is preferably from 0.2 to 10 μm, more preferably from 0.5 to 7 μm.

The mechanical strength of the hard coat layer is preferably H or harder, further preferably 2H or harder, and most preferably 3H or harder, in terms of the pensile hardness, according to JIS K5400 test. The hard coat layer is preferably one which is less in an abraded amount in a taber test according to JIS K5400, which means a test piece made of said hardcoat layer is less in the abraded amount after the test.

[Forward Scattering Layer]

In the case that the cellulose acylate film of the present invention is applied to a liquid crystal display device, a forward scattering layer may be fitted to the film in order to improve the field angle of the display device when the angle of visibility is inclined up and down or right and left. The hard coat layer can have both of a hard coat function and a forward scattering function by dispersing fine particles having different refractive indexes in the hard coat layer.

For example, any of the following structures may be used, which are described in JP-A-11-38208 in which the forward scattering coefficient is specified, in JP-A-2000-199809 in which the relative refractive indexes of a transparent resin and fine-particles are made to fall in the specific ranges, respectively, and in JP-A-2002-107512 in which the haze value is made to be 40% or more.

[Other Layers]

The antireflection film may be further provided with a primer layer, an anti-static layer, an undercoating layer and a protective layer.

[Coating Methods]

The respective layers of the antireflection film can be formed by application, according to any one of dip coat, air knife coat, curtain coat, roller coat, wire bar coat, gravure coat, micro gravure coat, and extrusion coat (described in U.S. Pat. No. 2,681,294) methods.

[Antiglare Function]

The anti-reflection film may have an antiglare function for scattering light from the outside. The antiglare function can be obtained by making unevenness in a surface of the anti-reflection film. In the case that the anti-reflection film has the antiglare function, the haze of the anti-reflection film is preferably 3 to 30%, more preferably 5 to 20%, and most preferably 7 to 20%.

In order to form irregularities in the surface of the antireflection film, any method capable of forming the irregularities and keeping the resultant surface form sufficiently can be used. Examples of the method include a method of using fine particles in the low refractive index layer to form irregularities in the surface of the film (see, for example, JP-A-2000-271878); a method of adding a small amount (0.1 to 50 wt %) of relatively large particles (particle size: 0.05 to 2 μm) to the layer (high refractive index layer, middle refractive index layer or hard coat layer) to be formed beneath the low refractive index layer so as to form a surface uneven film, and then forming the low refractive index layer thereon while keeping this surface uneven form (see, for example, JP-A-2000-281410, JP-A-2000-95893, JP-A-2001-100004, and JP-A-2001-281407); and methods of transferring uneven forms physically onto the surface of a formed topmost layer (antifouling layer) by coating (see, for example, JP-A-63-278839, JP-A-11-183710 and JP-A-2000-275401 as embossing methods).

According to the method of preparation of the present invention, a cellulose, containing very little amount of minute contaminants, suitable for a material of an optical film can be prepared in a short reaction time. Further, the cellulose acylate film of the present invention, which is made by applying a solution-casting film formation method or a melt-casting film formation method from the cellulose acylate, can realize a high-quality liquid crystal display device.

Moreover, the cellulose acylate film of the present invention shows remarkable improvement of peelability in film formation. Further, the cellulose acylate film of the present invention contains substantially no minute polarizing contaminants, and has sufficient Re and Rth. Still further, the polarizing plate using the cellulose acylate film of the present invention, in use of a liquid crystal display device, can prevent light leakage from a picture element (pixel) which is necessarily to be black. Further, a liquid crystal display device fabricating the cellulose acylate film of the present invention can prevent a breakdown in display occurring at displaying a black screen. Furthermore, the cellulose acylate film of the present invention can be particularly effectively used in a vertical alignment (VA) type liquid crystal display device.

The present invention will be described in more detail based on examples given below, but the invention is not meant to be limited by these.

### EXAMPLES

### Example 1-1

(Cellulose Acetate Propionate P-110)

10 g of cellulose (broad leaf wood pulp), 2.2 g of water and 11 g of acetic acid were put into a 500 ml separable flask equipped with a reflux apparatus, agitated vigorously while heating on an oil bath adjusted at 80° C. and then were added 16 g of acetic acid anhydride and agitated for two hours. Cellulose thus pretreated was swollen and grinded and was made to be fluff. The reactor was put on an iced water bath maintained at 5° C. for one hour to cool cellulose sufficiently. Apart from them, a mixture of 2 g of acetic acid anhydride, 62 g of propionic acid anhydride and 1.2 g of sulfuric acid was prepared and cooled to −20° C. and then added all at once into the cellulose pretreated. After a lapse of 30 minutes, the temperature of the outside of the reactor was raised to 20° C. and reaction was continued for five hours. The reactor was cooled on an iced water bath maintained at 5° C. and added 120 g of acetic acid containing 25% of water over a period of 30 minutes. The temperature of the inside of the reactor was raised to 30° C. and agitation was performed for tow hours. 5 g of 50% aqueous solution of magnesium acetate tetra-anhydride were added into the reactor and agitated for 30 minutes. 75 g of acetic acid containing 25% of water, and 250 g of water were added gradually into the reactor to precipitate cellulose acetate propionate. Cellulose acetate propionate thus obtained was washed by hot water of 70° C. until cleaning fluid being pH 6-7, and agitated in 0.005% aqueous solution of calcium hydroxide of 20° C. for 30 minutes and then washed by water until cleaning fluid being pH 7. Cellulose acetate propionate thus obtained was dried at 70° C. According to ¹H-NMR and GPC (gel permeation chromatography) measurements, the cellulose acetate propionate thus obtained had the acetylation degree of 1.45, propionylation degree of 1.47, and polymerization degree of 301.

### Example 1-2

(Cellulose Acetate Propionate P-104)

10 g of cellulose (broad leaf wood pulp) and 5 g of acetic acid were put into a 500 ml separable flask equipped with a reflux apparatus and allowed to stand for six hours while heating on an oil bath adjusted at 60° C., and thereafter agitated vigorously for one hour on an oil bath adjusted at 60° C. Cellulose thus pretreated was swollen and grinded and was made to be fluff. The reactor was put on an iced water bath maintained at 5° C. for one hour to cool cellulose sufficiently. Apart from them, a mixture of 103 g of propionic acid anhydride and 1.0 g of sulfuric acid was prepared and cooled to −20° C. and then added all at once into the cellulose pretreated. After a lapse of 30 minutes, the temperature of the outside of the reactor was raised to 20° C. and reaction was continued for three hours. The reactor was cooled on an iced water bath maintained at 5° C. and added 120 g of acetic acid containing 25% of water over a period of 30 minutes. The temperature of the inside of the reactor was raised to 30° C. and agitation was performed for tow hours. 10 g of 50% aqueous solution of magnesium acetate tetra-anhydride were added into the reactor and agitated for 30 minutes. 75 g of acetic acid containing 25% of water, and 250 g of water were added gradually into the reactor to precipitate cellulose acetate propionate. Cellulose acetate propionate thus obtained was washed by hot water of 70° C. until cleaning fluid being pH 6-7, and agitated in 0.005% aqueous solution of calcium hydroxide of 20° C. for 30 minutes and then washed by water until cleaning fluid being pH 7. Cellulose acetate propionate thus obtained was dried at 70° C. According to ¹H-NMR and GPC measurements, the cellulose acetate propionate thus obtained had the acetylation degree of 0.16, propionylation degree of 2.80, and polymerization degree of 287.

### Example 1-3

(Cellulose Acetate Butyrate B-105)

10 g of cellulose (broad leaf wood pulp) and 13.5 g of acetic acid were put into a 500 ml separable flask equipped with a reflux apparatus and allowed to stand for six hours while heating on an oil bath adjusted at 80° C., and thereafter agitated vigorously for one hour on an oil bath adjusted at 60° C. Cellulose thus pretreated was swollen and grinded and was made to be fluff. The reactor was put on an iced water bath maintained at 5° C. for one hour to cool cellulose sufficiently. Apart from them, a mixture of 108 g of butyric acid anhydride and 1.0 g of sulfuric acid was prepared and cooled to −20° C. and then added all at once into the cellulose pretreated. After a lapse of 30 minutes, the temperature of the outside of the reactor was raised to 20° C. and reaction was continued for five hours. The reactor was cooled on an iced water bath maintained at 5° C. and added 120 g of acetic acid containing 25% of water over a period of 30 minutes. The temperature of the inside of the reactor was raised to 30° C. and agitation was performed for 1.5 hours. 10 g of 50% aqueous solution of magnesium acetate tetra-anhydride were added into the reactor and agitated for 30 minutes. 75 g of acetic acid containing 25% of water, and 250 g of water were added gradually into the reactor to precipitate cellulose acetate butyrate. Cellulose acetate butyrate thus obtained was washed by hot water of 70° C. until cleaning fluid being pH 6-7, and agitated in 0.005% aqueous solution of calcium hydroxide of 20° C. for 30 minutes and then washed by water until cleaning fluid being pH 7. Cellulose acetate butyrate thus obtained was dried at 70° C. According to ¹H-NMR and GPC measurements, the cellulose acetate butyrate thus obtained had the acetylation degree of 0.84, butyration degree of 2.14, and polymerization degree of 270.

### Example 1-4

(Cellulose Acetate Propionate P-101)

150 g of cellulose (broad leaf wood pulp) and 75 g of acetic acid were put into a 500 ml separable flask equipped with a reflux apparatus, agitated vigorously while heating on an oil bath adjusted at 60° C. Cellulose thus pretreated was swollen and grinded and was made to be fluff. The reactor was cooled by allowing to stand on an iced water bath maintained at 2° C. for 30 minutes. Apart from them, a mixture of 1545 g of propionic acid anhydride and 10.5 g of sulfuric acid was prepared and cooled to −30° C. and then added all at once into the above-described pretreated cellulose. After a lapse of 30 minutes, the temperature of the outside of the reactor was raised gradually and adjusted so that the temperature of the inside of the reactor became 25° C. after a lapse of two hours from addition of acylating agent. The reactor was cooled on an iced water bath maintained at 5° C. and adjusted so that the temperature of the inside of the reactor became 10° C. after a lapse of 3.5 hours from addition of acylating agent. 120 g of acetic acid containing 25% of water cooled to 5° C. were added into the reactor over a period of one hour. The temperature of the inside of the reactor was raised to 40° C. and agitation was carried out for 1.5 hours. A solution prepared by dissolving two times mol of magnesium acetate tetra-anhydride to the mol of sulfuric acid into acetic acid containing 25% of water and agitated for 30 minutes. 1 L of acetic acid containing 25% of water, 500 ml of acetic acid containing 33% of water, 1 L of acetic acid containing 50% of water and IL of water were added into the reactor, in that order to precipitate cellulose acetate propionate. Cellulose acetate propionate thus obtained was washed by hot water of 70° C. until cleaning fluid being pH 6-7, and agitated in 0.005% aqueous solution of calcium hydroxide of 20° C. for 30 minutes and then washed by water. Cellulose acetate propionate thus obtained was dried at 70° C. According to ¹H-NMR and GPC measurements, the cellulose acetate propionate thus obtained had the acetylation degree of 0.30, propionylation degree of 2.65, and polymerization degree of 326.

### Comparative Example 1

(Cellulose Acylate C-101, C-102, C-103)

10 g of cellulose (broad leaf wood pulp) was swollen by 11 g of acetic acid and allowed to stand at 20° C. for six hours, and then agitated vigorously at a room temperature for one hour. Cellulose thus pretreated was a mixture of fluff-like cellulose and sheet-shaped cellulose insufficiently swollen. The reactor was put on an iced water bath maintained at 5° C. for one hour to cool cellulose sufficiently. Apart from them, a mixture of 18 g of acetic acid anhydride, 62 g of propionic acid anhydride and 0.5 g of sulfuric acid was prepared and cooled to −20° C. and then added all at once into the above-described pretreated cellulose. After a lapse of 30 minutes, the temperature of the outside of the reactor was raised to 30° C. and reaction was started. 12 hours were required until completion of reaction. The reactor was cooled on an iced water bath maintained at 5° C. and added 120 g of acetic acid containing 25% of water over a period of 30 minutes. The temperature of the inside of the reactor was raised to 30° C. and agitation was carried out for 2 hours. 5 g of 50% aqueous solution of magnesium acetate tetra-anhydride were added into the reactor and agitated for 30 minutes. 75 g of acetic acid containing 25% of water and 250 g of water were added gradually in to the reactor to precipitate cellulose acetate propionate. Cellulose acetate propionate thus obtained was washed by hot water of 70° C. until cleaning fluid being pH 6-7 and allowed to stand in saturated aqueous solution of calcium hydroxide of 20° C. for 12 hours and then washed by water until cleaning fluid being pH 7. Cellulose acetate propionate thus obtained was dried at 70° C. According to ¹H-NMR and GPC measurements, the cellulose acetate propionate thus obtained had acetylation degree of 1.42, propionylation degree of 1.43, and polymerization degree of 224.

According to the same acylation methods as those of Examples 1-2 and 1-3 except that cellulose pretreated at low temperatures in such a manner as described in Comparative Example 1 was used, compound C-102 and compound C-103 for comparison were prepared. Time required for acylation was seven hours for C-102 and nine hours for C-103, respectively.

It was found that pretreatment in the method of preparation of the present invention contributes to the reduction of the reaction time and cellulose acylate having high degree polymerization can effectively be obtained.

With respect to cellulose acylates (P-102, 103, 105 to 109, 111 to 114, B-101 to 104, 106, and 107) described in Table-1, “pretreatment temperature”, the amount of “acetic acid” used for pretreatment, and the amounts of “acetic acid anhydride” “propionic acid anhydride” and “butyric acid anhydride” used for acylation, and “reaction time for acylation” which are shown in Table-1 were adopted as conditions, and another conditions were the same as those adopted in Example 1-2. In the present invention, “DSAc” stands for substitution degree of acetyl group, “ DSPr” stands for substitution degree of propionyl group, and “DSBu” stands for substitution degree of butyryl group.

TABLE 1

| | Pre- | | | | | | | | | | | | |
|---|---|---|---|---|---|---|---|---|---|---|---|---|---|
| | treat- | | | | | | | | | | Total | Polym- | |
| | ment | | | Acetic | Propionic | Butyric | Reaction | | | | substi- | eriza- | |
| Cellulose | temper- | Wa- | Acetic | acid | acid | acid | time for | | | | tution | tion | |
| acylate | ature | ter | acid | anhydride | anhydride | anhydride | acylation | DSAc | DSPr | DSBu | degree | degree | Remarks |
| C-101 | 20° C. | | 11 g | 18 g | 62 g | | 12 Hr | 1.42 | 1.43 | | 2.85 | 224 | Comparative |
| | | | | | | | | | | | | | example |
| C-102 | 20° C. | | 5 g | | 103 g | | 7 Hr | 0.19 | 2.74 | | 2.93 | 208 | Comparative |
| | | | | | | | | | | | | | example |
| C-103 | 20° C. | | 13.5 g | | | 108 g | 9 Hr | 1.28 | | 1.65 | 2.93 | 205 | Comparative |
| | | | | | | | | | | | | | example |
| P-101 | 60° C. | | 75 g | | 1545 g | | 3 Hr | 0.3 | 2.65 | | 2.95 | 326 | This invention |
| P-102 | 50° C. | | 5 g | | 103 g | | 4 Hr | 0.25 | 2.55 | | 2.8 | 295 | This invention |
| P-103 | 50° C. | | 11 g | 18 g | 62 g | | 3 Hr | 1.4 | 1.35 | | 2.75 | 284 | This invention |
| B-101 | 50° C. | | 13.5 g | | | 108 g | 3 Hr | 1.27 | | 1.63 | 2.9 | 302 | This invention |
| P-104 | 60° C. | | 3 g | | 126 g | | 4 Hr | 0.16 | 2.8 | | 2.96 | 287 | This invention |
| P-105 | 60° C. | | 5 g | | 103 g | | 3 Hr | 0.25 | 2.46 | | 2.71 | 296 | This invention |
| P-106 | 60° C. | | 5 g | 7 g | 116 g | | 3 Hr | 0.59 | 2.1 | | 2.69 | 305 | This invention |
| P-107 | 60° C. | | 5 g | 10 g | 112 g | | 3 Hr | 0.75 | 1.92 | | 2.67 | 281 | This invention |
| P-108 | 60° C. | | 5 g | 43 g | 80 g | | 3 Hr | 2.05 | 0.69 | | 2.74 | 279 | This invention |
| B-102 | 60° C. | | 5 g | 16 g | | 127 g | 3 Hr | 1.05 | | 1.75 | 2.8 | 268 | This invention |
| B-103 | 60° C. | | 5 g | 6 g | | 142 g | 4 Hr | 0.55 | | 2.24 | 2.79 | 261 | This invention |
| P-109 | 80° C. | | 5 g | 98 g | 103 g | | 4 Hr | 0.3 | 2.65 | | 2.95 | 286 | This invention |
| P-110 | 80° C. | 2.2 g | 11 g | 16 g + 2 g | 62 g | | 4 Hr | 1.45 | 1.47 | | 2.92 | 301 | This invention |
| P-111 | 80° C. | | 5 g | | 103 g | | 3 Hr | 0.25 | 2.46 | | 2.71 | 285 | This invention |
| P-112 | 80° C. | | 5 g | 7 g | 116 g | | 3 Hr | 0.59 | 2.1 | | 2.69 | 275 | This invention |
| P-113 | 80° C. | | 5 g | 17 g | 103 g | | 4 Hr | 1.09 | 1.72 | | 2.81 | 298 | This invention |
| P-114 | 80° C. | | 5 g | 43 g | 70 g | | 3 Hr | 2.05 | 0.69 | | 2.74 | 305 | This invention |
| B-104 | 80° C. | | 5 g | 16 g | | 127 g | 3 Hr | 1.02 | | 1.81 | 2.83 | 268 | This invention |
| B-105 | 80° C. | | 13.5 g | | | 108 g | 4 Hr | 0.84 | | 2.14 | 2.98 | 270 | This invention |
| B-106 | 80° C. | | 5 g | 26 g | | 110 g | 4 Hr | 1.52 | | 1.33 | 2.85 | 258 | This invention |
| B-107 | 80° C. | | 5 g | 42 g | | 87 g | 3 Hr | 2.05 | | 0.71 | 2.76 | 232 | This invention |

### Example 2

(Melt-Casting Film Formation)

(1) Preparation of Cellulose Acylate

As shown in Table 1, a variety of cellulose acylates having different types of acyl groups and different polymerization degrees were prepared in such a manner as above described.

(2) Pelletizing of Cellulose Acylate

The above-described cellulose acylate was dried by blowing at 120° C. for three hours to make its water content of 0.1 wt % in Karl Fischer's method. To the cellulose acylate thus obtained, a plasticizer selected from the group described below was added, and then silicon dioxide particulates “Aerosil R972V” (trade mark) in 0.05 wt % to the total weight were added.
Plasticizer A: triphenyl phosphate
Plasticizer B: dioctyl adipate

A mixture thus prepared was put into a hopper of a biaxial kneading extruder. A vacuum vent was mounted to the biaxial kneading extruder to perform vacuum evacuation (setting: 0.3 atm). The mixture was melted in such a manner as described above and extruded in a water bath in a state of strand of 3 mm diameter, and then immersed for one minutes (strand setting). The strand thus obtained was passed through water of 10° C. for 30 seconds to lower its temperature and cut into pellets of 5 mm long. Pellets thus prepared were dried at 100° C. for ten minutes and then packed in a bag.

(3) Melt Film-Formation

Cellulose acylate pellets prepared according to the above-described method of preparation were dried in a vacuum drying apparatus of 110° C. for three hours. Cellulose acylate pellets thus dried were put into a hopper, which is adjusted to be at Tg-10° C., and were melted at 190° C. over a period of five minutes. Thereafter, cellulose acylate pellets thus melted were formed into a film by the use of a casting machine using T/D ratio (*1) and a value (*2) shown in Table-1. At this time by magnifying the speed of the casting drum by T/D times that of extrusion speed, a film having desired thickness (D) was obtained.
*1: T/D is obtained by dividing the space between lips by the thickness of a film formed.
*2: The value is obtained by dividing the space between a casting drum (CD) and a die by the width of a film formed to express by percent.

The casting drum was maintained at TG-10° C., on which a melted product was solidified to form a film. At this time, leveling was carried out by the use of a leveling static application method, in which a wire of 10 kV was placed at a position 10 cm away from a touch point of the melt on a casting drum. The solidified melt was peeled off from the surface of the casting drum and its both edges (5% of total width) were trimmed immediately before winding. Then, a thickness-enlarging process (knurling) was applied to the solidified melt. And, the widths of both edges of the solidified melt were widened by 10 mm respectively, and the heights of both edges of the solidified melt were heightened by 50 μm, respectively. Thereafter, the film obtained was wound around a wind-up roll by 3000 m at 30 m/minute. The width of the non-stretched film thus obtained was 1.5 m and its thickness was as shown in Table-2.

(Minute Polarizing Contaminants)

A sample film formed by the solution casting film formation or stretched was observed with a polarizing microscope having crossed two polarizers, at a magnification of 100 times. And number of white contaminant of 1 μm to less than 10 μm observed under the microscope was counted visually and shown by number per 1 mm².

(Measurements of Re and Rth)

The above-described sample film was allowed to stand at a temperature of 25° C. and at a relative humidity (RH) of 60% for three hours or above to adjust the moisture in the sample film. The measurement was carried out at a temperature of 25° C. and 60% RH by the use of an automatic double refractometer “KOBRA-21ADH/PR”(trade mark) manufactured by OJI KEISOKUKI Co. Ltd. A retardation value was obtained at a wavelength of 500 nm from the direction perpendicular to the surface of the sample film, and from the direction inclined at an angle of ±40° to the normal line of the surface of the sample film. Further, the retardation (Re) in the inside of the film is calculated from the value measured from vertical direction, and the retardation (Rth) in the direction of the thickness of the film is calculated from the value measured from vertical direction and the value measured from ±40° direction.

Minute polarizing contaminant of the non-stretched film thus obtained in such a manner as described above is described in Table 2. The film formed of a cellulose acylate obtained by the method of preparation of the present invention showed good characteristics that minute contaminant can not be substantially measured. However, the film formed of a cellulose acylate prepared under conditions beyond those defined by the method of preparation of the present invention contains a particularly large quantity of minute contaminants.

For comparison, the number of minute polarizing contaminant in cellulose acetate butyrate of EASTMAN CHEMICAL CO. was measured in such a manner as described above and the result obtained was described in Table 2.

TABLE 2

| | | | | | | | | Minute | | | |
|---|---|---|---|---|---|---|---|---|---|---|---|
| | Cellulose | | | | Total substitution | | Thickness | contaminants | | | |
| Sample | acylate | DSAc | DSPr | DSBu | degree | Plasticizer | (μm) | (number/mm²) | Re (nm) | Rth(nm) | Remarks |
| M1101 | C-101 | 1.42 | 1.43 | | 2.85 | A | 105 | 43 | 1 | 5 | Comparative example |
| M1102 | C-102 | 0.19 | 2.74 | | 2.93 | A | 100 | 56 | 3 | 5 | Comparative example |
| M1103 | C-103 | 1.28 | | 1.65 | 2.93 | B | 85 | 60 | 5 | 7 | Comparative example |
| M1104 | P-101 | 0.3 | 2.63 | | 2.93 | A | 82 | 1 | 3 | 4 | This invention |
| M1105 | P-102 | 0.25 | 2.55 | | 2.8 | A | 105 | 2 | 2 | 13 | This invention |
| M1106 | P-103 | 1.4 | 1.35 | | 2.75 | B | 110 | 0 | 3 | 14 | This invention |
| M1107 | B-101 | 1.27 | | 1.63 | 2.9 | A | 150 | 0 | 4 | 10 | This invention |
| M1108 | P-104 | 0.16 | 2.8 | | 2.96 | A | 120 | 6 | 2 | 4 | This invention |
| M1109 | P-105 | 0.25 | 2.46 | | 2.71 | B | 115 | 2 | 1 | 2 | This invention |
| M1110 | P-106 | 0.59 | 2.1 | | 2.69 | A | 120 | 1 | 2 | 3 | This invention |
| M1111 | P-107 | 0.75 | 1.92 | | 2.67 | A | 130 | 0 | 1 | 12 | This invention |
| M1112 | P-108 | 2.05 | 0.69 | | 2.74 | B | 150 | 0 | 3 | 6 | This invention |
| M1113 | B-102 | 1.05 | | 1.75 | 2.8 | A | 150 | 0 | 3 | 9 | This invention |
| M1114 | B-103 | 0.55 | | 2.24 | 2.79 | A | 150 | 1 | 2 | 12 | This invention |
| M1115 | P-109 | 0.3 | 2.65 | | 2.95 | B | 120 | 3 | 1 | 3 | This invention |
| M1116 | P-110 | 1.45 | 1.47 | | 2.92 | A | 120 | 0 | 4 | 3 | This invention |
| M1117 | P-111 | 0.25 | 2.46 | | 2.71 | A | 120 | 1 | 3 | 10 | This invention |
| M1118 | P-112 | 0.59 | 2.1 | | 2.69 | A | 120 | 1 | 4 | 7 | This invention |
| M1119 | P-113 | 1.09 | 1.72 | | 2.81 | A | 120 | 0 | 2 | 5 | This invention |
| M1120 | P-114 | 2.05 | 0.69 | | 2.74 | B | 120 | 0 | 3 | 4 | This invention |
| M1121 | B-104 | 1.02 | | 1.81 | 2.83 | B | 120 | 0 | 5 | 6 | This invention |
| M1122 | B-105 | 0.84 | | 2.14 | 2.98 | A | 120 | 2 | 6 | 12 | This invention |
| M1123 | B-106 | 1.52 | | 1.33 | 2.85 | A | 120 | 0 | 3 | 6 | This invention |
| M1124 | B-107 | 2.05 | | 0.71 | 2.76 | A | 110 | 0 | 3 | 4 | This invention |
| M1125 | *381-20 | 1.01 | | 1.68 | 2.69 | A | 110 | 50 | 7 | 9 | Comparative example |

*Cellulose acetate butyrate of EASTMAN CHEMICAL Co. Ltd

### Example 3

(Solution-Casting Film Formation)

(1) Solving Cellulose Acylate

(a) Solvent

A solvent was selected from the group below as shown in Table 3.
(i) Anti-chlorine type 1:
   Methyl acetate/Acetone/Methanol/Ethanol/Butanol (80/5/7/5/3, mass parts)
(ii) Anti-chlorine type 2:
   Ethyl acetate/Ethanol (300/45, mass parts)
(iii) Chlorine type:
   Dichloromethane/Methanol/Ethanol/Butanol (85/6/5/4, mass parts)
      (b) Cellulose Acylate

After drying cellulose acylate so that the water content was 0.5 wt % or below, the cellulose acylate thus obtained was added to the above-described solvent in concentration of 25 wt % to prepare a dope as shown in Table 3.

(c) Additives

The following additives were added to the above-described dope.
Plasticizer A: triphenylphosphate (3 wt %)
Plasticizer B: biphenyl-diphenyl phosphate (1 wt %)
Optical anisotropy-controlling agent: Compound illustrated in formula 1 in JP-A-2003-66230 (3 wt %)
Ultraviolet-absorbing agent a: (2,4-bis-(n-octylthio)-6-(4-hydroxy-3,5-di-tert-butylanilino)-1,3,5-triazine (0.5 wt %)
Ultraviolet-absorbing agent b: 2(2′-hydroxy-3′,5′-di-tert-butylphenyl)-5-chlorobenzotriazole (0.2 wt %)
Ultraviolet-absorbing agent c: 2 (2′-hydroxy-3′,5′-di-tert-amylphenyl)-5-chlorobenzotriazole (0.1 wt %)
Fine particles: silicon dioxide (grain size 20 nm), Mohs' hardness about 7 (0.25 wt %)
Ethyl citrate ester (a mixture ratio of monoester to diester=1:1) (0.2 wt %)
* The above-described addition amounts (mass %) each represent the ratio to the cellulose acylate.
   (d) Swelling and Solving

These cellulose acylates, solvents and additives were added into a solvent while agitating to prepare a mixture. After completion of addition, agitation was stopped. The mixture was swollen at 25° C. for three hours to prepare slurry. The slurry thus obtained was agitated again to dissolve cellulose acylate completely.

(e) Filtration and Concentration

After that, the slurry was filtered through a filter paper having the absolute filtering precision of 0.01 mm (manufactured by TOYO ROSHI Co. Ltd., “#63”) and further filtered through a filter paper having the absolute filtering precision of 2.5 μm (manufactured by POLE Co. “FH025”).

(2) Formation of Non-Stretched Film

The above-described film was heated at 35° C. and cast by a band-type casting method or drum-type casting method as described below and shown in Tabel-3.

[Band-Type Casting Method]

The dope was cast through a delivery valve onto a mirror-finished stainless steel-made endless band 60 m in length set at 15° C. which is mounted between two drums. A delivery valve used was analogous in shape to that described in JP-A-11-314233. Casting speed was 60 m/minute and the width of the dope was 250 cm. When the remaining solvent in a film became 100 wt %, the film was peeled. The film thus peeled was dried at temperatures gradually increased in the range from 40° C. to 120° C. at the rate show in Table-1, and further dried at 120° C. for five minutes and still further dried at 145° C. for 20 minutes. And thereafter, temperature was gradually increased at the rate show in Table-1 and a cellulose acylate film was obtained, and both edges of the film thus obtained were trimmed by 3 cm. A knurling 100 μm in height was added to places positioned in the range from 2 to 10 mm from both edges of the film, and then the film was wound around a wind-up roll by 3000 m.

[Drum-Type Casting Method]

The dope was cast through a delivery valve onto a mirror-finished stainless steel-made drum of 3 m diameter. A delivery valve used was analogous in shape to that described in JP-A-11-314233. Casting speed was 100 m/minute and the width of the dope was 250 cm.

When the remaining solvent in a film became 200 wt %, the film was peeled. The film thus peeled was dried at temperatures gradually increased in the range from 40° C. to 120° C. at the rate show in Table-1, and further dried at 120° C. for five minutes and still further dried at 145° C. for 20 minutes. And thereafter, temperature was gradually increased at the rate show in Table-1 and a cellulose acylate film was obtained, and both edges of the film thus obtained were trimmed by 3 cm. A knurling 100 μm in height was added to places positioned in the range from 2 to 10 mm from both edges of the film, and then the film was wound around a wind-up roll by 3000 m.

(3) Evaluation of Characteristics of Non-Stretched Film

Re, Rth, and amount of minute contaminant were measured in such a manner as described above and shown in Table 3. The film formed of a cellulose acylate prepared according to the method of preparation of the present invention shows good characteristics that minute contaminant can not be substantially measured. However, the film formed of a cellulose acylate prepared under conditions beyond those defined by the method of preparation of the present invention contains a large quantity of minute contaminants.

According to Example 1 of the technical report of the Japan Institute of Invention and Innovation (technical report Ko-Gi No. 2001-1745), a three-layer cast film was prepared by a cast film-formation method using the above-described dope and good effects as those described above were similarly obtained.

TABLE 3

| | | | | | Total | | | Minute | | | |
|---|---|---|---|---|---|---|---|---|---|---|---|
| | Cellulose | | | | substitution | | Casting | contaminants | | Rth | |
| Sample | acylate | DSAc | DSPr | DSBu | degree | Solvent | method | (number/mm²) | Re (nm) | (nm) | Remarks |
| S1101 | C-101 | 1.42 | 1.43 | | 2.85 | Chlorine type | Band | 11 | 7 | 11 | Comparative example |
| S1102 | C-102 | 0.19 | 2.74 | | 2.93 | Chlorine type | Band | 12 | 4 | 14 | Comparative example |
| S1103 | C-103 | 1.28 | | 1.65 | 2.93 | Chlorine type | Drum | 10 | 4 | 16 | Comparative example |
| S1104 | P-101 | 0.3 | 2.63 | | 2.93 | Chlorine type | Band | 0 | 2 | 18 | This invention |
| S1105 | P-102 | 0.25 | 2.55 | | 2.8 | Chlorine type | Band | 0 | 6 | 26 | This invention |
| S1106 | P-103 | 1.4 | 1.35 | | 2.75 | Chlorine type | Drum | 0 | 3 | 31 | This invention |
| S1107 | B-101 | 1.27 | | 1.63 | 2.9 | Chlorine type | Band | 0 | 3 | 19 | This invention |
| S1108 | P-104 | 0.16 | 2.8 | | 2.96 | Anti-chlorine type 1 | Drum | 0 | 4 | 15 | This invention |
| S1109 | P-105 | 0.25 | 2.46 | | 2.71 | Chlorine type | Band | 0 | 2 | 21 | This invention |
| S1110 | P-106 | 0.59 | 2.1 | | 2.69 | Chlorine type | Band | 0 | 6 | 35 | This invention |
| S1111 | P-107 | 0.75 | 1.92 | | 2.67 | Chlorine type | Band | 0 | 4 | 31 | This invention |
| S1112 | P-108 | 2.05 | 0.69 | | 2.74 | Anti-chlorine type 1 | Band | 0 | 2 | 27 | This invention |
| S1113 | B-102 | 1.05 | | 1.75 | 2.8 | Chlorine type | Drum | 0 | 3 | 24 | This invention |
| S1114 | B-103 | 0.55 | | 2.24 | 2.79 | Chlorine type | Band | 0 | 5 | 26 | This invention |
| S1115 | P-109 | 0.3 | 2.65 | | 2.95 | Anti-chlorine type 1 | Drum | 0 | 3 | 15 | This invention |
| S1116 | P-110 | 1.45 | 1.47 | | 2.92 | Chlorine type | Band | 0 | 5 | 20 | This invention |
| S1117 | P-111 | 0.25 | 2.46 | | 2.71 | Chlorine type | Band | 0 | 6 | 36 | This invention |
| S1118 | P-112 | 0.59 | 2.1 | | 2.69 | Chlorine type | Drum | 0 | 4 | 29 | This invention |
| S1119 | P-113 | 1.09 | 1.72 | | 2.81 | Chlorine type | Drum | 0 | 3 | 28 | This invention |
| S1120 | P-114 | 2.05 | 0.69 | | 2.74 | Chlorine type | Band | 0 | 3 | 29 | This invention |
| S1121 | B-104 | 1.02 | | 1.81 | 2.83 | Anti-chlorine type 1 | Drum | 0 | 2 | 25 | This invention |
| S1122 | B-105 | 0.84 | | 2.14 | 2.98 | Anti-chlorine type 2 | Band | 0 | 7 | 25 | This invention |
| S1123 | B-106 | 1.52 | | 1.33 | 2.85 | Chlorine type | Band | 0 | 5 | 24 | This invention |
| S1124 | B-107 | 2.05 | | 0.71 | 2.76 | Chlorine type | Band | 0 | 6 | 34 | This invention |
| S1125 | *381-20 | 1.01 | | 1.68 | 2.69 | Anti-chlorine type 1 | Drum | 13 | 4 | 29 | Comparative example |

*Cellulose acetate butyrate of EASTMAN CHEMICAL Co. Ltd

### Example 4

(1) Stretching

Each of non-stretched films described in Examples 2 and 3 was stretched at a temperature higher by 10° C. than Tg at the rate of 100%/sec to perform 15% MD stretching and at the rate of 20%/sec to perform 50% MD stretching. Tg was measured in such a manner as described below.

Such stretching was selected from a sequential stretching method in which lengthwise stretching is carried out after crosswise stretching, and a simultaneous biaxial stretching method in which lengthwise stretching and crosswise stretching are carried out simultaneously.

(Measurement of Tg)

20 g of a sample were put into a measuring pan of DSC (differential scanning calorimeter), and heated from 30° C. to 250° C. at the rate of 10° C./minute in an atmosphere of nitrogen (1st-run), and then cooled to 30° C. at the rate of −10° C./minute. Thereafter, the sample was heated again from 30° C. to 250° C. (2nd-run). Tg obtained at 2nd-run was used, which was a temperature at which a base line starts to change from the side of low temperature.

(2) Saponification

A non-stretched cellulose acylate film and a stretched cellulose acylate film were saponified by a dipping saponification method described below.

(a) Dipping Saponification

1.5 N aqueous solution of NaOH was used as saponification liquid. This saponification liquid was heated at 60° C. in which was dipped a cellulose acylate film for two minutes. Thereafter, the cellulose acylate film was dipped in 0.1 N aqueous solution of sulfuric acid for 30 seconds and was passed through a washing bath. A coating saponification described below was carried out and similar result as that of the dipping saponification was obtained.

(b) Coating Saponification

To 80 parts by weight of isopropyl alcohol were added 20 parts by weight of water, and was added KOH so as to be 1.5 mol/L to prepare a mixture. The mixture was heated at 60° C. and was used as saponification liquid. This saponification liquid was applied onto a cellulose acylate film of 60° C. in thickness of 10 g/m² and saponified for one minute. Thereafter, hot water of 50° C. was sprayed onto the cellulose acylate film at 10 L/m²/minute for one minute to wash.

(3) Preparation of Polarizing Layer

According to Example 1 described in JP-A-2001-141926, in order to stretch lengthwise the cellulose acylate prepared in such a manner as described above, it was passed through a nip between two pairs of rolls each of peripheral speeds of which was changed.

(4) Lamination

A polarizing layer obtained in such a manner as described above, a non-stretched cellulose acylate film saponified in such a manner as described above, a stretched cellulose acylate film, and saponified “FUJITAC” (trade mark for non-stretched triacetate film manufactured from FUJI PHOTO FILM Co. Ltd) were laminated by 3% aqueous solution of “PVA-117H” (trade mark for PVA manufacture by KURARAY Co. Ltd) as a bonding agent in such a combination as described below so that a polarizing axis and a lengthwise cellulose acylate film form an angle of 45 degree:
1. Polarizing plate A: stretched cellulose acylate film/polarizing film/non-stretched cellulose acylate film,
2. Polarizing plate B: stretched cellulose acylate film/polarizing film/FUJITAC,
3. Polarizing plate C: stretched cellulose acylate film/polarizing film/stretched cellulose acylate film.

As a non-stretched cellulose acylate film was used a film before stretching of same level.

(5) Preparation of an Optical Compensating Film and Liquid Display Device

The above-described phase contrast polarizing plate A or B was used instead of “VL-153OS” (trade mark for a VA-type 15 inch-display manufactured by FUJITU Co. Ltd). At this time, when a phase contrast polarizing plate was used for only one side of a pair of polarizing plates, a description “one side” was given, and, and when a phase contrast polarizing plate was used for both sides of a pair of polarizing plates, a description “both sides” was given. The quantity of light leakage of the liquid crystal display device thus prepared was measured in such a manner as described above.

[Method of Evaluation of Light Leakage]

The above-described liquid crystal display device was used as a whole surface black display and put in a pitch-dark room, and the brightness of the surface was measured by a photometer to obtain a value of quantity of light (hereinafter referred to as “X”). Quantity of light leakage was obtained by expressing by percent a value obtained by dividing “X” by a value obtained when using as a whole surface white display.

Since the quantity of light leakage of a display device using the stretched cellulose acylate film of the present invention was very small, a good optical compensating film was formed. On the other hand, the quantity of light leakage of a phase contrast liquid crystal display device using the stretched cellulose acylate film prepared under conditions beyond those defined by the present invention was very remarkable.

When a stretched cellulose acylate film of the present invention was used instead of a cellulose acetate film coated with a liquid crystal layer described in Example 1 of JP-A-11-316378, a good optical compensating film was formed.

When an optical compensating film was formed by the use of a stretched cellulose acylate film of the present invention instead of a cellulose acetate film coated with a liquid crystal layer described in Example 1 of JP-A-7-333433, a good optical compensating film was formed.

When a polarizing plate and phase contrast polarizing plate using a cellulose acylate film of the present invention were used for (1) a liquid crystal display device described in Example 1 of JP-A-10-48420, (2) an optical anisotropic layer comprising a discotheque liquid crystal molecule and an orientation film coated with polyvinyl alcohol described in Example 1 of JP-A-9-26572, (3) a 20-inch OCB-type liquid crystal display device described in FIG. 10 to FIG. 15 of JP-A-2000-154261, and (4) an IPS-type liquid crystal display device described in FIG. 11 of JP-A-2004-12731, a good liquid crystal display device without light leakage was obtained.

### Example 5

(Preparation of a Film of Low Reflection)

According to Example 47 described in the technical report of the Japan Institute of Invention and Innovation (technical report Ko-Gi No. 2001-1745), a low reflection film was prepared, using the stretched cellulose acylate film of the present invention. A film thus obtained has excellent optical performances.

Cellulose acylate film of low reflection of the present invention was adhered to (1) an uppermost surface of a liquid crystal display device described in Example 1 of JP-A-10-48420, (2) an uppermost surface of a 20-inch VA-type liquid crystal display device described in FIG. 2 to FIG. 9 of JP-A-2000-154261, (3) an uppermost surface of a 20-inch OCB-type liquid crystal display device described in FIG. 10 to FIG. 15 of JP-A-2000-154261 and evaluated. As a result, a good liquid crystal display device was obtained.

### Example 6

(1) Pelletization of Cellulose Acylate

Cellulose acylates, as shown in Table 4, were synthesized, respectively, in the same manner as in Example 1-2, except for changing the acylating agent in Example 1-2 to a mixture of acetic anhydride, propionic anhydride, acetic acid, propionic acid, and sulfuric acid, and for suitably changing the ratio of acetyl to propionyl contained in the acylating agent and the reaction temperature. As Comparative Examples 6-1 and 6-2, cellulose acylates C-101 and C-102 were designated respectively. Those cellulose acylates were dried with air at 120° C. for 3 hours, to reduce the content of water to 0.1 wt %. The plasticizers shown in Table 4, 0.05 wt % of silicon dioxide fine particles (Aerosil R972V), 0.20 wt % of a phosphite-based stabilizer (P-1), 0.8 wt % of 2,4-bis-(n-octylthio)-6-(4-hydroxy-3,5-di-tert-butylanilino)-1,3,5-triazine (ultraviolet absorbing agent a), and 0.25 wt % of 2(2′-hydroxy-3′,5′-di-tert-butylphenyl)-5-chlorobenzotriazole (ultraviolet absorbing agent b) were added to the obtained cellulose acylates, and the resulting mixtures were molten and kneaded with a twin-screw kneading extruder at 190° C., respectively. A vacuum vent was provided in the twin-screw kneading extruder, to carry out vacuum gas exhaustion (0.3 atm was set). The cellulose acylates were extruded into a strand form of diameter 3 mm in a water bath, and cut to length 5 mm, respectively. 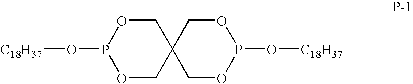
(2) Melting Film Formation

The cellulose acylate pellet prepared by the above method was dried in a vacuum dryer at 100° C. for 3 hours. This pellet was placed in a hopper set at Tg-10° C., to melt and extrude the cellulose acylate by using the screw having a compression ratio of 3.0 of a single-screw extruder, at the following temperature pattern.

Screw temperature pattern:

Upstream feed portion (180 to 195° C.)
Intermediate compression portion (200 to 210° C.)
Downstream metering portion (210 to 240° C.)

Thereafter, the molten cellulose acylate was let pass through a gear pump, to remove the pulsation of the extruder, then the resultant was filtered with a 3-μm filter, let pass through a die at 230° C., and cast onto a cast drum. At this time, a 3 kV electrode was installed in 5 cm away from the molten cellulose acylate, to carry out the static electricity application of both 5 cm ends thereof. The cellulose acylate was let pass through three casting drums each having a diameter of 60 cm and set at Tg−5° C., Tg ° C., and Tg−10° C., respectively, to be solidified, to thereby obtain a cellulose acylate film having a thickness described in Table 4. After both 5-cm ends were trimmed, both ends were knurled to a width of 10 mm and a height of 50 μm, to prepare a sample roll of a cellulose acylate film having a width of 1.5 m and a length of 2,000 m at a film formation rate of 30 m/min. The surface of the film had no die streak or level difference, and a cellulose acylate film having an excellent surface was obtained.

Re and Rth of the obtained cellulose acylate unstretched film were measured in the same manner as in Example 2. Results are shown in Table 4. Other physical properties of the film were included a haze of 0.15%, a transparency of 93.1%, and a molecular orientation axis of 0.3°. Minute contaminants were measured in the same manner as in Example 2. Results are also shown in Table 4. According to the examples of the present invention, minute contaminants of less than 0.02 mm was of less density than 1 piece/m² and no minute contaminants of 0.02 to 0.05 mm, which means that it has excellent properties for optical use. In contrast to this, the cellulose acylate films of Comparative Examples produced by a method other than the method of the present invention, each had much minute contaminants and were poor in properties as an optical film.

(3) Preparation of Polarizing Plate

(3-1) Saponification of Cellulose Acylate Film

The cellulose acylate film was saponified by the following immersion saponification method. That is, a 2.5 mol/L aqueous solution of NaOH was used as a saponification liquid. This was heated at 60° C., and the cellulose acylate film was immersed in this for 2 minutes. Thereafter, the film was immersed in a 0.05 mol/L aqueous solution of sulfuric acid for 30 seconds, followed by rinsing with water.

(3-2) Preparation of Polarizing Film

The film was stretched in a longitudinal direction, by giving a speed difference to two pairs of nip rolls, to form a 20 μm-thick polarizing film, in accordance with Example 1 of JP-A-2001-141926.

(3-3) Lamination

The thus-obtained polarizing film, the above saponified unstretched or stretched cellulose acylate films, and the saponified Fujitac (trade name, unstretched triacetate film) were combined as follows and laminated together, by means of a 3% aqueous solution of PVA (PVA-117H, trade name, manufactured by Kuraray Co., Ltd.) as an adhesive, in the stretching direction of the polarizing film and the film forming flow direction (longitudinal direction) of the cellulose acylate.
Polarizing plate A: unstretched cellulose acylate film/polarizing film/Fujitac (TD80U)
Polarizing plate B: unstretched cellulose acylate film/polarizing film/unstretched cellulose acylate film
   (3-4) Evaluation of Packaging

A polarizing plate on a surface for observer's side, out of two pairs of polarizing plates sandwiching a liquid crystal layer in 26-inch and 40-inch liquid crystal display devices provided with VA-type liquid crystal cells (manufactured by Sharp Co., Ltd.), was removed and replaced by the above polarizing plate A or B by means of an adhesive. The polarizing plate A or B was positioned such that the transparent axes of the polarizing plates on the observer's side and the transparent axes of the polarizing plates on the backlight side would be perpendicular to each other, to prepare liquid crystal display devices, respectively.

A light leakage and uneven color occurring in a black display state and in-plane uniformity of the thus-obtained liquid crystal display device were observed. In Table 4, in the column of evaluation, “◯” indicates that the liquid crystal display device had almost no light leakage and uneven color and can be provided as a commodity without a problem in the respect of in-plane uniformity, and “x” indicates that the liquid crystal display device had much light leakage and uneven color and is unacceptable as a commodity.

TABLE 4

| | Cellulose acylate | | | | | | | | | | | | |
|---|---|---|---|---|---|---|---|---|---|---|---|---|---|
| | A | B | | | | | | | | | | Others | |
| | Sub- | Substitution | Sub- | | | | | | | | Con- | Minute | |
| | stitution | degree of | stituent | A + B | Polym- | Plasticizer | | Non-stretched film | | | stitution | con- | |
| | degree | acyl groups | other | Total | eri- | | Qty. | Thick- | | | of | taminants | |
| | of acetyl | other than | than acetyl | Substitution | zation | | (wt | ness | Re | Rth | polarizing | (number/ | EvaL- |
| | group | acetyl group | group | degree | degree | No. | %) | (μm) | (nm) | (nm) | plate | mm²) | uation |
| Example 16-1 | 0.11 | 2.81 | Propionyl | 2.92 | 190 | 4 | 6.0 | 100 | 4 | 19 | A | 0 | ◯ |
| Example 16-2 | 0.20 | 2.60 | Propionyl | 2.80 | 200 | 4 | 8.0 | 85 | 1 | 9 | A | 0 | ◯ |
| Example 16-3 | 0.25 | 2.53 | Propionyl | 2.78 | 210 | 4 | 10.0 | 88 | 0 | 14 | B | 0 | ◯ |
| Example 16-4 | 0.40 | 2.30 | Propionyl | 2.70 | 170 | 3 | 6.0 | 80 | 3 | 25 | B | 0 | ◯ |
| Example 16-5 | 0.70 | 1.90 | Propionyl | 2.60 | 185 | 3 | 9.0 | 90 | 5 | 40 | A | 0 | ◯ |
| Example 16-6 | 1.10 | 1.40 | Propionyl | 2.50 | 195 | 3 | 12.0 | 97 | 8 | 42 | A | 0 | ◯ |
| Example 16-7 | 1.60 | 1.25 | Propionyl | 2.85 | 160 | 1 | 6.0 | 88 | 7 | 80 | A | 0 | ◯ |
| Example 16-8 | 0.05 | 2.90 | Propionyl | 2.95 | 170 | None | 0.0 | 145 | 3 | 45 | A | 0 | ◯ |
| Example 16-9 | 0.20 | 2.00 | Propionyl | 2.20 | 140 | 2 | 15.0 | 75 | 3 | 41 | B | 0 | ◯ |
| Example 16-10 | 0.10 | 1.95 | Propionyl | 2.05 | 150 | 4 | 20.0 | 140 | 2 | 18 | B | 0 | ◯ |
| Example 16-11 | 0.20 | 2.60 | Butyryl | 2.80 | 200 | 4 | 8.0 | 75 | 9 | 65 | A | 0 | ◯ |
| Example 16-12 | 1.10 | 1.72 | Butyryl | 2.82 | 180 | 4 | 6.0 | 80 | 8 | 57 | A | 0 | ◯ |
| Comparative | 1.42 | 1.43 | Propionyl | 2.85 | 224 | 4 | 6.0 | 85 | 14 | 75 | A | 10 | X |
| example 16-1 | | | | | | | | | | | | | |
| Comparative | 0.19 | 2.74 | Propionyl | 2.93 | 208 | 4 | 6.0 | 85 | 16 | 77 | A | 17 | X |
| example 16-2 | | | | | | | | | | | | | |

Plasticizer 1: biphenyl-diphenyl phosphate
Plasticizer 2: dioctyl adipate
Plasticizer 3: glycerol diacetate mono-olate
Plasticizer 4: polyethylene glycol (molecular weight 600)

As is apparent from the results in Table 4, the cellulose acylate film of the present invention was very excellent without change in color.

(3-5) Formation of Low-Reflective Film

A low-reflective film was formed from the cellulose acylate film obtained in the above (2), according to Example 47 of the technical report of the Japan Institute of Invention and Innovation (technical report Ko-Gi No. 2001-1745). As a result, the film showed excellent optical properties.

(3-6) Formation of Optical Compensation Film

An excellent optical compensation film was obtained, by coating the cellulose acylate film obtained in the above (2) on a liquid crystal layer, according to Example 1 of JP-A-11-316378.

### Example 7-1

(Cellulose Acetate Propionate P-210)

10 g of cellulose (broadleaf wood pulp) and 11 g of acetic acid were put into a 500 ml separable flak equipped with a reflux condenser, and irradiated with microwaves of 2.45 GHz frequency with power of 300 W for ten seconds. This irradiation operation was repeated three times. Cellulose thus treated was agitated vigorously at a temperature of 25° C. Cellulose thus pretreated was swollen and grinded and was made to be fluff. The reactor was put on an iced water bath maintained at 5° C. for one hour to cool cellulose sufficiently. Apart from them, a mixture of 18 g of acetic acid anhydride, 62 g of propionic acid anhydride, and 0.5 g of sulfuric acid was prepared and cooled to −20° C. and then added all at once into the cellulose pretreated. After a lapse of 30 minutes, the temperature of the outside of the reactor was raised to 30° C. and reaction was continued for four hours. The reactor was cooled on an iced water bath maintained at 5° C. and added 120 g of acetic acid containing 25% of water over a period of 30 minutes. The temperature of the inside of the reactor was raised to 30° C. and agitation was performed for tow hours. 5 g of 50% aqueous solution of magnesium acetate tetra-anhydride were added into the reactor and agitated for 30 minutes. 75 g of acetic acid containing 25% of water, and 250 g of water were added gradually into the reactor to precipitate cellulose acetate propionate. Cellulose acetate propionate thus obtained was washed by hot water of 70° C. until cleaning fluid being pH 6-7, and stayed in saturated aqueous solution of calcium hydroxide of 20° C. for 12 hours and then washed by water until cleaning fluid being pH 7. Cellulose acetate propionate thus obtained was dried at 70° C. According to ¹H-NMR and GPC measurements, the cellulose acetate propionate thus obtained had the acetylation degree of 1.42, propionylation degree of 1.46, and polymerization degree of 298.

### Example 7-2

(Cellulose Acetate Propionate P-204)

10 g of cellulose (broadleaf wood pulp) and 11 g of acetic acid were put into a 500 ml separable flak equipped with a reflux condenser, and irradiated with microwaves of 2.45 GHz frequency with power of 300 W for ten seconds. This irradiation operation was repeated three times. Cellulose thus treated was agitated vigorously at a temperature of 25° C. Cellulose thus pretreated was swollen and grinded and was made to be fluff. The reactor was put on an iced water bath maintained at 5° C. for one hour to cool cellulose sufficiently. Apart from them, a mixture of 103 g of propionic acid anhydride, and 1.0 g of sulfuric acid was prepared and cooled to −20° C. and then added all at once into the cellulose pretreated. After a lapse of 30 minutes, the temperature of the outside of the reactor was raised to 20° C. and reaction was continued for three hours. The reactor was cooled on an iced water bath maintained at 5° C. and added 120 g of acetic acid containing 25% of water over a period of 30 minutes. The temperature of the inside of the reactor was raised to 30° C. and agitation was performed for tow hours. 10 g of 50% aqueous solution of magnesium acetate tetra-anhydride were added into the reactor and agitated for 30 minutes. 75 g of acetic acid containing 25% of water, and 250 g of water were added gradually into the reactor to precipitate cellulose acetate propionate. Cellulose acetate propionate thus obtained was washed by hot water of 70° C. until cleaning fluid being pH 6-7, and stayed in saturated aqueous solution of calcium hydroxide of 20° C. for 12 hours and then washed by water until cleaning fluid being pH 7. Cellulose acetate propionate thus obtained was dried at 70° C. According to ¹H-NMR and GPC measurements, the cellulose acetate propionate thus obtained had the acetylation degree of 0.14, propionylation degree of 2.80, and polymerization degree of 291.

### Example 7-3

(Cellulose Acetate Butyrate B-205)

10 g of cellulose (broadleaf wood pulp) and 13.5 g of acetic acid were put into a 500 ml separable flak equipped with a reflux condenser, and irradiated with microwaves of 2.45 GHz frequency with power of 300 W for ten seconds. This irradiation operation was repeated three times. Cellulose thus treated was agitated vigorously at a temperature of 25° C. Cellulose thus pretreated was swollen and grinded and was made to be fluff. The reactor was put on an iced water bath maintained at 5° C. for one hour to cool cellulose sufficiently. Apart from them, a mixture of 108 g of butyric acid anhydride, and 1.0 g of sulfuric acid was prepared and cooled to −20° C. and then added all at once into the cellulose pretreated. After a lapse of 30 minutes, the temperature of the outside of the reactor was raised to 20° C. and reaction was continued for 4.5 hours. The reactor was cooled on an iced water bath maintained at 5° C. and added 120 g of acetic acid containing 25% of water over a period of 30 minutes. The temperature of the inside of the reactor was raised to 30° C. and agitation was performed for 1.5 hours. 10 g of 50% aqueous solution of magnesium acetate tetra-anhydride were added into the reactor and agitated for 30 minutes. 75 g of acetic acid containing 25% of water, and 250 g of water were added gradually into the reactor to precipitate cellulose acetate butyrate. Cellulose acetate butyrate thus obtained was washed by hot water of 70° C. until cleaning fluid being pH 6-7, and stayed in saturated aqueous solution of calcium hydroxide of 20° C. for 12 hours and then washed by water until cleaning fluid being pH 7. Cellulose acetate butyrate thus obtained was dried at 70° C. According to ¹H-NMR and GPC measurements, the cellulose acetate butyrate thus obtained had the acetylation degree of 0.82, butyration degree of 2.15, and polymerization degree of 223.

### Comparative Example 2

(Cellulose Acylate C-201, C-202, C-203)

In the same manner described in Comparative Example 1, C-201 was obtained. According to ¹H-NMR and GPC measurements, the cellulose acetate propionate thus obtained had the acetylation degree of 1.42, propionylation degree of 1.43, and polymerization degree of 224.

According to the same acylation methods as those of Examples 7-2 and 7-3 except that cellulose pretreated at low temperatures in such a manner as described in Comparative Example 2 was used, cellulose acylate C-202 and C-203 for comparison were prepared. Time required for acylation was seven hours for C-202 and nine hours for C-203, respectively.

Similarly to that, another cellulose acylates described in Table 5 were prepared in such a manner as described in Examples 7-1 to 7-3 in which combination of acylating agent, amount of acylating agent and reaction conditions were changed. It was found that pretreatment in the method of preparation of the present invention contributes to the reduction of the reaction time and cellulose acylate having high degree polymerization can effectively be obtained.

Samples P-201 to 203, 205 to 209, and 211 to 214 were cellulose acetate propionates prepared according to Example 7-1 or 7-2. Samples B-201 to 204, 206, and 207 were cellulose acetate butyrate prepared according to Example 7-3. Measurements for ¹H-NMR and GPC were made on these samples to determine DSAc, DSPr, DSBu and the degree of polymerization in the same manner as those described in Examples 7-1 to 7-3. Results obtained are shown in Table 5.

TABLE 5

| Cellulose | | | | Total substitution | Polymerization | |
|---|---|---|---|---|---|---|
| acylate | DSAc | DSPr | DSBu | degree | degree | Remarks |
| C-201 | 1.42 | 1.43 | | 2.85 | 224 | Comparative example |
| C-202 | 0.19 | 2.74 | | 2.93 | 208 | Comparative example |
| C-203 | 1.28 | | 1.65 | 2.93 | 205 | Comparative example |
| P-201 | 0.24 | 2.65 | | 2.89 | 285 | This invention |
| P-202 | 0.22 | 2.58 | | 2.8 | 295 | This invention |
| P-203 | 1.42 | 1.36 | | 2.78 | 284 | This invention |
| B-201 | 1.25 | | 1.66 | 2.91 | 302 | This invention |
| P-204 | 0.14 | 2.8 | | 2.94 | 291 | This invention |
| P-205 | 0.24 | 2.39 | | 2.63 | 296 | This invention |
| P-206 | 0.61 | 2.11 | | 2.72 | 305 | This invention |
| P-207 | 0.76 | 1.89 | | 2.65 | 281 | This invention |
| P-208 | 2.1 | 0.71 | | 2.81 | 279 | This invention |
| B-202 | 1.02 | | 1.72 | 2.74 | 268 | This invention |
| B-203 | 0.56 | | 2.24 | 2.8 | 261 | This invention |
| P-209 | 0.32 | 2.63 | | 2.95 | 286 | This invention |
| P-210 | 1.42 | 1.46 | | 2.88 | 298 | This invention |
| P-211 | 0.25 | 2.43 | | 2.68 | 285 | This invention |
| P-212 | 0.54 | 2.25 | | 2.79 | 275 | This invention |
| P-213 | 1.11 | 1.77 | | 2.88 | 298 | This invention |
| P-214 | 2.1 | 0.65 | | 2.75 | 305 | This invention |
| B-204 | 1.01 | | 1.79 | 2.8 | 268 | This invention |
| B-205 | 0.82 | | 2.15 | 2.97 | 223 | This invention |
| B-206 | 1.51 | | 1.32 | 2.83 | 258 | This invention |
| B-207 | 2.04 | | 0.76 | 2.8 | 232 | This invention |

### Example 8

(Melt-Casting Film Formation)

According to the method described in Example 2, melt-casting film samples are obtained by using cellulose acylates described in Table 6. Results obtained in each item are shown in Table 6.

TABLE 6

| | | | | | | | | Minute | | | |
|---|---|---|---|---|---|---|---|---|---|---|---|
| | Cellulose | | | | Total substitution | | Thickness | contaminants | | Rth | |
| Sample | acylate | DSAc | DSPr | DSBu | degree | Plasticizer | (μm) | (number/mm²) | Re (nm) | (nm) | Remarks |
| M2101 | C-201 | 1.42 | 1.43 | | 2.85 | A | 105 | 43 | 1 | 5 | Comparative example |
| M2102 | C-202 | 0.19 | 2.74 | | 2.93 | A | 100 | 56 | 3 | 5 | Comparative example |
| M2103 | C-203 | 1.28 | | 1.65 | 2.93 | B | 85 | 60 | 5 | 7 | Comparative example |
| M2104 | P-201 | 0.24 | 2.65 | | 2.89 | A | 80 | 1 | 4 | 6 | This invention |
| M2105 | P-202 | 0.22 | 2.58 | | 2.8 | A | 105 | 0 | 3 | 12 | This invention |
| M2106 | P-203 | 1.42 | 1.36 | | 2.78 | B | 110 | 0 | 4 | 6 | This invention |
| M2107 | B-201 | 1.25 | | 1.66 | 2.91 | A | 150 | 0 | 2 | 10 | This invention |
| M2108 | P-204 | 0.14 | 2.8 | | 2.94 | A | 120 | 0 | 2 | 9 | This invention |
| M2109 | P-205 | 0.24 | 2.39 | | 2.63 | B | 115 | 1 | 3 | 6 | This invention |
| M2110 | P-206 | 0.61 | 2.11 | | 2.72 | A | 120 | 1 | 4 | 8 | This invention |
| M2111 | P-207 | 0.76 | 1.89 | | 2.65 | A | 130 | 0 | 2 | 4 | This invention |
| M2112 | P-208 | 2.1 | 0.71 | | 2.81 | B | 150 | 0 | 2 | 11 | This invention |
| M2113 | B-202 | 1.02 | | 1.72 | 2.74 | A | 150 | 0 | 1 | 6 | This invention |
| M2114 | B-203 | 0.56 | | 2.24 | 2.8 | A | 150 | 0 | 2 | 9 | This invention |
| M2115 | P-209 | 0.32 | 2.63 | | 2.95 | B | 120 | 1 | 3 | 14 | This invention |
| M2116 | P-210 | 1.42 | 1.46 | | 2.88 | A | 120 | 0 | 4 | 10 | This invention |
| M2117 | P-211 | 0.25 | 2.43 | | 2.68 | A | 120 | 0 | 2 | 4 | This invention |
| M2118 | P-212 | 0.54 | 2.25 | | 2.79 | A | 120 | 0 | 2 | 6 | This invention |
| M2119 | P-213 | 1.11 | 1.77 | | 2.88 | A | 120 | 0 | 1 | 3 | This invention |
| M2120 | P-214 | 2.1 | 0.65 | | 2.75 | B | 120 | 0 | 2 | 12 | This invention |
| M2121 | B-204 | 1.01 | | 1.79 | 2.8 | B | 120 | 0 | 2 | 6 | This invention |
| M2122 | B-205 | 0.82 | | 2.15 | 2.97 | A | 120 | 1 | 1 | 12 | This invention |
| M2123 | B-206 | 1.51 | | 1.32 | 2.83 | A | 120 | 0 | 3 | 6 | This invention |
| M2124 | B-207 | 2.04 | | 0.76 | 2.8 | A | 110 | 0 | 3 | 4 | This invention |
| M2125 | *381-20 | 1.01 | | 1.68 | 2.69 | A | 110 | 50 | 7 | 9 | Comparative example |

*Cellulose acetate butyrate of EASTMAN CHEMICAL Co. Ltd

The film formed of a cellulose acylate prepared according to the method of preparation of the present invention shows good characteristics. However, the film formed of a cellulose acylate prepared under conditions beyond those defined by the method of preparation of the present invention contains a particularly large quantity of minute contaminants.

### Example 9

(Solution-Casting Film Formation)

According to the method described in Example 3, solution-casting film samples are formed by using cellulose acylates shown in Table 7. Results of measurements are shown in Table 7.

The film formed of a cellulose acylate prepared according to the method of preparation of the present invention has substantially no minutes contaminants observed, and shows preferable characteristics. However, the film formed of a cellulose acylate prepared under conditions beyond those defined by the method of preparation of the present invention contains a large quantity of minute contaminants.

According to Example 1 described in a Published Technical Report published from Japan Institute of Invention and Innovation Ko-Gi No. 2001-1745, a three-layer cast film was prepared by a cast film-formation method using the above-described dope and good effects as those described above were similarly obtained.

TABLE 7

| | | | | | Total | | | Minute | | | |
|---|---|---|---|---|---|---|---|---|---|---|---|
| | Cellulose | | | | substitution | | Casting | contaminants | Re | Rth | |
| Sample | acylate | DSAc | DSPr | DSBu | degree | Solvent | method | (number/mm²) | (nm) | (nm) | Remarks |
| S2201 | C-201 | 1.42 | 1.43 | | 2.85 | Chlorine type | Band | 11 | 7 | 11 | Comparative example |
| S2202 | C-202 | 0.19 | 2.74 | | 2.93 | Chlorine type | Band | 12 | 4 | 14 | Comparative example |
| S2203 | C-203 | 1.28 | | 1.65 | 2.93 | Chlorine type | Drum | 10 | 4 | 16 | Comparative example |
| S2204 | P-201 | 0.3 | 2.63 | | 2.93 | Chlorine type | Band | 0 | 3 | 19 | This invention |
| S2205 | P-202 | 0.25 | 2.55 | | 2.8 | Chlorine type | Band | 0 | 4 | 31 | This invention |
| S2206 | P-203 | 1.4 | 1.35 | | 2.75 | Chlorine type | Drum | 0 | 5 | 28 | This invention |
| S2207 | B-201 | 1.27 | | 1.63 | 2.9 | Chlorine type | Band | 0 | 2 | 27 | This invention |
| S2208 | P-204 | 0.16 | 2.8 | | 2.96 | Anti-chlorine type (1) | Drum | 0 | 6 | 24 | This invention |
| S2209 | P-205 | 0.25 | 2.46 | | 2.71 | Chlorine type | Band | 0 | 2 | 28 | This invention |
| S2210 | P-206 | 0.59 | 2.1 | | 2.69 | Chlorine type | Band | 0 | 7 | 31 | This invention |
| S2211 | P-207 | 0.75 | 1.92 | | 2.67 | Chlorine type | Band | 0 | 7 | 29 | This invention |
| S2212 | P-208 | 2.05 | 0.69 | | 2.74 | Anti-chlorine type (1) | Band | 0 | 2 | 28 | This invention |
| S2213 | B-202 | 1.05 | | 1.75 | 2.8 | Chlorine type | Drum | 0 | 6 | 29 | This invention |
| S2214 | B-203 | 0.55 | | 2.24 | 2.79 | Chlorine type | Band | 0 | 4 | 26 | This invention |
| S2215 | P-209 | 0.3 | 2.65 | | 2.95 | Anti-chlorine type (1) | Drum | 0 | 5 | 18 | This invention |
| S2216 | P-210 | 1.45 | 1.47 | | 2.92 | Chlorine type | Band | 0 | 4 | 21 | This invention |
| S2217 | P-211 | 0.25 | 2.46 | | 2.71 | Chlorine type | Band | 0 | 2 | 34 | This invention |
| S2218 | P-212 | 0.59 | 2.1 | | 2.69 | Chlorine type | Drum | 0 | 6 | 30 | This invention |
| S2219 | P-213 | 1.09 | 1.72 | | 2.81 | Chlorine type | Drum | 0 | 3 | 30 | This invention |
| S2220 | P-214 | 2.05 | 0.69 | | 2.74 | Chlorine type | Band | 0 | 5 | 29 | This invention |
| S2221 | B-204 | 1.02 | | 1.81 | 2.83 | Anti-chlorine type (1) | Drum | 0 | 8 | 24 | This invention |
| S2222 | B-205 | 0.82 | | 2.15 | 2.97 | Anti-chlorine type (2) | Band | 0 | 4 | 25 | This invention |
| S2223 | B-206 | 1.52 | | 1.33 | 2.85 | Chlorine type | Band | 0 | 3 | 24 | This invention |
| S2224 | B-207 | 2.05 | | 0.71 | 2.76 | Chlorine type | Band | 0 | 6 | 31 | This invention |
| S2225 | *381-20 | 1.01 | | 1.68 | 2.69 | Anti-chlorine type (1) | Drum | 13 | 4 | 29 | Comparative example |

*Cellulose acetate butyrate of EASTMAN CHEMICAL Co. Ltd

### Example 10

According to the method described in Example 4, liquid crystal display devices were prepared by using non-stretched film samples described in Examples 8 and 9. Light leakage of the liquid crystal display devices thus prepared was measured.

The quantity of light leakage of a display device using the stretched cellulose acylate film of the present invention was very small, and thereby a good optical compensating film was formed. On the other hand, the quantity of light leakage of those using the stretched cellulose acylate film prepared under conditions beyond those defined by the present invention was very remarkable.

Further, according to the method described in Example 4, a good optical compensating film was formed. Moreover, according to the method described in Example 4, a good liquid crystal display device without light leakage was obtained.

### Example 11

(Preparation of Low-Reflection Film)

According to the method described in Example 5, low reflection films were prepared by using stretched cellulose acylate films of the present invention obtained in Example 10. The optical characteristics of the low reflection films thus obtained were good.

Further, the above low reflection film was adhered to an uppermost surface of an OCB-type liquid crystal display device, and the resultant display device was evaluated, in the same manner as described in Example 5. As a result, a good liquid crystal display device was obtained.

### Example 12

Cellulose acylates of Examples 26-1 to 26-12 according to the present invention, as shown in Table 8, were synthesized, respectively, in the same manner as in Example 7-1, except for changing the acylating agent in Example 7-1 to a mixture of acetic anhydride, propionic anhydride, acetic acid, propionic acid, and sulfuric acid, and for suitably changing the ratio of acetyl to propionyl contained in the acylating agent and the reaction temperature. As Comparative Examples, cellulose acylates C-201 and C-202 were designated as Comparative Examples 26-1 and 26-2, respectively. These cellulose acylates were utilized to make cellulose acylate films, to further prepare liquid crystal display devices, respectively, in the same manner as in Example 6. Light leakage and uneven color occurring in a black display state and in-plane uniformity of the thus-obtained liquid crystal display device were observed. In Table 8, in the column of evaluation, “◯” indicates that the liquid crystal display device had almost no light leakage and uneven color and can be provided as a commodity without a problem in the respect of in-plane uniformity, “Δ” indicates that the liquid crystal display device had light leakage and uneven color and may have a problem as a commodity according to application purpose, and “X” indicates that the liquid crystal display device had much light leakage and uneven color and is unacceptable as a commodity. The liquid crystal display devices of the present invention each were less in light leakage and uneven color, and exhibited excellent performance. Further, the cellulose acylate films of the Examples according to the present invention were very excellent without change in color.

A low-reflective film was formed from the cellulose acylate film, according to Example 47 of Japan Institute of Invention and Innovation (technical report Ko-Gi No. 2001-1745). As a result, the film showed excellent optical properties.

An excellent optical compensation film was obtained, by coating the cellulose acylate film on a liquid crystal layer, according to Example 1 of JP-A-11-316378.

TABLE 8

| | Cellulose acylate | | | | | | | | | | | | |
|---|---|---|---|---|---|---|---|---|---|---|---|---|---|
| | A | B | | | | | | | | | | Others | |
| | Sub- | Substitution | Sub- | | | | | | | | Con- | Minute | |
| | stitution | degree of | stituent | A + B | Polym- | Plasticizer | | Non-stretched film | | | stitution | con- | |
| | degree | acyl groups | other | Total | eri- | | Qty. | Thick- | | | of | taminants | |
| | of acetyl | other than | than acetyl | Substitution | zation | | (wt | ness | Re | Rth | polarizing | (number/ | Eval- |
| | group | acetyl group | group | degree | degree | No. | %) | (μm) | (nm) | (nm) | plate | mm²) | uation |
| Example 26-1 | 0.11 | 2.81 | Propionyl | 2.92 | 190 | 4 | 6.0 | 110 | 3 | 20 | A | 1 | ◯ |
| Example 26-2 | 0.20 | 2.60 | Propionyl | 2.80 | 200 | 4 | 8.0 | 80 | 0 | 8 | A | 1 | ◯ |
| Example 26-3 | 0.25 | 2.53 | Propionyl | 2.78 | 210 | 4 | 10.0 | 90 | 1 | 16 | B | 0 | ◯ |
| Example 26-4 | 0.40 | 2.30 | Propionyl | 2.70 | 170 | 3 | 6.0 | 110 | 5 | 30 | B | 0 | ◯ |
| Example 26-5 | 0.70 | 1.90 | Propionyl | 2.60 | 185 | 3 | 9.0 | 95 | 8 | 42 | A | 0 | ◯ |
| Example 26-6 | 1.10 | 1.40 | Propionyl | 2.50 | 195 | 3 | 12.0 | 125 | 8 | 58 | A | 0 | ◯ |
| Example 26-7 | 1.60 | 1.25 | Propionyl | 2.85 | 160 | 1 | 6.0 | 85 | 10 | 60 | A | 0 | ◯ |
| Example 26-8 | 0.05 | 2.90 | Propionyl | 2.95 | 170 | None | 0.0 | 75 | 6 | 28 | A | 1 | ◯ |
| Example 26-9 | 0.20 | 2.00 | Propionyl | 2.20 | 140 | 2 | 15.0 | 75 | 3 | 41 | B | 0 | ◯ |
| Example26-10 | 0.10 | 1.95 | Propionyl | 2.05 | 150 | 4 | 20.0 | 140 | 2 | 18 | B | 0 | ◯ |
| Example26-11 | 0.20 | 2.60 | Butyryl | 2.80 | 200 | 4 | 8.0 | 80 | 9 | 59 | A | 1 | ◯ |
| Example26-12 | 1.10 | 1.72 | Butyryl | 2.82 | 180 | 4 | 6.0 | 85 | 8 | 55 | A | 0 | Δ |
| Comparative | 1.49 | 1.43 | Propionyl | 2.92 | 224 | 4 | 6.0 | 85 | 14 | 75 | A | 10 | X |
| example 26-1 | | | | | | | | | | | | | |
| Comparative | 0.19 | 2.74 | Propionyl | 2.93 | 208 | 4 | 6.0 | 85 | 16 | 77 | A | 14 | X |
| example 26-2 | | | | | | | | | | | | | |

Plasticizer 1: biphenyl-diphenyl phosphate
Plasticizer 2: dioctyl adipate
Plasticizer 3: glycerol diacetate mono-olate
Plasticizer 4: polyethylene glycol (molecular weight 600)

### Example 13-1

200.0 g of cellulose and 100 g of acetic acid were put into a 2 L autoclave. Nitrogen gas was charged into the autoclave to maintain the pressure and temperature in the autoclave at 7 atm and at 35° C., respectively and agitation was made for five hours. Swollen Cellulose with acetic acid thus obtained was put into a 5 L separable flask and cooled by an ice bath. A mixture of 2060.0 g of propionic acid anhydride and 20.0 g of sulfuric acid which was cooled to −20° C. or below was added all at once into the flask. After laps of 30 minutes, the ice bath was removed and agitation was made at 20° C. for four hours. Temperature of the outside of a transparent viscous liquid thus obtained was made at 5° C., into which 1000 g of a mixture of acetic acid/water (3/1) were added dropwise over a period of one hour. After dropwise-addition, agitation was made at 40° C. for one hour, and 200 mL of an aqueous solution prepared by dissolving 160 g of magnesium acetate tetrhydrate were added dropwise. Further, 2 L of water were added dropwise to reprecipitate cellulose acetate propionate. The cellulose acetate propionate thus obtained was filtered and washed continuously with running water. The cellulose acetate propionate was filtered again and agitated in a saturated aqueous solution of calcium hydroxide at 60° C. for three hours. Filtration was made and washing by running water was made continuously until it being pH 7. Filtration was made again and vacuum drying was made to obtain CAP 301 as white solid. The weight of CAP 301 thus obtained was 350 g.

### Example 13-2

200.0 g of cellulose and 280 g of acetic acid were put into a 2 L autoclave. Nitrogen gas was charged into the autoclave to maintain the pressure and temperature in the autoclave at 7 atm and at 35° C., respectively and agitation was made for five hours. Swollen Cellulose with acetic acid thus obtained was put into a 5 L separable flask and cooled by an ice bath. A mixture of 1900.0 g of butyric acid anhydride and 20.0 g of sulfuric acid which was cooled to −20° C. or below was added all at once into the flask. After laps of 30 minutes, the ice bath was removed and agitation was made at 20° C. for four hours. Temperature of the outside of a transparent viscous liquid thus obtained was made at 5° C., into which 1000 g of a mixture of acetic acid/water (3/1) were added dropwise over a period of one hour. After dropwise-addition, agitation was made at 40° C. for five hours, and 200 mL of an aqueous solution prepared by dissolving 160 g of magnesium acetate tetrhydrate were added dropwise. Further, 2 L of water were added dropwise to reprecipitate cellulose acetate butyrate. The cellulose acetate butyrate thus obtained was filtered and washed continuously with running water. The cellulose acetate butyrate was filtered again and agitated in a saturated aqueous solution of calcium hydroxide at 60° C. for three hours. Filtration was made, and washing by running water was made continuously until it being pH 7. Filtration was made again, and vacuum drying was made to obtain CAB 301 as white solid. The weight of CAB 301 thus obtained was 380 g.

### Comparative Example 3

The same procedures as those of Example 13-1 were repeated, except that a process for swelling cellulose was carried out at the pressure and temperature in the autoclave at 1 atm and at 35° C., respectively, and C 302 as white solid was obtained. However, the time for agitation at 20° C. required for obtaining transparent high viscous liquid was 20 hours. The weight of C 302 thus obtained was 360 g.

Properties data of CAP 301 and CAB 301 as examples of the present invention, and C 302 and CAB 381-20 (manufactured by EASTMANN CHEMICAL Co. Ltd) as a comparative examples, are shown in Table 9. Each of substitution degrees was determined by ¹HNMR. From this result, the molecular weight of the repeating unit of mixed cellulose acylate was obtained. An average polymerization degree was determined by dividing average molecular weight obtained with GPC by this molecular weight.

(Observation of Minute Polarizing Contaminants)

A small amount of each of CAP 301, CAB 301, C 302, and CAB 381-20 was put on a slide glass and griped by a cover glass. Then the samples were heated to a temperature higher than its melting point and melted. The state thus obtained was observed by a polarizing microscope having crossed polarizers in a magnification of 100 times. Number of white contaminant of from 1 μm to less than 10 μm observed under the polarizing microscope was measured visually and represented by number per 1 mm². Results thus obtained are shown in Table 9.

As shown in Table 9, cellulose acylate of the present invention contains no minute polarizing contaminant. On the other hand, cellulose acylate beyond the scope of the present invention contain a large quantity of minute polarizing contaminants.

### Example 14

(Solution Casting Film Formation of Cellulose Acylate)

100 g of sample of each of CAP 301, CAB 301, C 302, and CAB 381-20 were dissolved in 600 mL of a solution of methylene chloride/methanol (9/1) and filtered at 2 atm to obtain a dope. The dope thus obtained was casted onto a SUS-made plate cooled and maintained at 15° C. by a doctor blade and dried at 25° C. for 30 minutes to obtain a film. The film thus formed was peeled off from a supporting structure at 200 mm/sec. At this time, a part of the film which was not peeled off and remains on the supporting structure was evaluated visually. The case where a remaining film was not observed at al on the supporting structure after completion of peeling was expressed by “nil.” The case where a remaining film was confirmed was expressed by “presence.” The case where a remaining film was slightly confirmed was expressed by “presence (small quantity).” Further, the film thus obtained was dried at 100° C. for ten minutes, and at 133° C. for 30 minutes, to obtain a transparent film. An observation of minute polarizing contaminant was carried out for the transparent film in such a manner as described above. Results obtained are shown in Table 9.

TABLE 9

| | | | | | | | Minute | | | |
|---|---|---|---|---|---|---|---|---|---|---|
| | | | | | | | polarizing | Remaining | Minute | |
| | | | | Molecular | | | contaminant in | film on a | polarizing | |
| | Substitution degree of | | | weight of | Average | Average | a molten | substrate | contaminant in | |
| | | propionil | butyryl | repetition | molecular | Polymerization | sample | after peeling | a film | |
| | acetyl group | group | group | unit | weigh | degree | (number/mm²) | film | (number/mm²) | Remarks |
| CAP 301 | 0.23 | 2.72 | | 324.3 | 90800 | 280 | 0 | Nil | 0 | This |
| | | | | | | | | | | invention |
| CAB 301 | 0.90 | | 1.73 | 321.2 | 88700 | 276 | 0 | Nil | 0 | This |
| | | | | | | | | | | invention |
| C 302 | 0.23 | 2.72 | | 324.3 | 54000 | 167 | 45 | Presence | 21 | Comparative |
| | | | | | | | | | | example |
| CAB | 1.01 | | 1.67 | 321.7 | 70500 | 219 | 50 | Presence | 30 | Comparative |
| 381-20 | | | | | | | | (small | | example |
| | | | | | | | | quantity) | | |

As shown in Table 9, a cellulose acylate film of the present invention has good peelability. On the other hand, a mixed cellulose acylate film beyond the scope of the present invention has poor peelability.

### Example 15

(Melt Casting Film Formation of Cellulose Acylate)

(1) Preparation of Cellulose Acylate Pellet

By enlarging the scale of preparation example 13-2, cellulose acylate CAB 301 was prepared in bulk. CAB 301 and CAB 381-20 manufactured by EASTMANN CHEMICAL Co. Ltd were formed into films by a melt casting film formation method in such a manner as described below.

Cellulose acylate was dried at 120° C. for three hours to make the water content 0.1 wt %, and were added triphenylphosphate as a plasticizer and “Aerosil 972V”(trade mark for silicon dioxide fine particulates manufactured by NIHON AEROSIL KK.) in 0.05 wt %, and a mixture was formed. The mixture thus formed was put into a hopper of a biaxial extruder and kneaded at a temperature of 170° C. at the number of revolutions of a screw of 200 rpm and in the residence time of 80 seconds. A vacuum vent was mounted to the biaxial extruder and evacuated (set at 0.3 atm). The mixture was melted in such a manner as described above and then was extruded into a water bath of 40° C. in a shape of strand of 3 mm diameter and dipped for one minute (strand-solidification). Thereafter, the strand thus formed was passed through water of 10° C. for three minutes and then after decreasing the temperature, the strand was cut into a pellet of 5 mm length. The pellet thus obtained was dried at 100° C. for ten minutes and packed in a bag.

(2) Non-Stretched Film

The pellet of mixed cellulose acylate prepared in such a manner as described above was dried in a vacuum dryer maintained at 110° C. for three hours to obtain dried pellets. The pellets thus obtained were put into a hopper adjusted at Tg-10° C. and melted at 190° C. over a period of five minutes to obtain a melted product. Thereafter, the melted product thus obtained was formed into a film under such conditions as described below: T/D ratio obtained by dividing the space between lips by the thickness of film formed was 4, and a value obtained by dividing the space between a casting drum (CD) and a die by the width of film formed to express by percent was 10%. At this time, by magnifying the speed of the casting drum by T/D times that of extrusion speed, a film having desired thickness was obtained. At this time, temperatures of both ends of the die were increased higher by 10° C. than that of the central part thereof. In the case where the temperatures of both ends of the die were increased by temperatures from 1° C. to 20° C. than the temperature of the central part thereof, no cracking occurred in both ends of a film formed; in the case where such temperatures were increased by less than 1 mm, cracking occurred in both ends of a film formed; in the case where such temperatures were increased by more than 20° C., theremal decomposition of resin occurred and coloring of both ends occurred. The casting drum was maintained at Tg-10° C., on which the melt was solidified to form a solidified melt. At this time, leveling was carried out by the use of a leveling static application method, in which a wire of 10 kV was placed at a position 10 cm away from a touch point of the film on a casting drum. The solidified melt was peeled off from the surface of the casting drum and its both edges (5% of the total width) were trimmed immediately before winding. Then, a thickness-enlarging process (knurling) was applied to both edges of the solidified melt, by which the widths and the heights of both edges of the solidified melt were made large by 10 mm and 50 μm, respectively. Then, the film thus obtained was wound around a roll by 3000 m at 30 m/minute. The widths and thicknesses at each of levels of the non-stretched film thus obtained were 1.5 m and 80 μm, respectively.

(3) Stretching

A non-stretched film obtained in (2) was stretched by a ratio of 70% in the direction of MD and by a ratio of 70% in the direction of Td. Thereafter, both edges of the film were trimmed by 5%, respectively. Amount of a minute polarizing contaminant remaining in sample films thus formed and Re and Rth were measured in such a manner as described below. Stretching was carried out at a temperature higher by 10° C. than Tg, at 300%/minute, measured in such a manner as described above.

Measurements for minutes contaminants, Re, and Rth were conducted according to the procedures described in Example 2. Results are shown in Table 10.

### Example 16

(Preparation for Polarizing Plate)

(1) Saponification

Cellulose acylate films were saponified as the procedure described below.

1.5 N aqueous solution of NaOH was used as saponification liquid. This saponification liquid was heated at 60° C. in which was dipped a cellulose acylate film for two minutes. Thereafter, the cellulose acylate film was dipped in 0.1 N aqueous solution of sulfuric acid for 30 seconds and was passed through a washing bath.

(2) Preparation for Polarizing Layer

According to Example 1 described in JP-A-2001-141926, in order to stretch lengthwise, it was passed through a nip between two pairs of rolls each of peripheral speeds of which was changed.

(3) Lamination

A polarizing layer thus obtained and a non-stretched cellulose acylate film saponified in such a manner as described above were laminated by 3% aqueous solution of “PVA-117H” (trade mark for PVA manufacture by KURARAY Co. Ltd) as a bonding agent in such a combination as described below so that a polarizing axis and a lengthwise cellulose acylate film form an angle of 45 degree to be a phase contrast polarizing plate:
Stretched cellulose acylate film/polarizing film/non-stretched cellulose acylate film,
As a non-stretched cellulose acylate film was used a film before stretching of same level.

### Example 17

(Preparation for Optical Compensation Film and Liquid Crystal Display Device)

According to the procedure described in Example 4, light leakage amount is measured, by using a phase contrast polarizing plate obtained in Example 16.

TABLE 10

| | | | | Liquid | |
|---|---|---|---|---|---|
| | | | | crystal | |
| | Properties of stretched film | | | display | |
| | | | Minutes | device | |
| | | | polarizing | Light | |
| Cellulose | Rth | Re | contaminants | leakage | |
| acylate | (nm) | (nm) | (number/mm²) | (%) | Remarks |
| CAB301 | 400 | 30 | 0 | 0 | This invention |
| CAB381-20 | 400 | 30 | 25 | 25 | Comparative |
| | | | | | example |

As shown in Table 10, light leakage from a liquid crystal display device using a phase contrast polarizing plate comprising cellulose acylate film of the present invention was small. On the other hand, light leakage form a liquid crystal display device using a phase contrast polarizing plate comprising cellulose acylate film beyond the scope of the present invention was remarkable.

As described above, by integrating a film obtained from cellulose acylate produced by a preparation method of the present invention, that is, preparation method including steps of swelling cellulose by the use of water, at least one kind of carboxylic acid having 2 to 6 carbon atoms, or a mixture thereof under pressure from 1.5 atm (0.15 MPa) to 100 atm (10.13 MPa) into a liquid crystal display device, light leakage was prevented and a breakdown in display occurring when using as a black display was resolved.

### Example 18

Cellulose acylates of Examples 36-1 to 36-12 according to the present invention, as shown in Table 11, were synthesized, respectively, in the same manner as in Example 13-1, except for changing the acylating agent in Example 13-1 to a mixture of acetic anhydride, propionic anhydride, acetic acid, propionic acid, and sulfuric acid, and for suitably changing the ratio of acetyl to propionyl contained in the acylating agent and the reaction temperature. As Comparative Example 36-1, cellulose acylate C-302 that was not fallen in the present invention was utilized. These cellulose acylates were utilized to make cellulose acylate non-stretched films, respectively, in the same manner as in Example 6. Re, Rth, and minute contaminants of the obtained cellulose acylate non-stretched film were measured in the same manner as in Example 6. Results are shown in Table 11. The cellulose acylate films of the present invention had excellent properties for optical use. On the contrary, the cellulose acylate films of Comparative Examples produced by a method other than the method of the present invention, each had much minute contaminants and were poor in properties as an optical film.

Further, the cellulose acylate films of the present invention were utilized to prepare liquid crystal display devices, respectively, in the same manner as in Example 6. Light leakage and uneven color occurring in a black display state and in-plane uniformity of the thus-obtained liquid crystal display device were observed.

In Table 11, in the column of evaluation, “◯” indicates that the liquid crystal display device had almost no light leakage and uneven color and can be provided as a commodity without a problem in respect of in-plane uniformity, “Δ” indicates that the liquid crystal display device had light leakage and uneven color and may have a problem as a commodity according to application purpose, and “X” indicates that the liquid crystal display device had much light leakage and uneven color and is unacceptable as a commodity. The liquid crystal display devices of the present invention each were less in light leakage and uneven color, and exhibited excellent performance. Further, the cellulose acylate films of the Examples according to the present invention were very excellent without change in color.

TABLE 11

| | Cellulose acylate | | | | | | | | | | | | |
|---|---|---|---|---|---|---|---|---|---|---|---|---|---|
| | A | | | | | | | | | | | | |
| | Substi- | B | | | | | | | | | | | |
| | tution | Substitution | Substit- | | | | | | | | Consti- | | |
| | degree | degree of | uent | A + B | Poly- | | | Non-stretched film | | | tution | Others | |
| | of | acyl groups | other than | Total | meri- | Plasticizer | | Thick- | | | of | Minute | |
| | acetyl | other than | acetyl | substitution | zation | | Qty. | ness | Re | Rth | polarizing | con- | Evalu- |
| | group | acetyl group | group | degree | degree | No. | (wt %) | (μm) | (nm) | (nm) | plate | taminants | ation |
| Example 36-1 | 0.11 | 2.81 | Propionyl | 2.92 | 190 | 4 | 6.0 | 95 | 2 | 25 | A | 0 | ◯ |
| Example 36-2 | 0.20 | 2.60 | Propionyl | 2.80 | 200 | 4 | 8.0 | 80 | 5 | 10 | A | 0 | ◯ |
| Example 36-3 | 0.25 | 2.53 | Propionyl | 2.78 | 210 | 4 | 10.0 | 85 | 0 | 15 | B | 0 | ◯ |
| Example 36-4 | 0.40 | 2.30 | Propionyl | 2.70 | 170 | 3 | 6.0 | 92 | 2 | 15 | B | 1 | ◯ |
| Example 36-5 | 0.70 | 1.90 | Propionyl | 2.60 | 185 | 3 | 9.0 | 86 | 6 | 24 | A | 0 | ◯ |
| Example 36-6 | 1.10 | 1.40 | Propionyl | 2.50 | 195 | 3 | 12.0 | 92 | 3 | 36 | A | 0 | ◯ |
| Example 36-7 | 1.60 | 1.25 | Propionyl | 2.85 | 160 | 1 | 6.0 | 85 | 1 | 80 | A | 1 | ◯ |
| Example 36-8 | 0.05 | 2.90 | Propionyl | 2.95 | 170 | None | 0.0 | 125 | 8 | 40 | A | 0 | ◯ |
| Example 36-9 | 0.20 | 2.00 | Propionyl | 2.20 | 140 | 2 | 15.0 | 80 | 2 | 35 | B | 0 | ◯ |
| Example 36-10 | 0.10 | 1.95 | Propionyl | 2.05 | 150 | 4 | 20.0 | 80 | 9 | 20 | B | 0 | ◯ |
| Example 36-11 | 0.20 | 2.60 | Butyryl | 2.80 | 200 | 4 | 8.0 | 125 | 1 | 65 | A | 0 | ◯ |
| Example 36-12 | 1.10 | 1.72 | Butyryl | 2.82 | 180 | 4 | 6.0 | 97 | 5 | 43 | A | 0 | ◯ |
| Comparative | 0.23 | 2.72 | Propionyl | 2.95 | 167 | 4 | 6.0 | 85 | 10 | 75 | A | 25 | X |
| example 36-1 | | | | | | | | | | | | | |

Plasticizer 1: biphenyl-diphenyl phosphate
Plasticizer 2: dioctyl adipate
Plasticizer 3: glycerol diacetate mono-olate
Plasticizer 4: polyethylene glycol (molecular weight 600)

A low-reflective film was formed from the cellulose acylate film, according to Example 47 of the technical report of the Japan Institute of Invention and Innovation (technical report Ko-Gi No. 2001-1745). As a result, the film showed excellent optical properties.

Further, an excellent optical compensation film was obtained, by coating the cellulose acylate film on a liquid crystal layer, according to Example 1 of JP-A-11-316378.

Having described our invention as related to the present embodiments, it is our intention that the invention not be limited to any of the details of the description, unless otherwise specified, but rather be construed broadly within its spirit and scope as set out in the accompanying claims.

This non-provisional application claims priority under 35 U.S.C. § 119 (a) on PatentApplication No. 2004-197378 filed in Japan on Jul. 2, 2004; Patent Application No. 2004-197380 filed in Japan on Jul. 2, 2004, and Patent Application No. 2004-197376 filed in Japan on Jul. 2, 2004, each of which is entirely herein incorporated by reference.

What we claim is:

1. A method of preparing a cellulose acylate having a substitution degree represented by formulas (1) to (3), comprising the steps of:
adding at least one selected from the group consisting of water and a carboxylic acid having 2 to 7 carbon atoms, as an activating agent, to a cellulose; and
applying at least one treatment selected from (a) maintaining the cellulose at a temperature of 40° C. or more, for one hour or more, (b) irradiating microwaves to the cellulose, and (c) placing the cellulose under a pressure in the range of from 1.5 atm (0.15 MPa) to 100 atm (10.13 MPa):
2.5≦A+B≦3 formula (1)
0≦A≦2.5 formula (2)
0.3≦B≦3 formula (3)
wherein “A” represents a substitution degree of an acetyl group, and “B” represents the sum total of substitution degrees of acyl groups having 3 to 7 carbon atoms.

2. The method of preparing the cellulose acylate according to claim 1, further comprising the step of:
adding a carboxylic acid anhydride having 2 to 7 carbon atoms to the cellulose to be acylated, and acylating a hydroxyl group of the cellulose in the presence of a Brφnested acid.

3. The method of preparing the cellulose acylate according to claim 1, further comprising the steps of:
cooling the cellulose to a temperature of from −30° C. to less than 30° C., before acylation; and
adding a carboxylic acid anhydride having 2 to 7 carbon atoms to the cellulose to be acylated, to which said treatment is applied, and acylating a hydroxyl group of the cellulose in the presence of a Brφnested acid.

4. The method of preparing the cellulose acylate according to claim 1, wherein said activating agent is water, at least one kind of carboxylic acid having 2 to 6 carbon atoms, or a mixture of water with at least one kind of carboxylic acid having 2 to 6 carbon atoms.

5. The method of preparing the cellulose acylate according to claim 1, wherein “B” in formula (1) or (3) represents the sum total of substitution degrees of a propionyl group, a butyryl group, a pentanoyl group, and a hexanoyl group.

6. The method of preparing the cellulose acylate according to claim 1, wherein a frequency of the microwaves irradiated in the (b) is 433.920±0.87 MHz, 915±50 MHz, 2450±50 MHz, 5800±75 MHz, or 24.125±0.125 GHz.

7. The method of preparing the cellulose acylate according to claim 1, wherein the activating agent to be added to the cellulose is a carboxylic acid having 2 to 7 carbon atoms.

8. The method of preparing the cellulose acylate according to claim 1, wherein the activating agent to be added to the cellulose is selected from the group consisting of acetic acid, propionic acid, and butyric acid.

9. The method of preparing the cellulose acylate according to claim 1, wherein the activating agent to be added to the cellulose is acetic acid.

10. The method of preparing the cellulose acylate according to claim 1, wherein a period of time for maintaining the cellulose with the activating agent at a temperatures of 40° C. or above is in the range of from one hour to 100 hours.

11. The method of preparing the cellulose acylate according to claim 1, wherein the cellulose is maintained at a temperature in the range of from 60° C. to 90° C. in the presence of the activating agent.

12. The method of preparing the cellulose acylate according to claim 2, wherein said Brφnested acid is sulfuric acid or perchloric acid.

13. The method of preparing the cellulose acylate according to claim 2, wherein the maximum temperature in the step of acylation is 50° C. or below.

14. The method of preparing the cellulose acylate according to claim 2, wherein a reaction terminator is added over a period of time from three minutes to three hours, after the step of acylation.

15. The method of preparing the cellulose acylate according to claim 14, wherein the reaction terminator is acetic acid containing 5 wt % to 80 wt % of water.

16. A cellulose acylate film prepared by means of a solution-casting film formation method or melt-casting film formation method, using the cellulose acylate which is prepared by the preparation method according to claim 1.

17. The cellulose acylate film according to claim 16, wherein a retardation in a plane (Re) and a retardation in a thickness direction (Rth) satisfy the following formulas.
Rth[nm]≧Re[nm]
300≧Re[nm]≧0
500≧Rth[nm]≧0

18. A polarizing plate, comprising at least one sheet of the cellulose acylate film according to claim 16, as a protection film on a polarizing film (layer).

19. A liquid crystal display device, comprising the cellulose acylate film according to claim 16.
